(19) United States
(12) Patent Application Publication
(10) Pub. No.: US 2006/0144711 A1
(43) Pub. Date: Jul. 6, 2006

(54) Electrochemical machining device and electrochemical machining method

(76) Inventors: Itsuki Kobata, Tokyo (JP); Masayuki Kumekawa, Tokyo (JP); Osamu Nabeya, Tokyo (JP); Roberto Massahiro Serikawa, Fujisawa-shi (JP); Takayuki Saito, Fujisawa-shi (JP); Tsukuru Suzuki, Fujisawa-shi (JP); Akira Kodera, Fujisawa-shi (JP); Hozumi Yasuda, Tokyo (JP); Takeshi Iizumi, Tokyo (JP); Mitsuhiko Shirakashi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/534,232

(22) PCT Filed: Jul. 18, 2003
(86) PCT No.: PCT/JP03/09145

§ 371 Date: Dec. 12, 2005

(30) Foreign Application Priority Data
Nov. 8, 2002 (JP) 2002-325901
Nov. 20, 2002 (JP) 2002-337232
Feb. 24, 2003 (JP) 2003-46491

(51) Int. Cl. B23H 7/20

(52) U.S. Cl. 205/82; 205/641

(57) ABSTRACT

A object of this invention is to provide an electrolytic processing method and apparatus that can suppress a change in the electric conductivity of a fluid due to contaminants, such as processing products produced in electrolytic processing, so that the fluid can maintain good flattening properties. The electrolytic processing apparatus of this invention includes: a processing electrode (42) that can come into contact with a workpiece (W); a feeding electrode (44) for feeding electricity to the workpiece (W); a holder (22) for holding the workpiece (W); a power source (26) for applying a voltage between the processing electrode (42) and the feeding electrode (44); a fluid supply section (50) for supplying a fluid between the workpiece (W) and at least one of the processing electrode (42) and the feeding electrode (44); a sensor (80) for measuring the electric conductivity of the fluid; and a control section (84) for changing the processing conditions based on the electric conductivity measured by the sensor (80).

### TECHNICAL FIELD

The present invention relates to an electrolytic processing apparatus and an electrolytic processing method, and more particularly to an electrolytic processing apparatus and an electrolytic processing method useful for processing a conductive material formed in a surface of a substrate, such as a semiconductor wafer, or for removing impurities adhering to a surface of a substrate.

The electrolytic processing apparatus and the electrolytic processing method of the present invention are also useful for processing a metal portion of e.g. a vacuum device or high-pressure device that requires a high-precision surface finish, or for removing impurities adhering to a surface of such a workpiece.

### BACKGROUND ART

In recent years, instead of using aluminum or aluminum alloys as a material for forming circuits on a substrate such as a semiconductor wafer, there is an eminent movement towards using copper (Cu) which has a low electric resistivity and high electromigration resistance. Copper interconnects are generally formed by filling copper into fine recesses formed in a surface of a substrate. Various techniques for forming such copper interconnects are known including chemical vapor deposition (CVD), sputtering, and plating. According to any such technique, a copper film is formed in a substantially entire surface of a substrate, followed by removal of unnecessary copper by chemical mechanical polishing (CMP).

FIGS. 1A through 1C illustrate, in a sequence of process steps, an example of forming such a substrate W having copper interconnects. As shown in FIG. 1A, an insulating film 2, such as an oxide film of SiO₂ or a film of low-k material, is deposited on a conductive layer 1a in which semiconductor devices are formed, which is formed on a semiconductor base 1. Contact holes 3 and interconnect trenches 4 are formed by the lithography/etching technique. Thereafter, a barrier layer 5 of TaN or the like is formed on the surface, and a seed layer 7 as an electric supply layer for electroplating is formed on the barrier layer 5 by sputtering, CVD, or the like.

Then, as shown in FIG. 1B, copper plating is performed onto the surface of the substrate W to fill the contact holes 3 and the interconnect trenches 4 with copper and, at the same time, deposit a copper film 6 on the insulating film 2. Thereafter, the copper film 6 and the barrier layer 5 on the insulating film 2 are removed by chemical mechanical polishing (CMP) or the like so as to make the surface of the copper film 6 filled in the contact holes 3 and the interconnect trenches 4, and the surface of the insulating film 2 lie substantially on the same plane. Interconnects composed of the copper film 6, as shown in FIG. 1C, are thus formed.

Components in various types of equipments have recently become finer and have required higher accuracy. As sub-micro manufacturing technology has commonly been used, the properties of materials are largely influenced by the processing method. Under these circumstances, in such a conventional machining method that a desired portion in a workpiece is physically destroyed and removed from the surface thereof by a tool, a large number of defects may be produced to deteriorate the properties of the workpiece. Therefore, it becomes important to perform processing without deteriorating the properties of the materials.

Some special processing methods, such as chemical polishing, electrolytic processing, and electrolytic polishing, have been developed in order to solve this problem. In contrast with the conventional physical processing, these methods perform removal processing or the like through chemical dissolution reaction. Therefore, these methods do not suffer from defects, such as formation of a damaged layer and dislocation, due to plastic deformation, so that processing can be performed without deteriorating the properties of the materials (see, for example, Japanese Patent Laid-Open Publication Nos. 2000-246194 and 2001-20099).

FIG. 2 is a schematic diagram illustrating a conventional electrolytic processing method. As shown in FIG. 2, ion exchangers 36, 38 are respectively mounted on surfaces of an anode 32 and a cathode 34 to be connected to a power source 30. A fluid 42, such as pure water or ultrapure water, is supplied between the electrodes 32, 34 and a workpiece (e.g. a copper film) 40. The workpiece 40 is brought close to or into contact with the ion exchangers 36, 38 mounted on the surfaces of the electrodes 32, 34, and a voltage is applied from the power source 30 to between the anode 32 and the cathode 34. Water molecules in the fluid 42 are dissociated into hydroxide ions and hydrogen ions by the ion exchangers 36, 38, and the hydroxide ions produced, for example, are supplied to the surface of the workpiece 40. The concentration of hydroxide ion in the vicinity of the workpiece 40 thus increases, which causes reaction between the atoms of the workpiece 40 and hydroxide ions to effect removal processing of the surface layer of the workpiece 40. It has been considered that the ion exchangers 36, 38 thus have a catalytic action to dissociate the water molecules in the fluid 42 into hydrogen atoms and hydroxide ions.

In electrolytic processing using an ion exchanger, a change in the electric conductivity of a fluid supplied particularly affects a flatness of a processed surface of a workpiece. In this regard, a flattening effect on minute irregularities in the surface of a workpiece is produced by a difference in electric resistance between a raised portion and a depressed portion of the workpiece. In particular, as shown in FIG. 3, when pure water or ultra pure water is used, because of its very small electric conductivity, the electric resistance between a depressed portion 42 of a workpiece 40 and a processing electrode 50 is considerably different from the electric resistance between a raised portion 44 of the workpiece 40 and the processing electrode 50. Accordingly, if the processing progresses smoothly, electricity passes preferentially between the processing electrode 50 and the raised portion 44 closer to the processing electrode 50 rather than between the processing electrode 50 and the depressed portion 42 where the electric resistance is larger, whereby ions for processing are preferentially supplied to the vicinity of the raised portion 44. The raised portion 44 of the workpiece 40 is therefore electrolytically processed selectively and, as a result, a step difference between the depressed portion 42 and the raised portion 44 is eliminated and flatness of the surface of the workpiece 40 is obtained.

In fact, however, the electric conductivity of the fluid is always changing due to contaminants, such as processing products of the electrolytic processing, scrapings of an ion-exchange membrane, metal ions (e.g. copper ions), and additives. Further, such contaminants can remain in depressed portions 42 of the workpiece 40, which increases the electric conductivity of the fluid in the depressed portions 42, whereby electrolytic processing can progress also in the depressed portions 42. In such a case, electrolytic processing is effected both in depressed portions 42 and in raised portions 44. Accordingly, the step differences between the depressed portions 42 and the raised portions 44 cannot be eliminated. Thus, in this case, the fluid does not have the above-described flattening properties.

On the other hand, various techniques or processing methods are known to effect flattening and surface finishing of a surface of a workpiece, and specific examples include grinding, lapping, horning, and superfinishing. These processing methods are a machining which effects processing of a workpiece by chipping away the workpiece by e.g. a grinding stone while rotating the workpiece or the grinding stone at a high speed, and can effect a micron order of surface finishing. Such processing methods are widely used for processing metals that require high-precision surface finishing, in particular, pistons of internal combustion engines, and gasket portions, valve nozzles or plug sheets of vacuum devices or high-pressure devices, etc. where a high level of sealing must be maintained between the contact surfaces of workpieces.

In case a specular gloss finish is required of a workpiece, buffing with a polishing liquid is employed. In buffing, fine particles of silica, alumina, diamond, or the like contained in a polishing liquid are adhered to a buffing cloth composed of soft fibers. While rotating the buffing cloth, the buffing cloth is allowed to be in contact with a workpiece, thereby polishing the workpiece into a specular gloss surface.

With these processing methods, however, application of a mechanical force to a workpiece may cause defects in the workpiece, impairing the properties of the workpiece. For instance, when buffing an aluminum member, polishing particles can be embedded in the surface of the soft workpiece, making it difficult to obtain a specular finish.

CMP technology is a technology that was first employed as a method for eliminating irregularities in a surface of an interlevel dielectric layer formed in a semiconductor device manufacturing process. The CMP technology is now widely used for embedding of a tungsten plug, polishing of a poly-silicon, shallow trench isolation (STI), damascene processing of aluminum or copper interconnects, polishing of a noble metal for electrode, and the like.

According to a general CMP processing, while supplying a slurry of a suspension of polishing particles, such as silica or cerium oxide particles, to a workpiece such as a semiconductor wafer, and rotating the workpiece and a polishing pad (resin pad), the workpiece is mechanically pressed against the polishing pad, thereby eliminating irregularities in the surface of the workpiece and flattening the surface.

In the CMP, a chemical liquid contained in the slurry forms a complex with the metal of the workpiece. Such a metal complex, besides the metal itself, can be removed directly by the polishing particles. The polishing pad has proper hardness and roughness, and the workpiece is polishing by rubbing the surface to be processed with the polishing pad while supplying the slurry containing polishing particles to the entire workpiece. A CMP apparatus has recently been developed which employs a polishing pad having polishing particles embedded uniformly therein and thus eliminates the use of a slurry. A polishing pad, after its repeated use, loses its proper roughness and also its polishing effect. In order to restore the proper roughness of the polishing pad, it is practiced to scratch the polishing pad mechanically with a tool (dresser) in which diamond particles or the like are fixed.

With the recent movement toward higher integration of devices in the field of semiconductor industry, however, there is a tendency to use as an insulating film a porous low-k material which has a very low mechanical strength. Such an insulating film having a very low mechanical strength can be easily destroyed with the pressing force of a polishing pad during CMP processing.

Electrolytic processing is a processing method for effecting fine processing, flattening, surface finishing, etc., of a workpiece having such a mechanically weak portion. This processing method processes a metal (workpiece) through the reverse reaction to the so-called electroplating, and dissolves and removes the metal (workpiece) through an electrochemical reaction in contrast with the conventional physical processing methods. According to electrolytic processing, therefore, defects in a workpiece caused by its plastic deformation, such as a damager layer and dislocation, are not produced. Thus, electrolytic processing can process a workpiece without impairing the properties of the material.

Electrolytic processing uses electrolytic solutions containing phosphoric acid, sulfuric acid, chromic acid, nitric acid, sodium carbonate, or other various kinds of salts or organic substances, and dissolves and removes the metal of a workpiece by providing the workpiece with an anode potential. During electrolytic processing, proper electrolytic solution and electrolytic operating conditions may be determined depending upon the type of the metal of a particular workpiece, and various metals, such as stainless, aluminum, copper and titanium, can be processed by electrolytic processing.

A method has been disclosed which uses a chelating agent in electrolytically processing a metal (workpiece) using a pulse power source (see, for example, Japanese Patent Laid-Open Publication No. 2001-322036). CMP using a slurry (suspension containing abrasive grains) generally employs an operation of pressing a metal, and therefore involves the problem of causing defects, such as dishing, erosion and recesses, in the processed surface of the metal. The problem is taught to be overcome with the electrolytic processing method disclosed. According to this method, the metal is chelated by the chelating agent to form a chelate film (sticky layer) which has a very low mechanical strength and is easily removable, and the surface of the metal can be flattened by repeatedly carrying out the step of removing the raised portions of the chelate film.

There is also disclosed a method for electrolytically polishing a metal surface by a periodic reverse electrolytic method which carries out cathode electrode position and anode dissolution alternately (see, for example, Japanese Patent Laid-Open Publication No. H7-336017). According to this method, 63% phosphoric acid, for example, is used as an electrolytic solution, and a flat processed surface is taught to be obtainable by the use of periodic reverse current.

The above-described processing methods employ certain chemicals in chemical-mechanically or electrochemically flattening or fine processing of a metal surface. Such chemicals basically increase environmental burden. Further, when processing a workpiece that requires a high level of purity, such as a semiconductor device, there is a fear of chemical contamination.

Electrolytic metal processing methods, which are improved in environmental burden, contamination of a processed product, danger in operation, etc., have recently been developed (see, for example, Japanese Patent Laid-Open Publication Nos. 2000-52235 and 2001-64799). These electrolytic processing methods use pure or ultrapure water in carrying out electrolytic processing. Since pure water or ultrapure water hardly passes electricity therethrough, the electrolytic processing methods use an ion exchanger disposed between a workpiece serving as an anode and a processing electrode serving as a cathode to carry out electrolytic processing of the workpiece. Since the workpiece, the ion exchanger and the processing electrode are all put in pure water or ultrapure water atmosphere, the environmental burden problem and the workpiece contamination problem can be remarkably reduced. Further, the metal of the workpiece is removed as metal ions through the electrolytic reaction, and the dissolved ions are held in the ion exchanger. This can further reduce contamination of the workpiece and the liquid (pure water or ultrapure water) itself. Such a processing method, therefore, is considered as an ideal electrolytic processing method.

As described above, according to the electrolytic processing method which processes a workpiece by using an ion exchanger and supplying ultrapure water, contamination of the workpiece can be prevented and environmental burden can be remarkably reduced. Further, the electrolytic processing method can provide various metal parts with a specular gloss surface, and can also eliminate the use of a cutting oil, a slurry containing a polishing agent, an electrolytic solution, etc. which are necessary for the conventional mechanical metal processing for finishing methods.

Further according to the above-described electrolytic processing method using ultrapure water, there is no need to provide a process step to clean a workpiece, which can shorten the operating time and lower the equipment cost. In addition, as compared to the conventional electrolytic processing method that employs an electrolytic solution containing phosphoric acid, chromic acid, a salt, a chelating agent, a surfactant, or the like, the electrolytic processing method using an ion exchanger basically employs pure water or ultrapure water which, besides its safe and easy handling, can significantly reduce environmental burden.

Though the electrolytic processing method using an ion exchanger has the above advantages, it is known that depending upon the type of workpiece, the processing conditions, etc., pits (small holes) can be formed in the processed surface. The pits are such fine holes invisible to the naked eye that they may be present even when the processed surface shows a specular gloss. Thus, the pits are fine holes that can be only confirmed through analysis by a scanning electron microscope, a laser microscope, an atomic energy microscope, and the like.

Such pits, when formed in the finished surface of an ordinary mechanical part, may not adversely affect the appearance of the article. However, when pits are formed in a sealing surface of e.g. a vacuum device or a pressure device that requires a high degree of sealing, the desired vacuum or pressure may not be obtained. Further, the pits can promote corrosion of the metal. Also in the case of a semiconductor device, the formation of pits may exert various adverse influences.

CMP processing generally necessitates a considerably complicated operation and control, and needs a considerably long processing time. In addition, a sufficient post-cleaning of a substrate must be conducted after the polishing treatment upon CMP processing. This also imposes a considerable load on the slurry or cleaning liquid waste disposal. Also in this connection, it is to be pointed out that though a low-k material, which has a low dielectric constant, is expected to be predominantly used in the future as a material for the insulating film, the low-k material has a low strength and therefore is hard to endure the stress applied during conventional CMP processing. Thus, also from this standpoint, there is a demand for a process that enables the flattering of a substrate without giving any stress thereto.

Further, a process has been reported which performs CMP processing simultaneously with plating, viz. chemical mechanical electrolytic polishing. According to this process, the machining is carried out to the growing surface of a plating film and promotes an abnormal deposition of plating, causing the problem of denaturing of the resulting film quality.

Further, when a fragile material, such as a low-k material, is processed in a semiconductor device manufacturing process, there is a fear of destruction of the material due to buckling, etc. It is therefore not possible with such a processing as CMP to apply a high surface pressure between a substrate and a polishing surface, whereby a sufficient polishing cannot be performed. Especially, in these days, it is desired to use copper or a low-dielectric constant material as an interconnect material of a substrate. The above problem becomes remarkable when such a fragile material is used. In the case of electrolytic processing, it is not necessary to apply a surface pressure between a substrate and a processing electrode. It is however possible that a surface pressure is produced when a substrate is brought into contact with a processing electrode, which could cause destruction of a semiconductor device. Accordingly, it is necessary even with electrolytic processing to prevent a high load from being applied onto a substrate.

Ion exchangers have a functional group which has an electric charge. Accordingly, when an ion exchanger is used in electrolytic processing, processing products and residual products, etc., are attracted to a workpiece or a processing electrode due to the electric field produced between the workpiece and the processing electrode during processing. For example, when the workpiece and the processing electrode make a relative movement during electrolytic processing so that the ion exchanger slides on the workpiece, the ion exchanger wears and the scrapings float in a processing liquid. Due to the electric field, the floating scrapings are attracted to and adsorbed on the workpiece or the processing electrode.

Further, residues such as a processing product, an unreacted residual metal, etc., even in a small amount, are usually present on the electrolytically processed surface of a workpiece. In the case where a processing electrode and a feeding electrode are disposed opposite to the workpiece, because of the presence of fine residues between the processing electrode, the feeding electrode and the workpiece, it becomes difficult for the processing electrode and the feeding electrode to make contact with the workpiece, so that it is likely that the processing does not progress smoothly and the amount of residues increases.

The residues or extraneous matter, such as a processing product, an unreacted residual metal, etc., adsorbed as contaminants on a workpiece during the conventional electrolytic processing, can lower the reliability of the product (processed workpiece). Especially in the case of a semiconductor device, such residues can lead to short-circuit between interconnects, etc., and thus adversely affect the reliability of the device.

### DISCLOSURE OF INVENTION

The present invention has been made in view of the above situation in the background art. It is therefore a first object of the present invention to provide an electrolytic processing apparatus and an electrolytic processing method which can suppress a change in the electric conductivity of a fluid due to contaminants, such as processing products, produced upon the electrolytic processing, so that the fluid can maintain good flattening properties.

It is a second object of the present invention to provide an electrolytic processing apparatus and an electrolytic processing method which can carry out electrolytic processing without using a chemical liquid, and which can effectively prevent the formation of pits that would deteriorate the product quality of workpiece.

It is a third object of the present invention to provide an electrolytic processing method and an electrolytic processing apparatus which can minimize residues or extraneous matter remaining on the processed surface of a workpiece.

In order to achieve the above object, the present invention provides an electrolytic processing apparatus comprising: a processing electrode that can come close to a workpiece; a feeding electrode for feeding electricity to the workpiece; a holder for holding the workpiece; a power source for applying a voltage between the processing electrode and the feeding electrode; a fluid supply section for supplying a fluid between the workpiece and at least one of the processing electrode and the feeding electrode; a sensor for measuring the electric conductivity of the fluid; and a control section for changing the processing conditions based on the electric conductivity measured by the sensor. The processing conditions may be changed with the control section either during or after electrolytic processing of the workpiece.

The present invention provides an electrolytic processing method comprising: allowing a workpiece to be close to or in contact with a processing electrode; applying a voltage between the processing electrode and a feeding electrode for feeding electricity to the workpiece; supplying a fluid between the workpiece and at least one of the processing electrode and the feeding electrode; measuring the electric conductivity of the fluid; and changing the processing conditions based on the measured electric conductivity. The processing conditions may be changed either during or after electrolytic processing of the workpiece.

In a preferred embodiment of the present invention, an ion exchanger is disposed between the workpiece and at least one of the processing electrode and the feeding electrode.

Controlling the electric conductivity of a fluid for use in electrolytic processing is important in maintaining the good flattening properties of the fluid. According to the present invention, the electric conductivity of the fluid in a processing atmosphere is measured during or after electrolytic processing, and the processing conditions may be changed based on the measured electric conductivity of the fluid, so that the electric conductivity of the fluid can be kept at such a level that the flattening properties of the fluid are not affected, preferably not more than 500 μS/cm, more preferably not more than 50 μS/cm, most preferably not more than 2 μS/cm. This makes it possible to suppress a change in the electric conductivity of the fluid due to contaminants, such as a processing product and scrapings of the ion-exchanger membrane produced upon the electrolytic processing, metal ions, an additive, etc., thereby maintaining the good flattening properties of the fluid at all times.

In a preferred embodiment of the present invention, the control section changes the processing conditions by changing the flow rate of the fluid supplied from the fluid supply section (to between the workpiece and at least one of the processing electrode and the feeding electrode).

For instance, when the electric conductivity of the fluid, which is present between the workpiece and electrode where the ion exchanger is disposed, has increased, the flow rate of the fluid supplied from the fluid supply section is increased so as to discharge the fluid staying between the workpiece and electrode where the ion exchanger is disposed and containing contaminants, whereby the electric conductivity of the fluid present between the workpiece and electrode can be kept at a desired level.

The present invention also provides another electrolytic processing apparatus comprising: a processing electrode; a feeding electrode for feeding electricity to a workpiece; an ion exchanger disposed between the workpiece and at least one of the processing electrode and the feeding electrode; a holder for holding the workpiece and bringing the workpiece close to or into contact with the ion exchanger; a power source for applying a voltage between the processing electrode and the feeding electrode; a fluid supply section for supplying a fluid between the workpiece and the electrode in which the ion exchanger is disposed; a sensor for measuring the electric conductivity of the fluid; and a contaminant removing section for removing contaminants on the surface or in the interior of the ion exchanger based on the electric conductivity measured by the sensor.

The contaminant removing section may be comprised of a regeneration section for regenerating the ion exchanger. The removal of contaminants by the contaminant removal section may be carried out either during or after electrolytic processing of the workpiece. Further, the sensor may be provided in the contaminant removing section.

The present invention also provides another electrolytic processing method comprising: disposing an ion exchanger between a workpiece and at least one of a processing electrode and a feeding electrode for feeding electricity to the workpiece; allowing the workpiece to be close to or in contact with the ion exchanger; applying a voltage between the processing electrode and the feeding electrode; supplying a fluid between the workpiece and the electrode in which the ion exchanger is disposed; measuring the electric conductivity of the fluid; and removing contaminants on the surface or in the interior of the ion exchanger based on the measured electric conductivity. The contaminants may be removed either during or after electrolytic processing of the workpiece.

According to the present invention, the electric conductivity of the fluid in a processing atmosphere is measured during or after electrolytic processing and, based on the measured electric conductivity of the fluid, contaminants on the surface or in the interior of the ion exchanger may be removed so that the electric conductivity of the fluid can be kept at such a level that the flattening properties of the fluid are not affected, as a result, preferably not more than 500 μS/cm, more preferably not more than 50 μS/cm, most preferably not more than 2 μS/cm. This makes it possible to suppress a change in the electric conductivity of the fluid due to contaminants, such as processing products and scrapings of the ion-exchange membrane produced upon the electrolytic processing, metal ions, an additive, etc., thereby maintaining the good flattening properties of the fluid at all times.

The present invention provides still another electrolytic processing apparatus comprising: a processing electrode that can come close to a workpiece; a feeding electrode for feeding electricity to the workpiece; a holder for holding the workpiece; a power source for applying a voltage between the processing electrode and the feeding electrode; a fluid supply section for supplying a fluid between the workpiece and at least one of the processing electrode and the feeding electrode; a sensor for measuring the resistance between the processing electrode and the feeding electrode; and a control section for controlling the operation of the apparatus based on the resistance measured by the sensor.

It is preferred that an ion exchanger be disposed between the workpiece and at least one of the processing electrode and the feeding electrode.

The sensor may be disposed, for example, in the vicinity of the processing electrode or the feeding electrode, in the fluid supply section, or in a fluid discharge section for discharging the fluid supplied from the fluid supply section.

The fluid supplied from the fluid supply section is preferably pure water, ultrapure water or a fluid having an electric conductivity of not more than 500 μS/cm.

The present invention provides still another electrolytic processing apparatus comprising: a processing electrode; a feeding electrode for feeding electricity to a workpiece; an ion exchanger disposed at least one of between the workpiece and the processing electrode, and between the workpiece and the feeding electrode; a power source for applying a pulse voltage between the processing electrode and the feeding electrode; and a liquid supply section for supplying a liquid between the workpiece and at least one of the processing electrode and the feeding electrode.

Pits, in general, have a tendency to grow their sizes and increase their numbers with an increase in the processing time. Further, as the electrode efficiency during electrolytic processing is low, that is, as the loss of electricity is large due to consumption of electricity in a reaction other than the electrolytic reaction to dissolve the workpiece serving as an anode, the formation of pits becomes eminent. It has been confirmed empirically that the larger the amount of gasses (bubbles) generated at the surface of the workpiece during electrolytic processing is, the larger is the number of pits. Thus, when using an aqueous electrolytic liquid, the number of pits increases with an increase in the amount of oxygen and hydrogen generated at the electrodes. Such pits are therefore also called gas pits. The relationship between the gas bubbles and the formation of pits was unknown at least in the prior art pertaining to the technology of processing a workpiece by using an ion exchanger and supplying pure water or ultrapure water, and suppression of the formation of pits has been a technical problem to be solved in developing an electrolytic processing process with reduced environmental burden.

According to the present invention, the application of a pulse voltage between the processing electrode and the feeding electrode can prevent oxygen and hydrogen generated at the surface of a workpiece from growing as gas bubbles, thereby remarkably decreasing the number of pits formed in the surface of the workpiece during electrolytic processing. Further, since the reaction product dissolved out of the workpiece is held in the ion exchanger, contamination of the workpiece with the reaction product is remarkably reduced.

Preferably, the liquid is pure water, ultrapure water or a liquid having an electric conductivity of not more than 500 μS/cm.

Use of pure water or ultrapure water, which contains almost no impurities, in electrolytic processing makes it possible to carry out a clean processing without leaving impurities on the processed surface. Further, use of no chemical ensures safety of the worker upon electrolytic processing and, in addition, remarkably reduces environmental burden without involving the problem of waste liquid disposal.

Pure water herein refers to a water, for example, having an electric conductivity (referring herein to that at 25° C., 1 atm) of not more than 10 μS/cm. Ultrapure water refers to a water having an electric conductivity of not more than 0.1 μS/cm. As described above, use of pure water or ultrapure water in electrolytic processing enables a clean processing without leaving impurities on the processed surface of the workpiece, whereby a cleaning step after the electrolytic processing can be simplified. Specifically, the cleaning step after the electrolytic processing may be omitted or finished with one or two-stage.

Further, it is also possible to use a liquid obtained, for example, by adding an additive, such as a surfactant or the like, to pure water or ultrapure water, and having an electric conductivity of not more than 500 μS/cm, preferably not more than 50 μS/cm, more preferably not more than 0.1 μS/cm (resistivity of not less than 10 MΩ·cm). This makes it possible to form a layer, which functions to inhibit ion migration evenly, at the interface between the workpiece and the ion exchanger, thereby moderating concentration of ion exchange (metal dissolution) to enhance the flatness of the processed surface.

In a preferred embodiment of the present invention, the lowest potential of the pulse voltage periodically becomes zero or a negative potential. This makes it possible to more effectively prevent the formation of pits.

In a preferred embodiment of the present invention, the waveform of the pulse voltage is part of a square wave or a sine curve. This can simplify the electrolytic processing apparatus, especially the construction of the power source, thereby lowering the production cost of the apparatus.

In a preferred embodiment of the present invention, the duty ratio of positive potential of the pulse voltage is within the range of 10 to 97%.

If the duty ratio is less than 10%, the processing rate (processing speed) of electrolytic processing is low, and therefore it is necessary to prolong the processing time, which is undesirable practically. If the duty ratio exceeds 97%, on the other hand, the formation of pits in the surface of a workpiece cannot be effectively prevented, leading to a poor product (workpiece). The duty ratio of the pulse voltage is preferably 10 to 80%, more preferably 10 to 50%.

In a preferred embodiment of the present invention, the current density of an electric current flowing in the surface of a workpiece in contact with the ion exchanger is 0.1 to 100 A/cm².

If the current density of an electric current flowing in the surface of a workpiece in contact with the ion exchanger is lower than 0.1 A (100 mA)/cm², an effect of suppressing the formation of pits is not produced. In particular, when the current density is less than 100 mA/cm², rather than the electrolytic reaction of the workpiece, the oxidation reaction of water, which competes with the electrolytic reaction, is predominant, i.e., generation of oxygen occurs preferentially rather than dissolution of the workpiece. When a large amount of gas such as oxygen is generated, a large number of pits are undesirably formed in the surface of the workpiece, with the generation of gas. Further, if the current density is less than 100 mA/cm², the surface of the workpiece can partly corrode during electrolytic processing, causing defects in the surface of the workpiece. Therefore, by passing an electric current with a density of not less than 100 mA/cm², the amount of gas generated at the surface of the workpiece can be decreased to thereby effectively prevent the formation of pits. Further, when the current density is not less than 100 mA/cm², dissolution of the workpiece progresses uniformly as a whole, that is, processing of the workpiece is effected uniformly.

If the current density exceeds 100 A/cm², on the other hand, water boils due to the heat generation by resistance, which incurs deterioration of the ion exchanger, and can damage the surface of the workpiece. Further, boiling of water generates gas bubbles, leading to the formation of above-described gas pits. Furthermore, due to the high temperature, the ion exchanger may suffer from softening, dissolution, cracking, etc. Use of the current density of higher than 100 A/cm² thus causes various problems in the process of processing the workpiece. In addition, a rise in the voltage of electrolytic processing directly affects the power consumption, increasing the running cost of electrolytic processing and also the initial cost of the power source, etc. From such viewpoints, the current density is desirably not more than 100 A/cm². The current density during electrolytic processing is preferably 0.5 to 50 A/cm², more preferably 0.8 to 20 A/cm².

In a preferred embodiment of the present invention, the positive potential time in one cycle of the pulse voltage is 50 μs to 7 sec.

If a positive potential time in one cycle of the pulse voltage is less than 50 μs, which means application of a high-frequency pulse voltage, potential changes with high-speed. In a metal processing process using an ion exchanger and carried out in the presence of ultrapure water, the electrolytic reaction of metal (workpiece) and chemical reactions in the ion exchanger concerning movement and replacement of various ions (metal ion, H⁺, etc.) are in a rate-determining state. Accordingly, when the speed of potential change is fast, the electrochemical metal dissolution reaction cannot catch up with the change, whereby a partial dissolution of metal is likely to occur, resulting in the formation of pits in the surface of the metal. Further, use of a high-frequency pulse voltage necessitates a complicated power source, leading to an increased production cost.

On the other hand, if the positive potential time in one cycle of the pulse voltage applied exceeds 7 seconds, the same phenomenon as observed in the conventional processing using a direct current may occur. Thus, oxygen gas bubbles may grow at the surface of a workpiece serving as an anode and stay on the surface, leading to the formation of pits, as a result. From such viewpoints, a positive potential time in one cycle of the pulse voltage of not more than 7 seconds can suppress a continuous generation of oxygen and provide the oxygen gas bubbles generated with a time to leave the surface of the workpiece. According to the present invention, by making the positive potential time per cycle of the pulse voltage within the range of 50 us to 7 sec, it becomes possible to carry out processing of a metal smoothly and effect surface finishing with very few pits. The positive potential time per cycle of the pulse voltage is preferably 100 μs to 1 sec, more preferably 500 μs to 500 ms, preferably not more than 300 ms, more preferably not more than 100 ms.

In a preferred embodiment of the present invention, the liquid has been degassed to a dissolved oxygen concentration of 1 ppm or less. This can reduce the amount of oxygen generated during electrolytic processing, thereby decreasing the number of pits formed in the surface of a workpiece.

The present invention provides still another electrolytic processing method comprising: disposing an ion exchanger between at least one of between a workpiece and a processing electrode, and between the workpiece and a feeding electrode; allowing the workpiece to be close to the processing electrode; applying a pulse voltage between the processing electrode and the feeding electrode; and processing the workpiece while supplying a liquid between the workpiece and at least one of the processing electrode and the feeding electrode.

The present invention provides still another electrolytic processing method comprising: electrolytically processing a surface of a workpiece by providing a processing electrode and a feeding electrode for feeding electricity to the workpiece, applying a voltage between the processing electrode and the feeding electrode, allowing a liquid and a partition member to be present between the processing electrode and the workpiece, allowing the workpiece to be close to or in contact with the processing electrode, and allowing the workpiece and the processing electrode to make a relative movement; stopping the application of the voltage between the processing electrode and the feeding electrode after electrolytically processing the surface of the workpiece until a predetermined processing amount is reached; allowing the processing electrode and the workpiece to make a relative movement for a given length of time; and separating the workpiece from the processing electrode.

Preferably, an ion exchanger is disposed between the workpiece and at least one of the processing electrode and the feeding electrode. The partition member is preferably an ion exchanger disposed such that it covers the processing electrode in the vicinity of the processing electrode.

The present invention provides still another electrolytic processing apparatus comprising: an electrode section including a plurality of electrodes; a holder for holding a workpiece, capable of bringing the workpiece close to or into contact with the electrodes; a power source to be connected to the electrodes of the electrode section; a partition member disposed such that it can make contact with the surface of the workpiece; a liquid supply section for supplying a liquid between at least one of the electrodes, the partition member and the workpiece; and a drive section for allowing the electrode section and the workpiece to make a relative movement; wherein application of a voltage is stopped after processing the workpiece until a predetermined processing amount is reached, and the electrode section and the workpiece is allowed to make a relative movement for a given length of time while supplying the liquid between at least one of the electrodes, the partition member and the workpiece.

FIGS. 4 and 5 illustrate the principle of electrolytic processing. FIG. 4 shows the state when an ion exchanger 12a mounted on a processing electrode 14 and an ion exchanger 12b mounted on a feeding electrode 16 are brought into contact with or close to the surface of a workpiece 10, while a voltage is applied from a power source 17 to between the processing electrode 14 and the feeding electrode 16, and a liquid 18, such as ultrapure water, is supplied from a fluid supply section 19 to between the processing electrode 14, the feeding electrode 16 and the workpiece 10. FIG. 5 shows the state when the ion exchanger 12a mounted on the processing electrode 14 is brought into contact with or close to the surface of the workpiece 10 and the feeding electrode 16 is directly contacted with the workpiece 10, while a voltage is applied from the power source 17 to between the processing electrode 14 and the feeding electrode 16, and the liquid 18, such as ultrapure water, is supplied from the fluid supply section 19 to between the processing electrode 14 and the workpiece 10.

When using a liquid, like ultrapure water, which itself has a large resistivity, it is preferred to bring the ion exchanger 12a into “contact” with the surface of the workpiece 10. This can lower the electric resistance, lower the voltage applied, and reduce the power consumption. Thus, the “contact” in an electrolytic processing apparatus and an electrolytic processing method according to the present invention preferably do not imply “press” for giving a physical energy (stress) to a workpiece as in CMP, for example.

Water molecules 20 in the liquid 18, such as ultrapure water, are dissociated by the ion exchangers 12a, 12b into hydroxide ions 22 and hydrogen ions 24. The hydroxide ions 22 thus produced, for example, are carried, by the electric field between the workpiece 10 and the processing electrode 14 and by the flow of the liquid 18, such as ultrapure water, to the surface of the workpiece 10 facing the processing electrode 14, whereby the density of the hydroxide ions 22 in the vicinity of the workpiece 10 is increased, and the hydroxide ions 22 are reacted with the atoms 10a of the workpiece 10. The reaction product 26 produced by reaction is dissolved in the liquid 18, such as ultrapure water, and removed from the workpiece 10 by the flow of the liquid 18, such as ultrapure water, along the surface of the workpiece 10. Removal processing of the surface layer of the workpiece 10 is thus effected.

As will be appreciated from the above, the electrolytic processing apparatus and the electrolytic processing method according to the present invention perform removal processing of a workpiece solely by the electrochemical interaction with the workpiece, as distinct from a CMP which performs processing by the combination of the physical interaction between a polishing member and a workpiece, and the chemical interaction between a chemical species in a polishing liquid and the workpiece. Therefore, the present invention can perform removal processing of a material without impairing the properties of the material. Even when the material is of a low mechanical strength, such as the above-described low-k material, for example, removal processing of the material can be effected without causing any physical interaction. Further, as compared to the conventional electrolytic processing using electrolytic solution, the electrolytic processing of the present invention, due to the use of a processing liquid having an electric conductivity of not more than 500 μS/cm, preferably pure water, more preferably ultrapure water, can remarkably reduce contamination of the surface of a workpiece and can facilitate disposal of waste liquid after the processing. Accordingly to this method, the portion of the workpiece 10 facing the processing electrode 14 is processed. Therefore, by moving the processing electrode 14, the workpiece 10 can be processed into a desired surface configuration.

According to the present invention, after carrying out electrolytic processing of a workpiece until a desired processing amount is reached, the application of voltage between the processing electrode and the feeding electrode is stopped and the workpiece and the electrode section are allowed to make a relative movement for a given length of time. During the relative movement, extraneous matter such as scrapings of the ion exchanger, and residues such as an oxide layer and a small amount of unreacted metal, which are present on the surface of the workpiece upon completion of the electrolytic processing, are removed by the partition member that contacts the surface of the workpiece and by the flow of the liquid supplied to the surface of the workpiece. The processed surface of the workpiece after electrolytic processing is thus cleaned. This reduces burden on a cleaning of the workpiece after electrolytic processing and prevents lowering of the reliability of the product (workpiece). The term “electrode section” herein refers to a structure including electrodes and optionally members supporting the electrodes, and also including an ion exchanger that is disposed to cover at least one of the electrodes or the like.

The present invention provides still another electrolytic processing apparatus comprising: a processing electrode; a feeding electrode; a holder for holding a workpiece, capable of bringing the workpiece close to or into contact with the processing electrode; a power source to be connected to the processing electrode and the feeding electrode; a contact member disposed between the workpiece and at least one of the processing electrode and the feeding electrode, and capable of making contact with the workpiece; a liquid supply section for supplying a liquid between the workpiece and at least one of the processing electrode and the feeding electrode; and a drive section for allowing the workpiece and at least one of the processing electrode and the feeding electrode to make a relative movement; wherein application of a voltage is stopped after processing the workpiece until a predetermined processing amount is reached, and the workpiece and at least one of the processing electrode and the feeding electrode are allowed to make a relative movement for a given length of time.

### BRIEF DESCRIPTION OF DRAWINGS

FIGS. 1A through 1C are diagrams illustrating, in a sequence of process steps, an example of the production of a substrate with copper interconnects;

FIG. 2 is a schematic diagram illustrating a conventional electrolytic processing method;

FIG. 3 is a schematic diagram illustrating the influence of a change in the electric conductivity of a fluid in electrolytic processing;

FIG. 4 is a diagram illustrating the principle of electrolytic processing according to the present invention as carried out by allowing a processing electrode and a feeding electrodes to be close to a substrate (workpiece), and supplying pure water or a fluid having an electric conductivity of not more than 500 μS/cm between the processing electrode, the feeding electrode and the substrate (workpiece);

FIG. 5 is a diagram illustrating the principle of electrolytic processing according to the present invention as carried out by mounting the ion exchanger only on the processing electrode and supplying the fluid between the processing electrode and the substrate (workpiece);

FIG. 6 is a plan view illustrating a construction of a substrate processing apparatus provided with an electrolytic processing apparatus according to a first embodiment of the present invention;

FIG. 7 is a vertical sectional view schematically showing the electrolytic processing apparatus in the substrate processing apparatus of FIG. 6;

FIG. 8 is a plan view of FIG. 7;

FIG. 9 is a vertical sectional view schematically showing a regeneration section of the electrolytic processing apparatus of FIG. 7;

FIG. 10 is a graph showing the relationship between the processing amount of a substrate and residual irregularities on the substrate in electrolytic processing;

FIG. 11 is a graph showing the relationship between the electric conductivity of a fluid supplied in electrolytic processing and the substrate flattening properties;

FIG. 12 is a flow chart showing the process of monitoring the electric conductivity of a fluid according to the first embodiment of the present invention;

FIG. 13 is a vertical sectional view schematically showing an electrolytic processing apparatus according to a second embodiment of the present invention;

FIG. 14 is an enlarged view of the main portion of the electrolytic processing apparatus shown in FIG. 13;

FIG. 15 is an enlarged view of the main portion of a regeneration section of the electrolytic processing apparatus of FIG. 13;

FIG. 16 is an enlarged view showing the main portion of a variation of the regeneration section of the electrolytic processing apparatus of FIG. 13;

FIG. 17 is a cross-sectional view schematically showing an electrolytic processing apparatus according to a third embodiment of the present invention;

FIGS. 18A through 18D are diagrams showing examples of the pulse waveforms of pulse voltages according to the present invention;

FIG. 19 is a diagram schematically illustrating electrolytic processing using ion exchangers according to a fourth embodiment of the present invention;

FIG. 20 is a cross-sectional view schematically showing an electrolytic processing apparatus according to a fifth embodiment of the present invention;

FIG. 21 is a perspective view schematically showing an electrolytic processing apparatus according to a sixth embodiment of the present invention;

FIG. 22 is a cross-sectional view of the electrolytic processing apparatus shown in FIG. 21;

FIG. 23 is a graph showing the relationship between the duty ration and the pits level, as observed in electrolytic processing with changing the duty ration of the pulse waveform.

FIG. 24 is a plan view schematically showing an electrolytic processing apparatus having a mini multi-bar type electrode system.

FIG. 25A is an SEM photograph of the processed surface of a wafer sample after processing with a 10V pulse voltage in Example 1;

FIG. 25B is an SEM photograph of the processed surface of a wafer sample after processing with a 20V pulse voltage in Example 1;

FIG. 25C is an SEM photograph of the processed surface of a wafer sample after processing with a 30V pulse voltage in Example 1;

FIG. 25D is an SEM photograph of the processed surface of a wafer sample after processing with a 40V pulse voltage in Example 1;

FIG. 26A is an SEM photograph of the processed surface of a wafer sample after processing at a current density of 80 mA/cm² in Example 2;

FIG. 26B is an SEM photograph of the processed surface of a wafer sample after processing at a current density of 240 mA/cm² in Example 2;

FIG. 26C is an SEM photograph of the processed surface of a wafer sample after processing at a current density of 800 mA/cm² in Example 2;

FIG. 26D is an SEM photograph of the processed surface of a wafer sample after processing at a current density of 1 A/cm² in Example 2;

FIG. 27 is an SEM photograph of the processed surface of a wafer sample after processing with a pulse voltage applied by a slidax power source in Example 3;

FIG. 28A is an SEM photograph of the processed surface of a wafer sample after processing with a 10V DC voltage in Comp. Example 1;

FIG. 28B is an SEM photograph of the processed surface of a wafer sample after processing with a 20V DC voltage in Comp. Example 1;

FIG. 28C is an SEM photograph of the processed surface of a wafer sample after processing with a 30V DC voltage in Comp. Example 1;

FIG. 28D is an SEM photograph of the processed surface of a wafer sample after processing with a 40V DC voltage in Comp. Example 1;

FIG. 29 is a plan view schematically showing an electrolytic processing apparatus according to a seventh embodiment of the present invention;

FIG. 30 is a vertical sectional view of FIG. 29;

FIG. 31A is a plan view showing a rotation preventing mechanism of the electrolytic processing apparatus of FIG. 29;

FIG. 31B is a sectional view taken along line A-A of FIG. 31A;

FIG. 32 is a vertical sectional view showing an electrode section of the electrolytic processing apparatus of FIG. 29;

FIG. 33A is a schematic diagram illustrating the state in the case of not providing a partition member;

FIG. 33B is a schematic diagram illustrating the state in the case of providing a partition member;

FIG. 34A is a graph showing the relationship between electric current and time, as observed in electrolytic processing of the surface of a substrate having a film of two different materials formed in the surface;

FIG. 34B is a graph showing the relationship between voltage and time, as observed in electrolytic processing of the surface of a substrate having a film of two different materials formed in the surface;

FIG. 35A is a diagram schematically illustrating the state after electrolytic processing;

FIG. 35B is a diagram schematically illustrating the state of the surface of the substrate (workpiece) immediately after electrolytic processing;

FIG. 35C is a diagram schematically illustrating the state of the surface of the substrate (workpiece) after removing extraneous matter and residues from the surface;

FIG. 36 is a cross-sectional view showing a main portion of an electrolytic processing apparatus according to an eighth embodiment of the present invention;

FIG. 37 is an enlarged view of a main portion of FIG. 36; and

FIG. 38 is a view corresponding to FIG. 37, showing a variation of the electrode section.

### BEST MODE FOR CARRYING OUT THE INVENTION

Preferred embodiments of electrolytic processing apparatuses according to the present invention will now be described. The parts or components identical to or corresponding to each other are denoted by the same reference numerals, and a part of the repeated explanation thereof will be omitted.

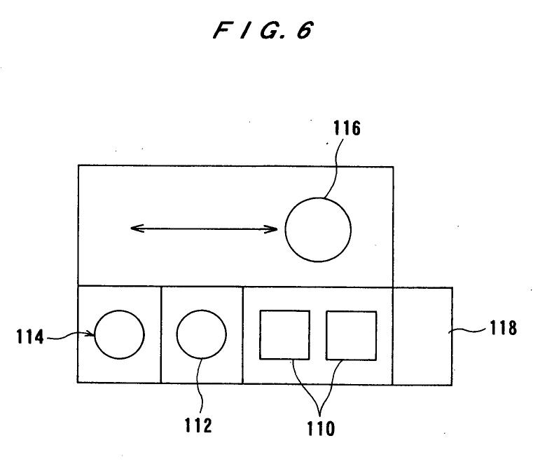

FIG. 6 is a plan view illustrating a construction of a substrate processing apparatus provided with an electrolytic processing apparatus according to a first embodiment of the present invention. Although the electrolytic processing apparatus of this embodiment is provided with a circular table that rotates about its axis, the present invention is not limited to such an embodiment. The same is true for below-described embodiments.

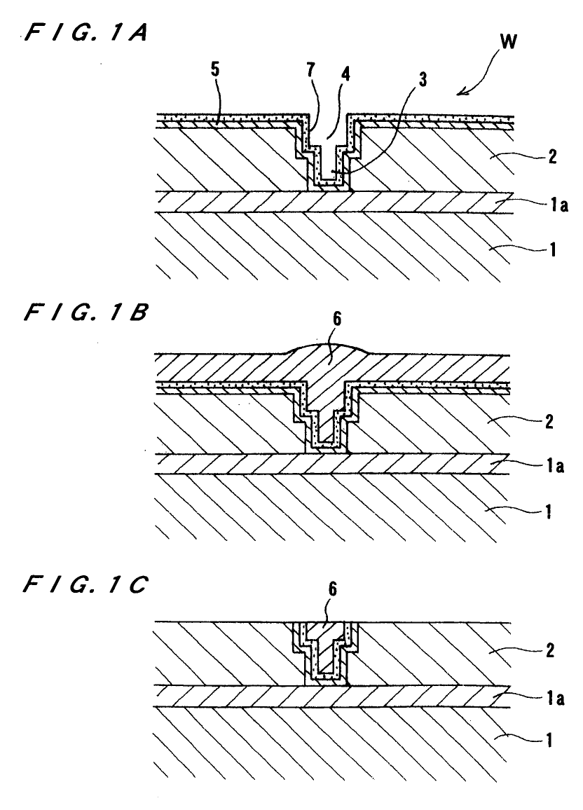

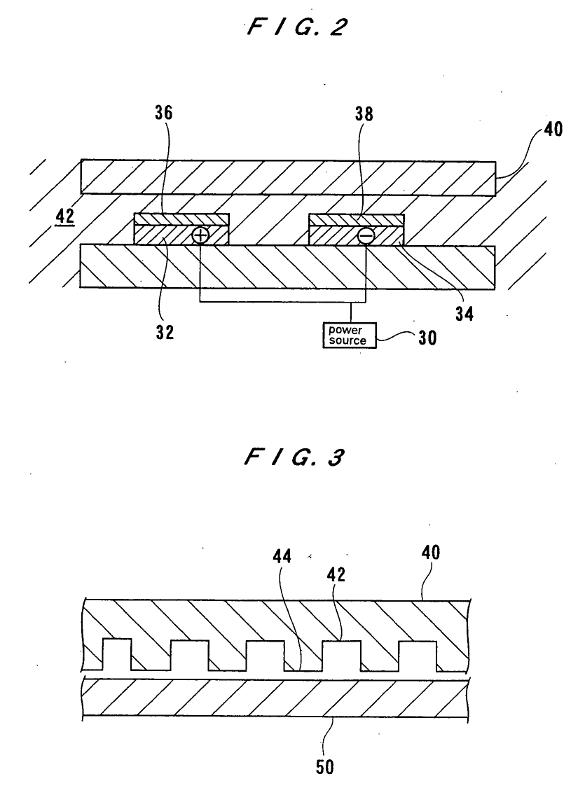

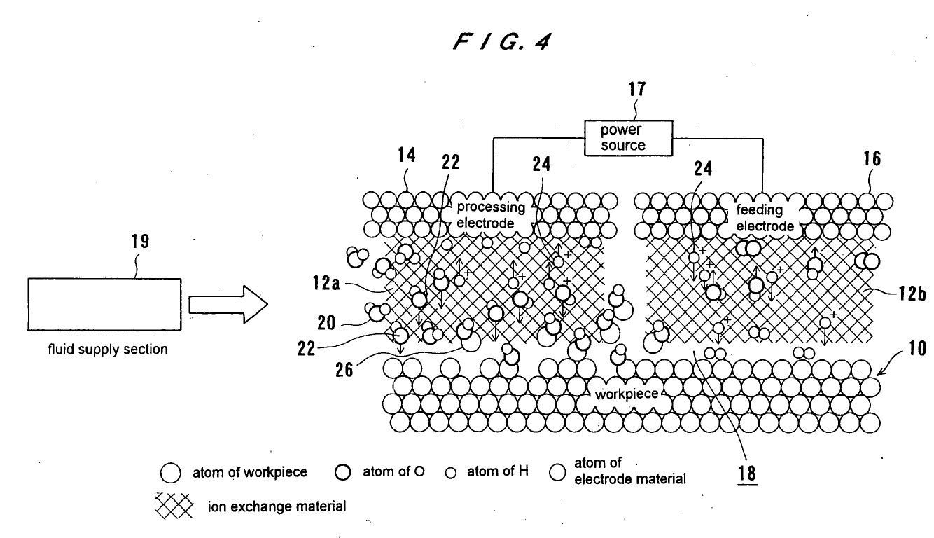

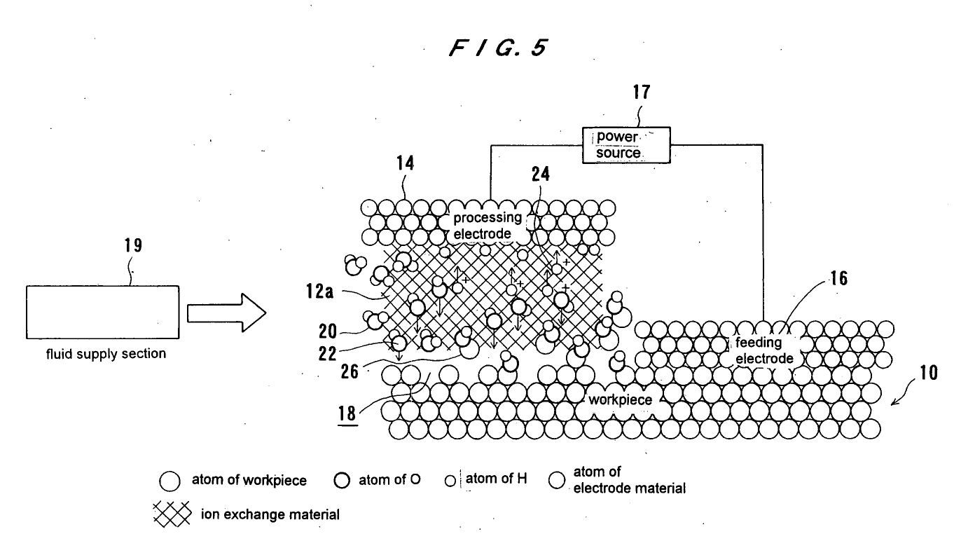

As shown in FIG. 6, the substrate processing apparatus comprises a pair of loading/unloading sections 110 as a carry-in and carry-out section for carrying in and carrying out a cassette housing a substrate, e.g. a substrate W having a copper film 6 as a conductive film (object to be processed) in the surface as shown in FIG. 1B, a reversing machine 112 for reversing the substrate w, and an electrolytic processing apparatus 114. These devices are disposed in series. A transport robot 116 as a transport device, which runs parallel to these devices for transporting and transferring the substrate W therebetween, is provided. The substrate processing apparatus is also provided with a monitor section 118, adjacent to the loading/unloading sections 110, for monitoring a voltage applied between the processing electrodes and the feeding electrodes during electrolytic processing in the electrolytic processing apparatus 114, or an electric current flowing therebetween.

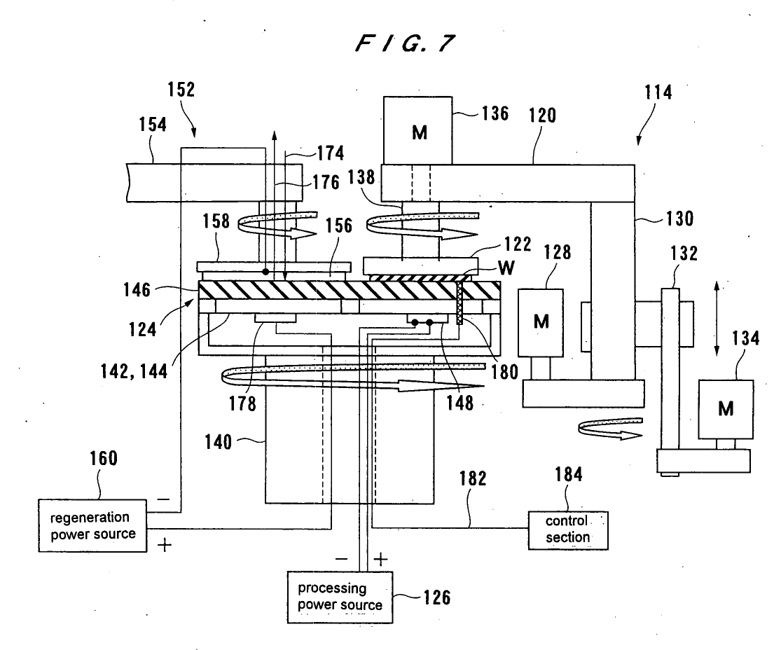

FIG. 7 is a vertical sectional view schematically showing the electrolytic processing apparatus 114 in the substrate processing apparatus of FIG. 6, and FIG. 8 is a plan view of FIG. 7. As shown in FIG. 7, the electrolytic processing apparatus 114 includes a arm 120 that can move vertically and pivot horizontally, a substrate holder 122, supported at the free end of the arm 120, for attracting and holding the substrate W with its front surface facing downwardly (face-down), a disk-shaped electrode section 124 positioned beneath the substrate holder 122, and a processing power source 126 to be connected to the electrode section 124. This embodiment uses as the electrode section 124 such one that has a diameter more than twice that of the substrate W so that the entire surface of the substrate W may undergo electrolytic processing.

The arm 120 is mounted to the upper end of a pivot shaft 130 that is connected to a pivot motor 128, and pivots horizontally by the actuation of the pivot motor 128. The pivot shaft 130 is engaged with a ball screw 132 that extends vertically, and moves vertically together with the arm 120 by the actuation of a vertical-movement motor 134 that is connected to the ball screw 132. The pivot shaft 130 may be connected to an air cylinder, so that the pivot shaft 130 moves vertically by the actuation of the air cylinder.

The substrate holder 122 is connected to a substrate-rotating motor 136 as a first drive section, which is allowed to move the substrate W held by a substrate holder 122 and the electrode section 124 relatively to each other, via a shaft 138. The substrate holder 122 is rotated (about its axis) by the actuation of the substrate-rotation motor 136. The arm 120 can move vertically and pivot horizontally, as described above, the substrate holder 122 can move vertically and pivot horizontally together with the pivot arm 120. A hollow motor 140 as a second drive section, which is allowed to move the substrate W and the electrode section 124 relatively to each other, is disposed below the electrode section 124. The electrode section 124 is directly connected to the hollow motor 140. Therefore, the electrode section 124 is rotated (about its axis) by the actuation of the hollow motor 140.

As shown FIGS. 7 and 8, the electrode section 124 has fan-shaped processing electrodes 142 and feeding electrodes 144 that are disposed alternatively. A film-like ion exchanger 146 (not shown in FIG. 8) is mounted on the upper surfaces of the processing electrodes 142 and the feeding electrodes 144 so as to covers the surfaces of the processing electrodes 142 and the feeding electrodes 144 integrally. The processing electrodes 142 and the feeding electrodes 144 are connected to the processing power source 126 via a slip ring 148. According to this embodiment, the processing electrodes 142 are connected to a cathode of the processing power source 126, and the feeding electrodes 144 are connected to an anode of the processing power source 126. Depending upon the material to be processed, the electrode connected to the cathode of the processing power source 126 may serve as a feeding electrode, and the electrode connected to the anode may serve as a processing electrode. Thus, when the material to be processed is copper, molybdenum or iron, for example, the electrolytic processing action occurs on the cathode side, and therefore the electrode connected to the cathode of the processing power source 126 becomes a processing electrode, and the electrode connected to the anode becomes a feeding electrode On the other hand, when the material to be processed is aluminum or silicon, for example, the electrolytic processing action occurs on the anode side, and therefore the electrode connected to the anode of the processing power source 126 becomes a processing electrode and the electrode connected to the cathode becomes a feeding electrode.

With respect to the processing electrodes 142 and the feeding electrodes 144, oxidation or dissolution thereof due to an electrolytic reaction may be a problem. In view of this, as a material for the electrode, carbon, relatively inactive noble metals, conductive oxides or conductive ceramics is used more preferably than the conventional metals and metal compounds widely used for electrode. A noble metal-based electrode may, for example, be one obtained by plating or coating platinum or iridium onto a titanium that is used as an electrode base material, and then sintering the coated electrode at a high temperature to stabilize and strengthen the electrode. Ceramics products are generally obtained by heat-treating inorganic raw materials, and ceramics products having various properties are produced from various raw materials including oxides, carbides and nitrides of metals and nonmetals. Among them there are ceramics having an electric conductivity. When an electrode is oxidized, the value of the electric resistance generally increases to cause an increase of applied voltage. However, by protecting the surface of an electrode with a non-oxidative material such as platinum or with a conductive oxide such as an iridium oxide, the decrease of electric conductivity due to oxidation of the base material of an electrode can be prevented.

The ion exchanger 146, which is mounted on the upper surfaces of the processing electrodes 142 and the feeding electrodes 144 of the electrode section 124, may be composed of a non-woven fabric which has an anion-exchange group or a cation-exchange group. A cation exchanger preferably carries a strongly acidic cation-exchange group (sulfonic acid group); however, a cation exchanger carrying a weakly acidic cation-exchange group (carboxyl group) may also be used. Though an anion exchanger preferably carries a strongly basic anion-exchange group (quaternary ammonium group), an anion exchanger carrying a weakly basic anion-exchange group (tertiary or lower amino group) may also be used.

The non-woven fabric carrying a strongly basic anion-exchange group can be prepared by, for example, the following method: A polyolefin non-woven fabric having a fiber diameter of 20-50 μm and a porosity of about 90% is subjected to the so-called radiation graft polymerization, comprising γ-ray irradiation onto the non-woven fabric and the subsequent graft polymerization, thereby introducing graft chains; and the graft chains thus introduced are then aminated to introduce quaternary ammonium groups thereinto. The capacity of the ion-exchange groups introduced can be determined by the amount of the graft chains introduced. The graft polymerization may be conducted by the use of a monomer such as acrylic acid, styrene, glicidyl methacrylate, sodium styrenesulfonate or chloromethylstyrene, or the like. The amount of the graft chains can be controlled by adjusting the monomer concentration, the reaction temperature and the reaction time. Thus, the degree of grafting, i.e. the ratio of the weight of the non-woven fabric after graft polymerization to the weight of the non-woven fabric before graft polymerization, can be made 500% at its maximum. Consequently, the capacity of the ion-exchange groups introduced after graft polymerization can be made 5 meq/g at its maximum.

The non-woven fabric carrying a strongly acidic cation-exchange group can be prepared by the following method: As in the case of the non-woven fabric carrying a strongly basic anion-exchange group, a polyolefin non-woven fabric having a fiber diameter of 20-50 μm and a porosity of about 90% is subjected to the so-called radiation graft polymerization comprising γ-ray irradiation onto the non-woven fabric and the subsequent graft polymerization, thereby introducing graft chains; and the graft chains thus introduced are then treated with a heated sulfuric acid to introduce sulfonic acid groups thereinto. If the graft chains are treated with a heated phosphoric acid, phosphate groups can be introduced. The degree of grafting can reach 500% at its maximum, and the capacity of the ion-exchange groups thus introduced after graft polymerization can reach 5 meq/g at its maximum.

The base material of the ion exchanger 146 may be a polyolefin such as polyethylene or polypropylene, or any other organic polymer. Further, besides the form of a non-woven fabric, the ion exchanger may be in the form of a woven fabric, a sheet, a porous material, or short fibers, etc. When polyethylene or polypropylene is used as the base material, graft polymerization can be effected by first irradiating radioactive rays (γ-rays and electron beam) onto the base material (pre-irradiation) to thereby generate a radical, and then reacting the radical with a monomer, whereby uniform graft chains with few impurities can be obtained. When an organic polymer other than polyolefin is used as the base material, on the other hand, radical polymerization can be effected by impregnating the base material with a monomer and irradiating radioactive rays (γ-rays, electron beam and UV-rays) onto the base material (simultaneous irradiation). Though this method fails to provide uniform graft chains, it is applicable to a wide variety of base materials.

By using a non-woven fabric having an anion-exchange group or a cation-exchange group as the ion exchanger 146, it becomes possible that pure water or ultrapure water, or a liquid such as an electrolytic solution can freely move within the non-woven fabric and easily arrive at the active points in the non-woven fabric having a catalytic activity for water dissociation, so that many water molecules are dissociated into hydrogen ions and hydroxide ions. Further, by the movement of pure water or ultrapure water, or a liquid such as an electrolytic solution, the hydroxide ions produced by the water dissociation can be efficiently carried to the surfaces of the processing electrodes 142, whereby a high electric current can be obtained even with a low voltage applied.

When the ion exchanger 146 have only one of anion-exchange groups and cation-exchange groups, a limitation is imposed on electrolytically processible materials and, in addition, impurities are likely to form due to the polarity. In order to solve this problem, an anion exchanger carrying an anion-exchange group and a cation exchanger carrying a cation-exchange group may be superimposed, or the ion exchanger 146 may carry both of an anion-exchange group and a cation-exchange group per se, whereby a range of materials to be processed can be broadened and the formation of impurities can be restrained.

As shown in FIG. 8, a pure water jet nozzle 150, extending in the radial direction of the electrode section 124, is disposed above the electrode section 124. The pure water jet nozzle 150 has a plurality of jet ports 150a for supplying a fluid, such as pure water or ultrapure water, to the upper surface of the electrode section 124, and comprises a pure water supply section for supplying a fluid, such as pure water or ultrapure water, to the electrode section 124. Pure water herein refers to a water having an electric conductivity of not more than 10 μS/cm, and ultrapure water refers to a water having an electric conductivity of not more than 0.1 μS/cm. Use of pure water or ultrapure water containing no electrolyte upon electrolytic processing can prevent extra impurities such as an electrolyte from adhering to and remaining on the surface of the substrate W. Further, copper ions or the like dissolved during electrolytic processing are immediately caught by the ion exchanger 146 through the ion-exchange reaction. This can prevent the dissolved copper ions or the like from re-precipitating on the other portions of the substrate W, or from being oxidized to become fine particles which contaminate the surface of the substrate W.

It is possible to use, instead of pure water or ultrapure water, a liquid having an electric conductivity of not more than 500 μS/cm or an electrolytic solution obtained by adding an electrolyte to pure water or ultrapure water. Use of an electrolytic solution can further lower the electric resistance and reduce the power consumption. A solution of a neutral salt such as NaCl or Na₂SO₄, a solution of an acid such as HCl or H₂SO₄, or a solution of an alkali such as ammonia, may be used as the electrolytic solution, and these solutions may be selectively used according to the properties of the workpiece.

Further, it is also possible to use, instead of pure water or ultrapure water, a liquid obtained by adding a surfactant or the like to pure water or ultrapure water, and having an electric conductivity of not more than 500 μS/cm, preferably not more than 50 μS/cm, more preferably not more than 2 μS/cm. Due to the presence of a surfactant, the liquid can form a layer, which functions to inhibit ion migration evenly, at the interface between the substrate W and the ion exchanger 146, thereby moderating concentration of ion exchange (metal dissolution) to enhance the flatness of the processed surface. The surfactant concentration is desirably not more than 100 ppm. When the value of the electric conductivity is too high, the current efficiency is lowered and the processing rate is decreased. Use of the liquid having an electric conductivity of not more than 500 μS/cm, preferably not more than 50 μS/cm, more preferably not more than 2 μS/cm, can attain a desired processing rate.

When electrolytic processing of copper is conducted by using, as the ion exchanger 146, for example, an ion exchanger having a cation-exchange group, the ion-exchange group of the ion exchanger (cation exchanger) 146 is saturated with copper after the processing, whereby the processing efficiency of the next processing is lowered. When electrolytic processing of copper is conducted by using, as the ion exchanger 146, an ion exchanger having an anion-exchange group, fine particles (contaminants) of a copper oxide can be produced and adhere to the surface of the ion exchanger (anion exchanger) 146, whereby particles can contaminate the surface of a next substrate to be processed. The electrolytic processing apparatus 114 according to this embodiment, as shown in FIG. 7, is provided with a regeneration section 152, as a contaminant removing section for removing contaminants present on the surface or the inside of the ion exchange 146, for regenerating the ion exchanger 146. Above-described harmful can be eliminated by regenerating the ion exchanger 146 with regeneration section 152 during processing or after processing of the substrate W.

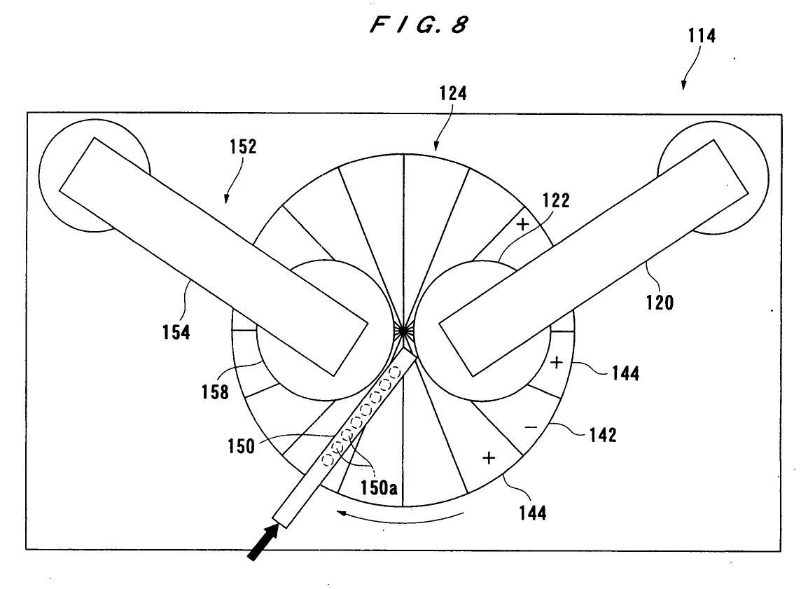

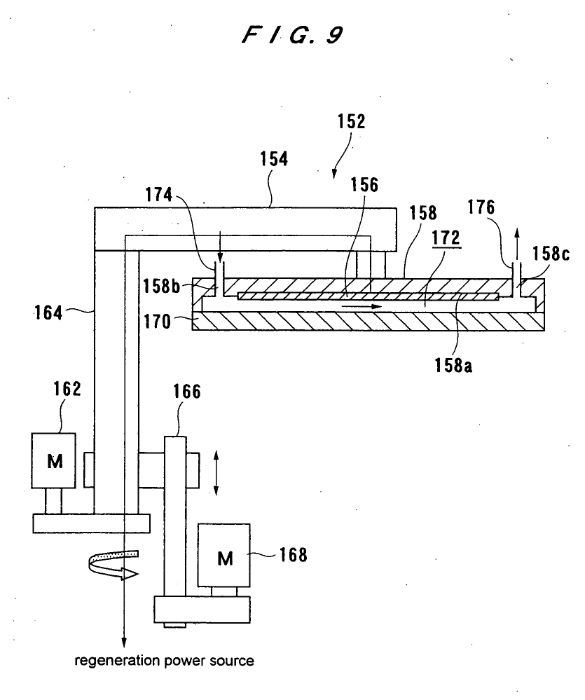

FIG. 9 is a vertical sectional view schematically showing the regeneration section 152 of the electrolytic processing apparatus 114 of FIG. 7. As shown in FIG. 9, the regeneration section 152 includes an arm 154 that can move vertically and pivot horizontally, a disk-shaped regeneration electrode holder 158, supported at the free end of the arm 154, for holding a regeneration electrode 156, and a regeneration power source 160 (see FIG. 7) to be connected to the regeneration electrode 156 and the electrode section 124.

The arm 154 is attached to the upper end of a pivot shaft 164 that is connected to a pivot motor 162, and pivots horizontally by the actuation of the pivot motor 162. The pivot shaft 164 is engaged with a ball screw 166 that extends vertically, and moves vertically together with the arm 154 by the actuation of a vertical-movement motor 168 connected to the ball screw 166. The arm 154 thus can move vertically and pivot horizontally, and the regeneration electrode holder 158 can move vertically and pivot horizontally together with the arm 154. The pivot shaft 164 may be connected to an air cylinder, so that the pivot shaft 164 moves vertically by the actuation of the air cylinder.

The regeneration electrode holder 158 has a downwardly-open circular depression 158a. A disc-shaped regeneration electrode 156 is mounted on the upper surface of the depression 158a. The lower opening of the depression 198a is closed with a partition 170, whereby a flow passage 172, defined by the partition 170, is formed in the regeneration electrode holder 158. Further, a fluid inlet 158b and a fluid outlet 158c, communicating with peripheral portions of the flow passage 172, are respectively provided at the both end portions in the diametrical direction of the regeneration electrode holder 158. The fluid inlet 158b and the fluid outlet 158c are respectively connected to a fluid inlet pipe 174 and to a fluid outlet pipe 176. A fluid (liquid) is supplied from the fluid inlet pipe 174 into the flow passage 172 during the regeneration of the ion exchanger 146. The liquid supplied fills the flow passage 172, so that the regeneration electrode 156 is immersed in the liquid. Thereafter, the liquid supplied into the flow passage 172 flows in one direction in the flow passage 172 and is discharged out sequentially from the fluid outlet pipe 176.

The regeneration electrode 156 is connected to one of electrodes (e.g. cathode) of the regeneration power source 160, while the processing electrodes 142 and the feeding electrodes 144 of the electrode section 124 are connected to the other electrode (e.g. anode) of the regeneration power source 160 via a slip ring 178 (see FIG. 7). The arm 154 is lowered so that the partition 170 of the regeneration electrode holder 158 contacts or gets close to the surface (upper surface) of the ion exchanger 148 mounted on the processing electrodes 142 and the feeding electrodes 144. When a voltage is applied between the regeneration electrode 156 and the processing electrodes 142, feeding electrodes 144 via the regeneration power source 160, dissolution of the contaminants such as copper adhering to the ion exchanger 146 is promoted, whereby the ion exchanger 146 is regenerated.

According to this embodiment, the ion exchanger used as the partition 170 has the same type of ion-exchange group as the ion exchanger 146 to be regenerated. That is, when an ion exchanger having a cation-exchange group is used as the ion exchanger 146 of the electrode section 124, an ion exchanger having a cation-exchange group is used also as the partition 170. When an ion exchanger having an anion-exchange group is used as the ion exchanger 146 of the electrode section 124, an ion exchanger having an anion-exchange group is used also as the partition 170. When an ion exchanger having a cation-exchange group is used as the ion exchanger 146 to be regenerated, the regeneration electrode 156 is connected to a cathode of the regeneration power source 160, and when an ion exchanger having an anion-exchange group is used as the exchanger 146 to be regenerated, the regeneration electrode 156 is connected to an anode of the regeneration power source 160.

It is desired that the partition 170 do not hinder a migration therethrough of impurity ions removed from the ion exchanger 146 to be regenerated and inhibit permeation therethrough of the fluid (including ions in the fluid) flowing in the flow passage 172 between the partition 170 and the regeneration electrode 156 into the ion exchanger 146 side. Use of a film-type ion exchanger, which permits selective permeation therethrough either cations or anions selectively, as the ion exchanger of the partition 170 can prevent intrusion of the fluid flowing between the partition 170 and the regeneration electrode 156 into the ion exchanger 146 to be generated.

The fluid to be supplied into the flow passage 172 is for discharging ions, which have moved from the ion exchanger 146 to be regenerated and passed through the partition 170, out of the system by the flow of the fluid. It is desired that this fluid be a fluid, such as an electrolytic solution, which has a high electric conductivity and does not form a hardly soluble or insoluble compound through a reaction with ions removed from the ion exchanger 146 to be regenerated. By supplying above fluid, which has a high conductivity and does not form a insoluble compound through a reaction with ions removed from the ion exchanger 146, into the flow passage 172, it is possible to reduce the power consumption in the regeneration section 152 because of its low electric resistance, and to prevent an insoluble compound (by-product) from being produced through a reaction with the impurity ions and adhering to the partition 170. A suitable fluid may be chosen depending upon the kind of the impurity ion to be discharged. For example, when regenerating the ion exchanger that was used in electrolytic processing of copper, sulfuric acid with a concentration of 1 wt % or higher may be used.

As shown in FIG. 7, the electrode section 124 is provided with a sensor (probe) 180 for measuring the electric conductivity of the fluid present in the vicinity of the substrate W. The sensor 180 is connected via a cable 182 to a control section 184 for controlling the processing conditions. The control section 184 can effect control of the processing conditions based on the electric conductivity measured by the sensor 180. For example, based on the electric conductivity measured by the sensor 180, the control section 184 can control the flow rate of the fluid to be jetted from the jet ports 150a of the pure water jet nozzle 150, or can start and stop the operation of the regeneration section 152.

Next, substrate processing (electrolytic processing) by using the electrolytic processing apparatus of this embodiment will be described. First, a substrate W, e.g. a substrate W, as shown in FIG. 1B, which has in its surface a copper film 6 as a conductive film (object to be processed), is taken by the transport robot 116 out of the cassette housing substrates and set in the loading/unloading section 110. If necessary, the substrate W is transferred to the reversing machine 112 by the transport robot 116 to reverse the substrate W so that the front surface of the substrate W having the conductor film (copper film 6) faces downwardly. Then, the transport robot 116 receives the reversed substrate W, and transfers it to the electrolytic processing apparatus 114.

The substrate W is attracted and held by the substrate holder 122 of the electrolytic processing apparatus 114. The arm 120 is moved to move the substrate holder 122 holding the substrate W to a processing position right above the electrode section 124. Next, the vertical-movement motor 134 is driven to lower the substrate holder 122 so as to bring the substrate W held by the substrate holder 122 close to or into contact with the surface of the ion exchanger 146 of the electrode section 124. Thereafter, the hollow motor 140 is driven to rotate the electrode section 124 and, at the same time, the substrate-rotating motor 136 is driven to rotate the substrate holder 122 and the substrate W so that the substrate W and the electrode section 124 make a relative movement, while pure water or ultrapure water is jetted from the jet ports 150a of the pure water jet nozzles 150 to between the substrate W and the electrode section 124. A given voltage is applied from the processing power source 126 to between the processing electrodes 142 and the feeding electrodes 144, and electrolytic processing of the conductive film (copper film 6) in the surface of the substrate W is carried out at the processing electrodes (cathodes) 142 through the action of hydrogen ions or hydroxide ions produced by the ion exchanger 146.

During the electrolytic processing, water molecules in the fluid, such as ultrapure water, are dissociated by the ion exchanger 146 into hydroxide ions and hydrogen ions. The hydroxide ions thus produced, for example, are carried, by the electric field between the substrate W and the processing electrodes 142 and by the flow of the fluid such as ultrapure water, to the surface of the substrate W facing the processing electrode 142, whereby the density of the hydroxide ions in the vicinity of the substrate W is increased, and the hydroxide ions are reacted with the atoms of the substrate W. The reaction product produced by reaction is dissolved in the fluid, and removed from the surface of the substrate W by the flow of the fluid along the surface of the substrate W. Removal processing of the surface layer of the substrate W is thus effected.

After completion of the electrolytic processing, the processing power source 126 is disconnected form the processing electrodes 142 and the feeding electrodes 144, and the rotations of the electrode section 124 and the substrate holder 122 are stopped. Thereafter, the substrate holder 122 is raised, and the substrate W is transferred to the transport robot 116 after moving the arm 120. The transport robot 116 takes the substrate W from the substrate holder 122 and, if necessary, transfers the substrate W to the reversing machine 112 for reversing it, and then returns the substrate W to the cassette in the loading/unloading section 110.

It is to be noted here that when a liquid like ultrapure water which itself has a large resistivity is used, the electric resistance can be lowered by bringing the ion exchanger 146 into contact with the substrate W, whereby the requisite voltage can also be lowered and hence the power consumption can be reduced. The “contact” does not imply “press” for giving a physical energy (stress) to a workpiece as in CMP. Accordingly, the electrolytic processing apparatus of this embodiment employs the vertical-movement motor 134 for bringing the substrate W into contact with or close to the electrode section 124, and does not have such a press mechanism as usually employed in a CMP apparatus that presses a substrate against a polishing member aggressively. In this regard, according to a CMP apparatus, a substrate is pressed against a polishing surface generally at a pressure of about 20-50 kPa, whereas in the electrolytic processing apparatus of this embodiment, the substrate W may be contacted with the ion exchanger 146 at a pressure of less than 20 kPa. Even at a pressure less than 10 kPa, a sufficient removal processing effect can be achieved.

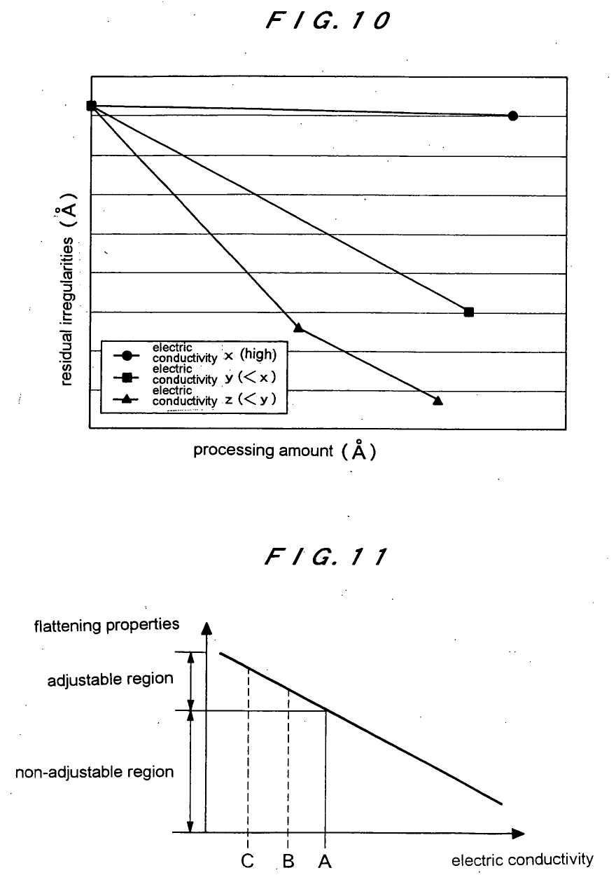

FIG. 10 is a graph showing the relationship between the processing amount of the substrate W and residual irregularities on the substrate W in electrolytic processing. As can be seen from FIG. 10, when the electric conductivity of the fluid supplied is high, the residual irregularities are not eliminated with the progress of electrolytic processing, whereas the residual irregularities are eliminated with the progress of electrolytic processing when the electric conductive of the fluid is low, and the degree of elimination is larger as the electric conductivity is lower. Thus, as shown in FIG. 11, the lower the electric conductivity of the fluid supplied is, the better are the flattening properties of the fluid. In view of this fact, according to this embodiment, the electric conductivity of the fluid is measured (monitored) by the above-described sensor 180 and, based on the electric conductivity measured, the processing conditions are changed so as to maintain the electric conductivity of the fluid at such a level that the flattening properties of the fluid are not affected.

According to this embodiment, an electric conductivity of e.g. not more than 500 μS/cm is set as a level not affecting the flattening properties. In this connection, as shown in FIG. 11, the value 500 μS/cm is set as a first threshold A. The under-500 μS/cm region is regarded as a region in which adjustment of the electric conductivity is possible (adjustable region), while the over-500 μS/cm region is regarded as a region in which adjustment of the electric conductivity is impossible (non-adjustable region). Further, the value 50 μS/cm is set as a second threshold B of electric conductivity in the adjustable region of FIG. 11, and the value 2 μS/cm is set as a third threshold C.

FIG. 12 is a flow chart showing the process of monitoring the electric conductivity of the fluid according to this embodiment. During electrolytic processing, the electric conductivity of the fluid (pure water or ultrapure water) is measured with the sensor 180, and the measured electric conductivity value is sent to the control section 184. A determination is made in the control section 184 as to whether the measured electric conductivity of the fluid is higher than the above threshold C, i.e., 2 μS/cm (step 1). When the measured electric conductivity is not higher than the threshold C (2 μS/cm), since the electric conductivity is at a level not affecting the flattening properties, the operation of the electrolytic processing apparatus 114 is continued with the current processing conditions.

When the measured electric conductivity is higher than the threshold C (2 μS/cm), on the other hand, the processing conditions are changed by the control section 184 (step 2). For example, the control section 184 changes the flow rate of the fluid jetted from the pure water jet nozzle 150. When the electric conductivity of the fluid present between the ion exchanger 146 and the substrate W has increased, the flow rate of the fluid jetted from the pure water jet nozzle 150 is increased to thereby discharge the fluid staying between the ion exchanger 146 and the substrate W and containing contaminants, whereby the electric conductivity of the fluid present between the ion exchanger 146 and the substrate W can be kept at a desired level.

After the processing conditions are changed in step 2, a determination is made as to whether the measured electric conductivity is higher than the threshold B, i.e., 50 μS/cm (step 3). When the electric conductivity is not higher than the threshold B 150 μS/cm), since the electric conductivity is at a level not affecting the flattening properties, the operation of the electrolytic processing apparatus 114 is continued with the current processing conditions. When the measured electric conductivity is higher than the threshold B (50 μS/cm), on the other hand, for example, an alarm is displayed on a display device installed in the substrate processing apparatus (step 4), and the processing conditions are again changed by the control section 184 (step 5).

After the processing conditions are changed by the control section 184 in step 5, a determination is made as to whether the measured electric conductivity is higher than the threshold A, i.e. 500 μS/cm (step 6). When the measured electric conductivity is not higher than the threshold A (500 μS/cm), since the electric conductivity is at a level not affecting the flattening properties, the operation of the electrolytic processing apparatus 114 is continued with the current processing conditions. When the measured electric conductivity is higher than the threshold A (500 μS/cm), on the other hand, for example, an alarm is displayed on the above-described display device (step 7). In this case, adjustment of the electric conductivity is regarded as impossible, and the operation of the electrolytic processing apparatus 114 is stopped.

Thus, according to the electrolytic processing apparatus of the present invention, the electric conductivity of the fluid in a processing atmosphere is measured and, based on the measured electric conductivity of the fluid, the processing conditions may be changed so that the electric conductivity of the fluid can be kept at such a level that the flattening properties are not affected, preferably not more than 500 μS/cm, more preferably not more than 50 μS/cm, most preferably not more than 2 μS/cm. This makes it possible to suppress a change in the electric conductivity of the fluid due to contaminants, such as processing products and scrapings of the ion exchanger produced upon the electrolytic processing, metal ions, an additive, etc., thereby maintaining the good flattening properties at all times. The monitoring of the electric conductivity of the fluid may be carried out either during or after electrolytic processing of the substrate W.

Though in the above-described embodiment the electric conductivity of the fluid between the ion exchanger 146 and the substrate W is maintained at a desired level by changing the processing conditions, instead of the change of processing conditions in step 2 or 5 of FIG. 12, it is possible to effect regeneration of the ion exchanger 146 by the regeneration section 152. Regeneration of the ion exchanger 146 by the regeneration section 152 can remove contaminants on the surface or in the interior of the ion exchanger 146, which makes it possible to maintain the electric conductivity of the fluid between the ion exchanger 146 and the substrate W at a level that does not affect the flattening properties, as the result. The regeneration treatment of the ion exchanger 146 by the regeneration section 152 will now be described.

In the regeneration treatment, the arm 154 of the regeneration section 152 is pivoted to move the regeneration section 152 to above the electrode section 124, and then the regeneration section 124 is lowered so that the lower surface of the partition 170 of the regeneration section 124 is brought close to or into contact with the upper surface of the ion exchanger 146 on the upper surface of the electrode section 124. Thereafter, one of the electrodes (e.g. cathode) of the regeneration power source 156 is connected to the regeneration electrode 156, and the other electrode (e.g. anode) is connected to the processing electrodes 142 and the feeding electrodes 144, thereby applying a voltage between the regeneration electrode 156 and the electrodes 142, 144, while the electrode section 124 is rotated by the actuation of the hollow motor 140. The regeneration treatment may be carried out without applying electricity to the feeding electrodes 144.

At the same time, pure water or ultrapure water is jetted from the pure water jet nozzle 150 to the upper surface of the electrode section 124, and a liquid is supplied to the flow passage 172 formed in the regeneration electrode holder 158. Thus, the area between the partition 170 and the electrode section 124 is filled with pure water or ultrapure water, thereby immersing the ion exchanger 146 to be regenerated in pure water or ultrapure water. At the same time, the liquid fills the flow passage 172, so that the regeneration electrode 156 is immersed in the liquid. Thereafter, the liquid supplied into the flow passage 172 flows in one direction in the flow passage 172 and is discharged out from the fluid outlet 158c.

As described above, the regeneration electrode 156 is controlled to have the opposite polarity to the polarity of the ion exchangers 146 (and the partition 170). Thus, when a cation exchanger is used as the ion exchanger 146 (and the partition 170), the regeneration electrode 156 should become a cathode and the electrodes 142, 144 should become an anode. Conversely, when an anion exchanger is used as the ion exchanger 146 (and the partition 170), the regeneration electrode 156 should become an anode and the electrodes 142,144 should become a cathode.

By the above operation, ions in the ion exchanger 146 are moved toward the regeneration electrode 156 and passed through the partition 170 to arrive at the flow passage 172, and the ions that have arrived at the flow passage 172 are discharged out of the system by the flow of the liquid supplied to the flow passage 172, whereby the ion exchanger 146 can be regenerated. When a cation exchanger is used as the ion exchanger 146, cations taken in the ion exchange 146 pass through the partition 170 and move into the flow passage 172; when an anion exchanger is used as the ion exchanger 146, anions taken in the ion exchanger 146 pass through the partition 170 and move into the flow passage 172, whereby the ion exchanger 146 is regenerated.

After completion of the regeneration treatment, electrical connections between the regeneration power source 160 and the electrodes 142, 144 and regeneration electrode 156 are shut off, and regeneration section 152 is raised, and then the rotation of the electrode section 124 is stopped. Thereafter, the arm 154 is pivoted to return the regeneration section 152 to the original position. As shown in FIG. 7, this embodiment uses as the electrode section 124 such one that has a diameter more than twice that of the substrate W so that the regeneration treatment can be carried out by the regeneration section 152 during electrolytic processing of the substrate W.

Thus, according to the electrolytic processing apparatus of the present invention, the electric conductivity of the fluid in a processing atmosphere is measured during or after electrolytic processing and, based on the measured electric conductivity of the fluid, contaminants on the surface or in the interior of the ion exchanger may be removed so that the electric conductivity of the fluid can be kept at such a level that the flattening properties of the fluid are not affected, preferably not more than 500 μS/cm, more preferably not more than 50 μS/cm, most preferably not more than 2 μS/cm, as the result. This makes it possible to suppress a change in the electric conductivity of the fluid due to contaminants, such as processing products and scrapings of the ion exchanger produced upon the electrolytic processing, metal ions, an additive, etc., thereby maintaining the good flattening properties at all times.

It would be ideal if the sensor 180 for measuring the electric conductivity of the fluid could directly measure the electric conductivity of the fluid present in the recess (depressed portion 42 of FIG. 3) of a pattern formed in the substrate W. It is however actually difficult to provide such a sensor in the recess or on the raised portion (raised portion 44 of FIG. 3). According to this embodiment, therefore, the sensor 180 is located in the electrode section 124 positioned in the vicinity of the substrate W. However, the location of the sensor 180 is not limited to the electrode section. For example, the sensor 180 may be located in a fluid discharge section for discharging the fluid. In the case where the discharged fluid is reused (recycled), it is possible to locate the sensor 180 in a fluid supply section for supplying the fluid.

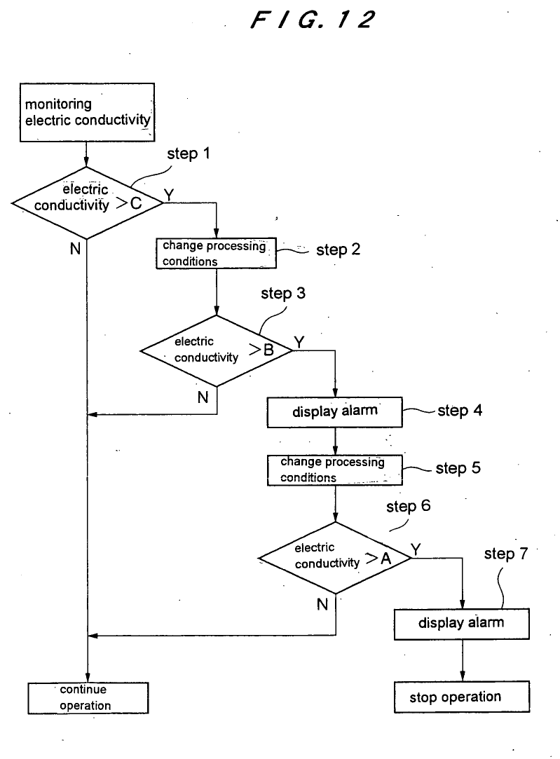

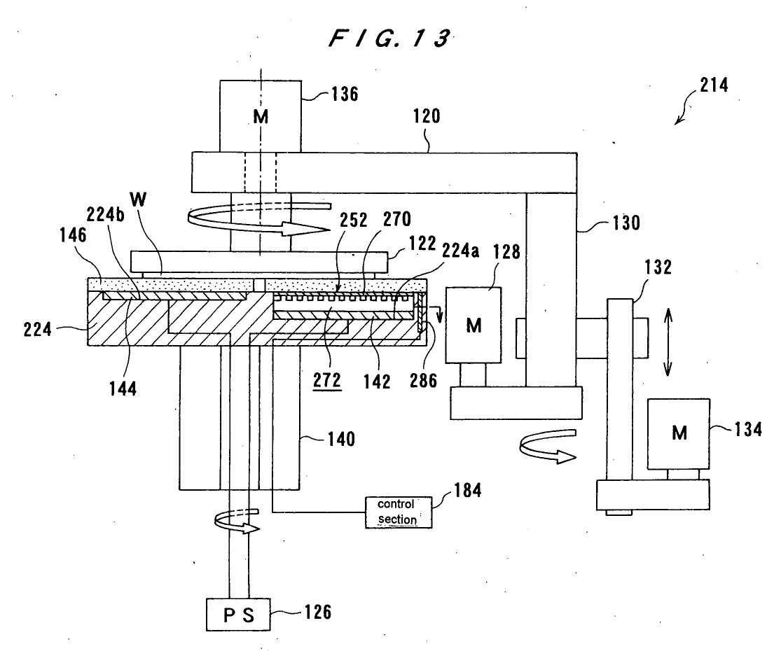

FIG. 13 is a vertical sectional view schematically showing an electrolytic processing apparatus according to a second embodiment of the present invention. According to the electrolytic processing apparatus 214 of this embodiment, a cation exchanger is used as the ion exchanger 146 mounted in the electrode section 224, and part of the ion exchanger (cation exchanger) 146 that is in such a position that it covers the surface of the processing electrodes 142 is subjected to regeneration. Thus, each processing electrode 142 is embedded in a recess 224a formed in an electrode section 224, and each feeding electrode 144 is embedded in a recess 224b formed in the electrode section 224. The recess 224a for embedding of the processing electrode 142 is deeper than the recess 224b for embedding of the feeding electrode 144, and a regeneration section 252 is provided in the recess 224a. According to this embodiment, the processing power source 126 also serves as a regeneration power source, and the processing electrode 142 also serves as a regeneration electrode.

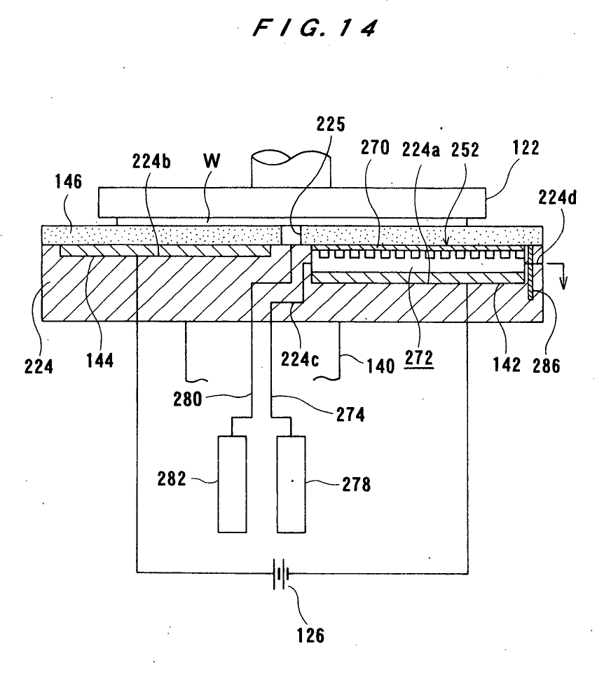

FIG. 14 is an enlarged view of the main portion of the electrolytic processing apparatus shown in FIG. 13. As shown in FIG. 14, the regeneration section 252 includes a partition 270 that closes the upper opening of the recess 224a. By thus closing the opening of the recess 224a with the partition 270, a flow passage 272 is formed between the processing electrode 142 and the partition 270 defined by the partition 270. It is desired that the partition 270, as with the above-described partition 170 in the first embodiment, do not hinder the migration therethrough of impurity ions removed from the ion exchanger 146 to be regenerated, and inhibit permeation therethrough of the liquid (including ions in the liquid) flowing in the flow passage 272 between the partition 270 and the processing electrode 142 into the ion exchanger 146 to be generated.

Further, the electrode section 224 is provided with a fluid supply inlet 224c which extends horizontally and communicates with the flow passage 272 at the central portion of the electrode section 224, and a fluid discharge outlet 224d which extends horizontally from the outer periphery of the flow passage 272 and opens at the outer circumferential surface of the electrode section 224. The fluid supply inlet 224c is connected to a fluid supply section 278 for supplying a fluid for discharging contaminants via a fluid supply pipe 274 that extends in the hollow portion of the hollow motor 140. A discharging fluid (liquid) is supplied through the fluid supply inlet 224c into the flow passage 272 when the ion exchanger 146 is regenerated. The liquid thus supplied into the flow passage 272 fills the flow passage 272 so that the processing electrode 142 is immersed in the liquid. Thereafter, the liquid supplied into the flow passage 272 flows in one direction in the flow passage 272 and is discharged out sequentially from the fluid discharge outlet 224d.

The fluid to be supplied into the flow passage 272 is for discharging ions, which have moved from the ion exchanger 146 to be regenerated and passed through the partition 270, out of the system by the flow of the fluid. The fluid supplied between the partition and the regeneration electrode is preferably a fluid that has high electric conductivity (dielectric constant) of e.g. not less than 50 μS/cm and does not form an insoluble compound through a reaction with an ion which is removed from the ion exchanger 146 to be regenerated. By supplying such a fluid, which has an electric conductivity (dielectric constant) of not less than 50 μS/cm and does not form a insoluble compound through a reaction with ions removed from the ion exchanger 146, it is possible to reduce the power consumption in the regeneration section 252 because of its low electric resistance, and to prevent an insoluble compound (by-product) from being produced through a reaction with the impurity ions and adhering to the partition 270. A suitable fluid may be chosen depending upon the kind of the impurity ion to be discharged. For example, when regenerating the ion exchanger that was used in electrolytic processing of copper, sulfuric acid with a concentration of 1 wt % or higher may be used.

According to this embodiment, as shown in FIG. 14, a through-hole 225 is formed in the central portion of the electrode section 224. The through-hole 225 is connected to a fluid supply section 282 for supplying a fluid for electrolytic processing such as pure water, preferably ultrapure water, via a fluid supply pipe 280 that extends inside the hollow portion of the hollow motor 140. The processing fluid, such as pure water or ultrapure water, is supplied through the through-hole 225 to the upper surface of the electrode section 224, and spreads to the entire processing surface of the substrate W through the ion exchanger 146 having water absorbing property.

According to this embodiment, an ion exchanger having the same type of ion-exchange group as the ion exchanger 146 to be regenerated is used as the partition 270 of the regeneration section 252. That is, a cation exchanger is used as the partition 270. Such a partition (ion exchanger) 270 can permit permeation therethrough of only those ions as coming from the ion exchanger (cation exchanger) 146 and inhibit migration therethrough of ions in the discharging fluid flowing in the flow passage 272 into the ion exchanger 146 side. When an anion exchanger having an anion-exchange group is used as the ion exchanger 146, it is preferred to use an anion exchanger as the partition (ion exchanger).

FIG. 15 is an enlarged view of the main portion of the regeneration section 252 of the electrolytic processing apparatus of FIG. 14. As shown in FIG. 15, this embodiment employs, as the partition (ion exchanger) 270 that forms the flow passage 272 between it and the processing electrode 142, a two-layer laminate structure consisting of a surface layer 270a composed of a thin film-shaped ion exchanger having a surface smoothness and flexibility, and a backside layer 207b composed of an ion exchanger having a large ion exchange capacity. Further, a support 284 for supporting the partition 270 in a flat state is provided in the flow passage 272. Through-holes 284a are formed at certain locations in the support 284.

Such a partition 270 of laminated structure of ion exchangers, because of the backside layer 270b composed of the ion exchange, has an increased total ion exchange capacity as a whole. Further, because of the elasticity, the partition 270 can be prevented from being damaged even when an excessive pressure is applied thereto during processing. As the surface layer 270a, an ion exchanger, which is permeable to ions, but not permeable to a liquid, may be used when an electrolytic solution is used as the discharging fluid that flows through the flow passage 272. When an ion-exchange liquid is used as the discharging fluid, the surface layer 270a may permit permeation therethrough of water insofar as an ion exchanger in the discharging fluid does not leak therethrough. The provision of the support 284 ensures the formation of the flow passage 272 and enables lamination of the ion exchanger on the support 284.

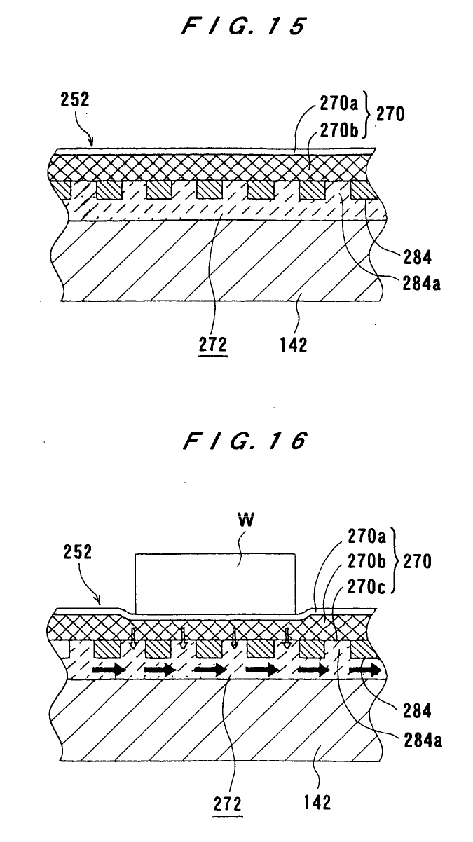

FIG. 16 is an enlarged view showing the main portion of a variation of the regeneration section 252 of the electrolytic processing apparatus of FIG. 13. According to this embodiment, a partition membrane 270c composed of an ion exchanger in the form of a membrane is mounted to the back surface of the above-described partition 270 of two-layer structure, and the partition 270 having the partition membrane 270c is supported by the support 284 provided in the flow passage 272. The provision of the support 284 makes it possible to use a thin film-shaped ion exchanger as the partition 270, and allow such a film-shaped partition 270 to flexible contact the workpiece W such as a semiconductor wafer. The flexibility is required to respond to variations of the to-be-processed surface of the workpiece due to the size of the workpiece, and the relative movement between the workpiece and the electrode.

The support 284 has a large number of through-holes 284a. The support 284 can hold the partition 270 in a tense state. Owing to the tension and the elasticity of the partition 270, the workpiece W such as a substrate can contact the surface of the partition 270 over the entire surface of the workpiece W. According to the embodiment shown in FIG. 16, two-layer structure of the surface layer 270a and the partition membrane 270c functions as a partition. Should one of the surface layer 270a and the partition membrane be broken, the discharging fluid can be prevented from leaking into the workpiece W side to keep safety.

When the ion exchange capacity of the partition 270 has reached its limit, the ionic processing products are taken in the discharging fluid fed into and flowing through the flow passage 272, whereby the partition 270 is regenerated. The regeneration can eliminate or at least lessen the time and labor for change of the partition 270 covering the surface of the processing electrode 142. According to this embodiment, ion exchangers are used for the surface layer 270a and the backside layer 270b, because they meet the requirements of electrochemical inactivity, elasticity and permeability to ions. Provided these requirements are met, other materials may be employed.

When the support 284 is formed of an electrochemically inactive insulating material, e.g. a fluororesin, which is different from the material of the processing electrode 142, since feeding of electricity to the workpiece is made through an ion-exchange liquid, processing products can be efficiently taken in the discharging fluid. Further, it is possible to make the partition membrane 270c of such an ion exchanger that allows pure water to flow on the membrane, that is, along the backside layer 270b, and allows the discharging fluid to flow below the membrane, that is, along the flow passage 272. This makes it possible to keep the discharging fluid, which is generally harmful, away from the processing surface and, if the ion exchanger, providing the processing surface, is broken, prevent the discharging fluid from flowing through the partition membrane 270c into the workpiece side. As the surface layer 270a, an ion exchanger, which is permeable to ions, but not permeable to a liquid, may be used when an electrolytic solution is used as the discharging fluid that flows through the flow passage 272. When an ion-exchange liquid is used as the discharging fluid, the surface layer 270a may permit permeation therethrough of water insofar as an ion exchanger in the discharging fluid does not leak therethrough.

As shown in FIG. 13, the electrode section 224 of this embodiment is provided with a sensor 286 for measuring the resistance between the processing electrode 142 and the feeding electrode 144, and detecting a leak of the discharging fluid from the flow passage 272. The sensor 286 is connected to the control section 184 for controlling the operation of the apparatus. The control section 184 can control the operation of the apparatus based on the resistance measured by the sensor 286. If the partition 270 is broken and the discharging fluid flowing in the flow passage 272 leaks into the processing area, the electric conductivity in the processing area increases rapidly. A leak of the fluid in the flow passage 272 can therefore be detected by monitoring the resistance between the processing electrode 142 and the feeding electrode 144. Upon occurrence of a liquid leak, the operation can be stopped immediately, thereby preventing the leak of the discharging fluid from adversely affecting the efficiency and uniformity of processing.

During electrolytic processing, a given voltage is applied from the processing power source 126 between the processing electrodes 142 and the feeding electrodes 144, while the substrate holder 224 is rotated by the actuation of the hollow motor 140, and the substrate W and the substrate holder 122 is rotated by the actuation of the substrate-rotating 136 so that the substrate W and the electrode section 224 make a relative movement. A processing fluid, such as pure water or ultrapure water, is supplied, through the through-hole 225, from beneath the electrode section 224 to the upper surface thereof, thereby filling pure water, ultrapure water, a liquid having an electric conductivity of not more than 500 μS/cm, or an electrolytic solution into the space between the processing electrodes 142, the feeding electrodes 144 and the substrate W. Thereby, electrolytic processing of the copper film 6 shown in FIG. 1B, for example, formed on the substrate W is effected by the electrolytic reaction and the movement of ions produced in the ion exchanger. By allowing pure water or ultrapure water to flow within the ion exchanger 146, the electrolytic processing efficiency can be enhanced.

When the ion exchanger 146 is regenerated, a discharging fluid for discharging contaminants is supplied through the fluid supply inlet 224c into the flow passage 272 provided in the regeneration section 252, thereby filling the flow passage 272 with the discharging fluid and immersing the processing electrode 142 in the discharging fluid, and allowing the discharging fluid to flow outwardly in the flow passage 272 and be discharged out from the fluid discharge outlet 224d. By the above operation, through an ion-exchange reaction utilizing the ion exchanger 146 as a solid electrolyte, ions in the ion exchanger 146 are moved toward the processing electrode 142, passed through the partition 270, and introduced into the flow passage 272. The ions thus moved into the flow passage 272 are discharged out of the system by the flow of the discharging fluid supplied into the flow passage 272. Regeneration of the ion exchanger 146 is thus effected. When a cation exchanger is used as the ion exchanger 146, cations taken in the ion exchanger 146 pass through the partition 270 and move into the flow passage 272; when an anion exchanger is used, anions taken in the ion exchanger 146 pass through the partition 270 and move into the flow passage 272, whereby the ion exchanger 146 is regenerated.

In the above regeneration treatment, as described above, an ion exchanger having the same type of ion-exchange group as the ion exchanger 146 to be regenerated is used as the partition 270. This can prevent migration of impurity ions in the ion exchanger 146 through the partition (ion exchanger) 270 from being hindered by the partition 270, thereby preventing an increase in the power consumption. Further, this can inhibit permeation through the partition 270 of the discharging fluid (including ions in the liquid) flowing between the partition 270 and the processing electrode 142, thus inhibiting movement of the fluid into the ion exchanger 146 side and preventing re-contamination of the regenerated ion exchanger 146. Further, preferably used as the discharging fluid to be supplied between the partition 270 and the processing electrode 142 is a fluid which has a high electric conductivity and which does not form an insoluble compound through a reaction with ions removed from the ion exchanger 146. Such a fluid, because of its low electric resistance, can reduce the power consumption in the regeneration section 252. Moreover, the fluid does not form an insoluble compound (by-product) through a reaction with an impurity ion. In this regard, an insoluble compound, if formed, will adhere to the partition 270 whereby the electric resistance between the processing electrode 142 and the feeding electrode 144 will be changed, making it difficult to control the electrolytic current. Such a problem can thus be prevented.

As described hereinabove, according to the present invention, the electric conductivity of the fluid in a processing atmosphere is measured during or after electrolytic processing, and the processing conditions may be changed based on the measured electric conductivity of the fluid so that the electric conductivity of the fluid can be kept at such a level that the flattening properties of the fluid are not affected. This makes it possible to suppress a change in the electric conductivity of the fluid due to contaminants, such as processing products and scrapings of the ion exchanger produced upon the electrolytic processing, metal ions, an additive, etc., thereby maintaining the good flattening properties at all times.

Further, the electric conductivity of the fluid in a processing atmosphere is measured during or after electrolytic processing and, based on the measured electric conductivity of the fluid, contaminants on the surface or in the interior of the ion exchanger may be removed so that the electric conductivity of the fluid can be kept at such a level that the flattening properties of the fluid are not affected, as a result. This also makes it possible to suppress a change in the electric conductivity of the fluid due to contaminants, such as processing products and scrapings of the ion exchanger produced upon the electrolytic processing, metal ions, an additive, etc., thereby maintaining the good flattening properties at all times.

FIG. 17 shows an electrolytic processing apparatus according to a third embodiment of the present invention, which is adapted to polish the gasket portion of a flange for connecting pipes.

According to this embodiment, a metal flange 310 is a workpiece. The gasket portion 310a is an annular groove that has been shaped on a lathe. A metal o-ring, for example, is mounted in the gasket portion 310a. By bringing two flanges 310, with O-rings mounted in the respective gasket portions 310a, into tight contact with each other, the inside of pipes connected via the flanges 310 can be kept at a high pressure or in vacuum.

The electrolytic processing apparatus of this embodiment includes a holder (not shown) for holding the flange 310 horizontally with the face, in which the gasket portion 310a is formed, facing downwardly, and a drive mechanism (not shown) for rotating and vertically moving the holder. By the drive mechanism, the flange 310 can be rotated about a Z-axis and moved vertically along the Z-axis. It is possible to use a drilling machine or another rotary machine tool in place of the holder and the drive mechanism.

The electrolytic processing apparatus of this embodiment also includes a liquid tank 311 in which a liquid 306 is pooled, an insulated base 312, two processing electrodes 303 installed on the upper surface of the base 312, a brush electrode (feeding electrode) 302 which makes contact with the flange 310, and a bipolar power source 315 for applying a pulse voltage between the processing electrodes 303 and the brush electrode 302. The base 312 is disposed at the bottom of the liquid tank 311, and the base 312 and the processing electrodes 303 are fully immersed in the liquid 306 pooled in the liquid tank 311. According to this embodiment, pure water is used as the liquid 306.

An ion exchanger 305 is mounted on each processing electrode 303, and the ion exchanger 305 faces the gasket portion 310a of the flange 310 held by the holder. The processing electrodes 303 are connected via a wire 314 to a cathode of the bipolar power source 315, while the flange 310 is electrically connected via the brush electrode 302 and a wire 313 to an anode of the bipolar power source 315. The brush electrode 302 is not necessary connected directly to the flange 310. For example, it is possible to mount the brush electrode 302 to a shaft (not shown) connecting the holder and the drive mechanism, and feed electricity to the flange 310 via the shaft and the holder. In this case, the shaft must be electrically insulated from the drive mechanism.

The process of electrolytically processing the flange 310 by using the above-described electrolytic processing apparatus will now be described.

First, the bipolar power source 315 is switched on, and an output current is set so that the current density becomes 500 mA/cm² with respect to the area of the processing electrodes 303, and is also set as a constant current (CC). A pulse voltage is applied between the brush electrode 302 and the processing electrodes 303. Next, the drive mechanism is turned on to rotate the flange 310 and, at the same time, move the flange 310 downwardly along the Z-axis so as to bring the gasket portion 310a into contact with the ion exchangers 305 mounted on the processing electrodes 303 by the drive mechanism. Electrolytic processing starts upon contact of the gasket portion 310a (flange 310) with the ion exchangers 305, and polishing of the gasket portion 310a progresses. The processing time may be adjusted depending on the flatness required of the gasket portion 310a. In general, the processing time is about 10 seconds to 5 minutes.

The gasket portion 310a thus processed is planished and has a processed surface with very high flatness and without defects such as pits. Accordingly, with such flanges 310 as processed by the electrolytic processing apparatus of this embodiment, it is possible to maintain a good sealing of interiors of pipes connected by the flanges 310. Further, since pure water is used in this embodiment, processing can be carried out in a clean atmosphere. A cleaning step, a degreasing step, and the like after electrolytic processing are no longer necessary, whereby the operating time can be shortened.

As previously stated, when using a liquid which per se has a large resistance, such as pure water or ultrapure water, as in this embodiment, it is preferred to bring the ion exchanger into “contact” with the surface of the workpiece.

According to the electrolytic processing method of this embodiment, as described above, the pulse voltage is applied between the processing electrodes 303 and the feeding electrode 302 while supplying the liquid (pure water) 306 to the ion exchangers 305 and the workpiece (flange) 310. The pulse voltage herein refers to a periodically changing voltage (potential), not a continuous direct current (DC) voltage commonly used in electrochemical reactions.

Though in this embodiment a bipolar power source is employed as a power source for applying a pulse voltage, it is possible to use a different type of power source. For example, it is possible to use a DC power source which periodically turns on and off electricity by timer and relay control. It is also possible to connect a 50/60 HZ AC power source, which is provided in factories and homes, to a circuit incorporating a diode so as to cut the half-waves of the alternating current. It is also possible to form a circuit connecting an isolation transformer of an AC power source to a DC power source, and produce a pulse voltage by adding bias voltage to an AC voltage. It is also possible to use a means for supplying a periodically changing voltage (potential) using a thyristor, a condenser or a diode. Further, it is possible to use a commercially available switching power source. A programmable power source or a sequence control power source, which can effect waveform control, is particularly preferred.

An explanation will now be given of the mechanism of suppression of the formation of pits by the application of pulse voltage. The formation of pits is considered to be closely related to the presence of gas, in particular gas bubbles, in the electrolytic reaction site. Any one of hydrogen, oxygen and air, when present as gas bubbles in the electrolytic reaction site, will promote the formation of pits. When a positive potential is imparted to a metal (workpiece), the metal dissolves through the following electrolytic reaction:
Me→Meⁿ⁺+ne⁻ (1)

Since the reaction (1) occurs in a liquid, it competes with the following reaction of oxidizing and decomposing water to generate oxygen:
H₂O→½O₂+2H⁺+2e⁻ (2)

The reaction (2) occurs at the surface of the metal and progresses at specific points in the metal surface for a period of time during which the metal takes on a positive potential, i.e. while the metal is serving as an anode. With the progress of the reaction (2), the oxygen generated grows into gas bubbles at the specific points on the surface of the metal. Such gas bubbles are considered to cause the formation of pits. Though the mechanism of the formation of pits by gas bubbles is not fully elucidated yet, pitting of the metal surface is considered to be involved. According to studies by the present inventors, the formation of pits by gas bubbles is completely different in the mechanism from the formation of craters in a metal surface by an electric discharge. While a large amount of electric current flows in a moment in the case of electric discharge, such a phenomenon is not observed in electrolytic processing of a metal using an ion exchanger.

When gas bubbles stay on the surface of a metal, there occurs partial corrosion, i.e. pitting, of the metal surface. It is considered that the application of pulse voltage according to the present invention gives intermittence to the specific points of oxygen generation to thereby suppress the growth of gas bubbles, resulting in suppression of the formation of pits. Thus, while a pulse voltage is being applied, oxygen generation points in the surface of the metal may differ between the peak of positive potential in one cycle and the peak in the next cycle, which will suppress growth of oxygen as gas bubbles.

The mechanism of suppression of the formation of pits by the application of pulse voltage may also be explained from the fact that a pulse voltage can provide the gas bubbles generated with time to escape into the liquid. The important point is not allowing the gas bubble to stay on the surface of the metal in order to suppress the formation of pits. According to this embodiment, by using a pulse voltage in which the lowest potential periodically becomes zero, it becomes possible to provide the gas bubbles generated at the metal surface with time to escape into the liquid. Further, it is possible to extinguish the gas bubbles (oxygen) adhering to the surface of the metal by using a pulse voltage in which the lowest potential periodically becomes a negative voltage. Thus, such a pulse voltage causes the adverse reaction to the above reaction (2) at the surface of the metal, whereby the oxygen that is present as gas bubbles is reduced into water to extinguish the gas bubbles present on the surface of the metal.

The mechanism of suppression of the formation of pits by the application of pulse voltage may also be explained by the effect of a pulse voltage of reducing the electrical attraction between the ion exchanger and the metal. When a positive potential is imparted to the metal during electrolytic processing, the surface of the ion exchanger strongly adheres to the metal, whereby water hardly passes contact surface between the ion exchanger and the metal. This phenomenon is marked when the below-described diaphragmatic ion exchanger is employed. Accordingly, the gas bubbles are likely to be trapped between the ion exchanger and the metal, leading to the formation of pits. The electrical attraction vanishes when the potential of the metal becomes zero or a negative potential, so that water can pass the contact surface between the ion exchanger and the metal. Thus, according to the electrolytic processing using a pulse voltage, the passage of water of the contact surface between the metal and the ion exchanger becomes possible periodically, whereby the gas bubbles can be prevented from staying on the surface of the metal, thereby preventing the formation of pits.

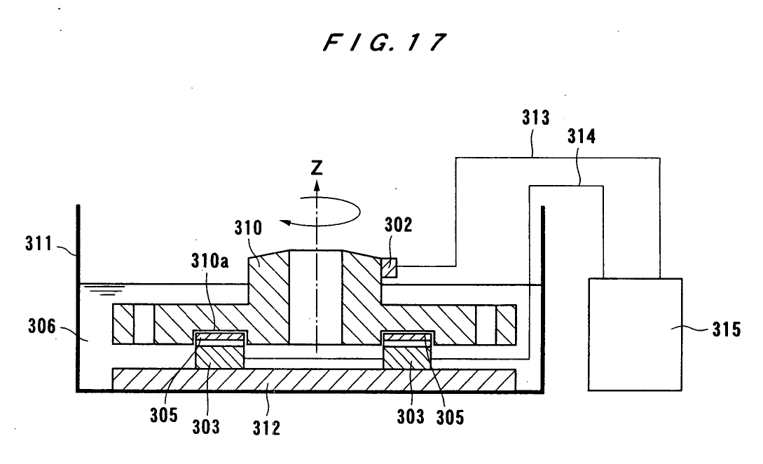

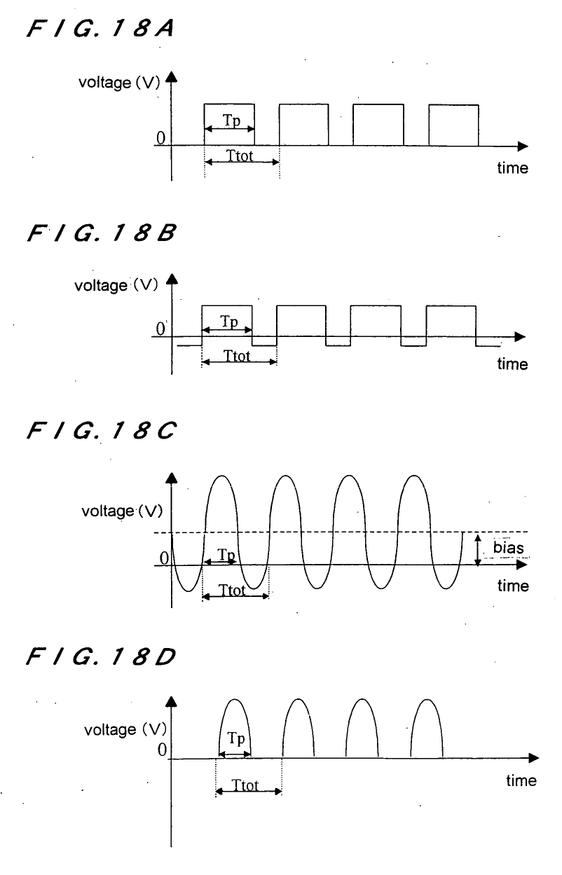

According to this embodiment shown in FIG. 17, a square wave, a sine curve, a triangular wave, a saw-tooth wave, a step wave, etc. may be used as the waveform of a pulse voltage. FIGS. 18A through 18D are diagrams showing examples of the pulse waveforms of pulse voltages according to this embodiment. Square waves as shown in FIGS. 18A and 18B, or sine curves as shown in FIGS. 18C and 18D are preferably used. This is because power sources for square waves or sine curves can be produced with ease and at a low production cost, and are most practical.

It is preferred that the duty ratio of positive potential of a pulse voltage is within the range of 10-97%. The duty ratio (D) refers to the percentage of the positive potential time per cycle of the pulse voltage and can be calculated by the following equation:
D=Tp/Ttot×100 (3)

(Tp: pulse width, Ttot: cycle)

If the duty ratio is less than 10%, the time for applying a positive potential to the workpiece 310 is short, and therefore the processing rate of electrolytic processing is slow. It therefore takes a long time to complete the electrolytic processing, which is undesirable practically. If the duty ratio exceeds 97%, pits are likely to form in the surface of the workpiece 310, leading to a poor processed product. According to this embodiment, the duty ratio of pulse voltage is preferably 10-80%, more preferably 10-50%.

In this case, it is preferred that an electric current of a negative potential be not applied. This is because hydrogen gas is generated in the surface of the workpiece, such as copper, when a negative electric current flows, resulting in the formation of pits. Specifically, the square wave for applying only an electric current of a positive potential by biasing to the square wave, as shown in FIG. 18A, or the sine wave to which half-rectification is added, as shown in FIG. 18d, are preferably used.

The experimental confirmation reveals that the square wave is more preferably used than the sine wave to reduce the formation of pits.

In case a negative potential is applied to the workpiece 310, the quantity of electricity of negative potential is preferably made less than 50% of the quantity of electricity of positive potential. When the quantity of electricity of negative potential is 50% or more, the electric current resembles a so-called alternating current, and a reverse electric current (electric current of a negative potential) flows in the ion exchanger 305, whereby the processing product dissolved out of the workpiece 310 is not held by the ion exchanger 305. The quantity of electricity of negative potential is more preferably not more than 40%, most preferably not more than 30%.

According to this embodiment, the current density of an electric current flowing in the surface of the workpiece 310 in contact with the ion exchanger 305 is preferably 0.1 A (100 mA) to 100 A/cm². The current density herein refers to the current density at the effective voltage of a pulse voltage, not at the peak voltage. If the current density is lower than 100 mA/cm², the effect of suppressing the formation of pits is not produced. In this regard, when the current density is less than 100 mA/cm², rather than the electrolytic reaction of the workpiece 310 (the above reaction (1)), the oxidation reaction of water (the above reaction (2)) occurs preferentially and a large amount of oxygen is generated. With the generation of a large amount of gas, typically oxygen, a large number of defects such as pits are undesirably formed in the surface of the workpiece 310.

When the current density is made higher than 100 mA/cm², on the other hand, the generation of gas (oxygen) is suppressed. This is because movement of substances in water toward the surface of the workpiece 310 enters into a rate-determining state. The electrolytic reaction of the workpiece 310, in which only dissolution of the metal is involved, is not concerned with such rate-determining state. Accordingly, oxygen is less likely to generate at such a high current density, leading to suppression of the formation of pits. Further, when viewed from the standpoint of corrosion, if the current density is less than 100 mA/cm², the surface of the workpiece 310 can partly corrodes during electrolytic processing, causing defects in the metal surface to be processed. When passing an electric current with a density of not less than 100 mA/cm², dissolution of the workpiece 310 progresses evenly over the entire surface to be processed, that is, processing of the workpiece 310 is effected uniformly.

If the current density to be flowed exceeds 100 A/cm², the liquid 306 boils due to the heat generation by the resistance, which incurs deterioration of the ion exchanger 305, and can damage the surface of the workpiece 310. Further, boiling of the liquid 306 generates gas bubbles, leading to the formation of above-described gas pits. Furthermore, due to the high temperature, the ion exchanger 305 may suffer from softening, dissolution, cracking, etc., causing various problems in the process of processing the workpiece 310. In addition, a rise in the voltage of electrolytic processing directly affects the power consumption, increasing the running cost of electrolytic processing and also the initial cost of the power source, etc. Also from such viewpoints, according to this embodiment, the current density during electrolytic processing is preferably 0.5 to 50 A/cm², more preferably 0.8 to 20 A/cm².

According to this embodiment, the positive potential time in one cycle of the pulse voltage is 50 μs-7 sec. That is, the pulse width Tp shown in FIGS. 18A through 18D is preferably from 50 us to 7 sec. When the positive potential time in one cycle of the pulse voltage is less than 50 μs, which means application of a high-frequency pulse voltage, potential changed with high-speed. In a metal processing process using an ion exchanger and carried out in the presence of ultrapure water, the dissolution reaction of metal (workpiece) and chemical reaction rate in the ion exchanger concerning movement and replacement of various ions (metal ion, H⁺, etc.) are in a rate-determining state. Accordingly, when the speed of potential change is fast, the electrochemical metal dissolution reaction cannot catch up with the change of potential, whereby a partial dissolution of metal is likely to occur, resulting in the formation of defects such as pits in the surface of the metal. Further, the use of a high-frequency pulse voltage necessitates a complicated power source, leading to an increased initial cost.

On the other hand, if the positive potential time in one cycle of the pulse voltage applied exceeds 7 seconds, the same phenomenon as observed in a metal processing using a DC voltage may occur. Thus, oxygen gas bubbles may grow at the surface of the anode and stay on the metal surface, leading to the formation of defects such as pits as the result. A positive potential time in one cycle of less than 7 seconds can suppress a continuous generation of oxygen and provide the oxygen gas bubbles once generated with time to leave the metal surface. According to this embodiment, by making the positive potential time per cycle of the pulse voltage within the range of 50 μs to 7 sec, it becomes possible to carry out processing of the workpiece 310 smoothly and effect surface finishing without defects. The positive potential time per cycle of the pulse voltage is maintained preferably 100 μs to 1 sec, more preferably 500 μs to 500 ms, preferably not more than 300 ms, more preferably not more than 100 ms.

According to this embodiment, processing of the workpiece 310 is carried out while supplying the liquid 306 between the workpiece 310 and the ion exchangers 305. The liquid 306 according to this embodiment refers to an aqueous solution mainly comprising water. The liquid 306 may contain various additives, such as a salt, a surfactant, a metal-chelating agent, a metal-surface treatment agent, an inorganic acid, an organic acid, an alkali, an oxidizing agent, a reducing agent, abrasive grains, etc. These additives may be appropriately selected depending upon the type of the metal to be processed and its intended use. The additives may be employed for the following purposes.

For example, an additive can be used for preventing local concentration of electrolysis that may occur during electrolytic processing of the metal. In this regard, it is noted that “an equal removal processing rate at every points in the entire processing surface” is an important factor for providing a flat processed surface. When a single electrochemical removal reaction is in progress, a local difference in the removal-processing rate may be produced by a local concentration of reactant species. The local concentration of reactant species may be caused by a local variation in the electric field intensity and a variation in the distribution of reactant ions as reactant species in the vicinity of the surface of the workpiece. The local concentration of ions can be prevented by allowing an additive, which acts to prevent local concentration of ions (e.g. hydroxide ions), to exist between the workpiece and the ion exchanger.

When an increase in the processing rate (processing speed) of electrolytic processing is desired, a chelating agent, which reacts with the workpiece (metal) to form a metal chelate, may be added to the liquid. By the addition of chelating agent, a metal chelate layer having a very weak mechanical strength is formed on the surface of the metal, making it possible to remove the metal only by contacting it with the ion exchanger. Thus, in this case, in addition to the ionization of the metal through electrochemical reaction, the metal is also ionized through the purely chemical reaction with the chelating agent. This enables a faster processing of the metal.

Depending upon the metal to be processed, a passive film may be formed on the surface of the metal. Such a passive film impedes the electrolytic reaction, making it difficult to continue the electrolytic processing. In such a case, a reducing agent for suppressing the formation of a passive film may therefore be added to the liquid. In the case where the workpiece is made of titanium, aluminum or the like, a passive film of a metal oxide is formed on the surface of the workpiece. The passive film of metal oxide is very strong, and suppression of its formation is difficult, making it difficult to process the metal only through the electrochemical reaction. In such a case, abrasive grains may be added to the liquid so that the grains will produce scratches in the passive film, thereby allowing the electrolytic processing to progress through the scratches. The liquid may thus contain various additives.

It is preferred that the additives be added to the liquid in the smallest possible amount. The electric conductivity of the liquid 306 is preferably not more than 500 μS/cm. Use of the liquid 306 with the electric conductivity of higher than 500 μS/cm will not meet the intended object of processing a workpiece in a clean atmosphere. Thus, use of an additive in a large amount deviates from a clean processing atmosphere, involving the problem of waste liquid disposal and the problem of contamination of the workpiece 310. From such viewpoints, it is more preferred that the liquid 306 be pure water having an electric conductivity of not more than 10 μS/cm. Use of pure water in electrolytic processing makes it possible to carry out a clean processing without leaving impurities on the processed surface, thereby simplifying a cleaning step after the electrolytic processing. For flattening and specular finishing on such a level as required of an ordinary machining, the use of pure water as the liquid will be sufficient.

The liquid 306 is more preferably ultrapure water having an electric conductivity of e.g. not more than 0.1 μS/cm. When carrying out electrolytic processing of a metal used, for example, in a semiconductor device, since a semiconductor device is sensitively affected by impurities, ultrapure water is preferably used as the liquid. When processing a metal of a semiconductor device using the present processing method, it is also preferred to use a degassed liquid. The liquid may be degassed to a dissolved oxygen concentration of 5 ppm or less, preferably 1 ppm or less, more preferably 100 ppb or less. The lower the dissolved oxygen concentration is, defects such as pits are less likely to form in the workpiece.

It is important in this embodiment that the liquid 306 be supplied between the ion exchangers 305 and the workpiece 310 during electrolytic processing. According to this embodiment, in order to supply the liquid between the ion exchangers 305 and the workpiece 310, the ion exchangers 305 and the workpiece 310 are immersed in the liquid 306. It is also possible to use a means to supply the liquid so that the workpiece 310 and the ion exchangers 305 may be kept in contact with the liquid 306 at all times. It basically suffices if the surface of the workpiece 10 and the surfaces of the ion exchangers 305, which are in contact with each other, are enveloped in the liquid 306 during processing.

Depending upon the objective of processing, it is possible to use as the ion exchanger 305 a combination of a plurality of ion exchangers having different properties. For example, it is possible to use a combination of a fluorine ion exchanger (ion-exchange membrane) having a high hardness and good surface smoothness, and an ion exchanger comprising a non-woven fabric as a base material and having a large ion exchange capacity.

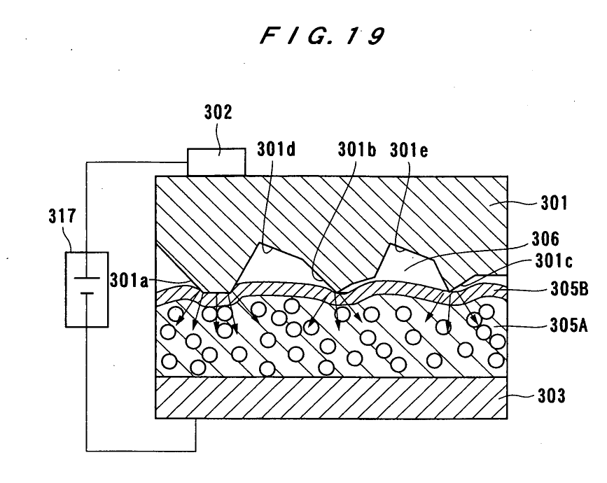

Electrolytic processing according to a fourth embodiment of the present invention, which employs a combination of two types of ion exchangers having different properties, will now be described by referring to FIG. 19. FIG. 19 is a diagram schematically illustrating electrolytic processing as carried out by using a combination of a fluorine ion exchanger (diaphragmatic ion-exchange membrane) and an ion exchanger (porous ion exchanger) comprising a non-woven fabric as a base material.

As shown in FIG. 19, a porous ion exchanger 305A is mounted on a processing electrode 303, and a diaphragmatic ion exchanger 305B is mounted on the surface of the ion exchanger 305A. A feeding electrode 302 is electrically connected to a workpiece (metal) 301. The surface of the workpiece 301 is in contact with the ion exchanger 305B, and a liquid 306, such as ultrapure water, is supplied between the ion exchanger 305B and the workpiece 301. A pulse voltage is applied from a power source 317 to between the processing electrode 303 and the feeding electrode 302.

The workpiece 301 is in contact with the ion exchanger 305B at raised portions 301a, 301b, 301c formed in a surface of the workpiece 301. Since a positive potential in a pulse form is applied from the power source 317 to the workpiece 301, the raised portions 301a, 301b, 301c of the workpiece 301 undergo electrolytic reaction and dissolve. The dissolved processing product (metal ions, etc.) passes through the ion exchanger 305B, and is trapped in the ion exchanger 305A. Since depressed portions 301d, 301e in the surface of the workpiece 301 are in contact with the liquid 306 having a low electric conductivity, such as pure water or ultrapure water, the electrochemical dissolution reaction of the workpiece 301 does not progress there. Removal processing of the workpiece 301 thus progresses preferentially at the raised portions 301a, 301b, 301c of its surface, whereby flattening of the surface of the workpiece 301 advances.

As described above, the processing product dissolved out of the workpiece 301 passes through the ion exchanger 305B, and is then trapped in the form of metal ions, metal oxide or metal hydroxide in the porous ion exchanger 305A. Accordingly, the liquid 306 is kept almost free of impurities. Further, impurities can be prevented from adhering to the workpiece 301, which makes it possible to simplify cleaning of the workpiece after the processing. In addition, unlike the conventional electrolytic processing method using an electrolytic solution, the electrolytic processing method of this embodiment does not necessitate formation of a sticky layer on the surface of a metal film and control of the layer thickness. This embodiment can therefore considerably simplify operational management during electrolytic processing, and can selectively remove only the raised portions of a workpiece.

The fluorine ion exchanger 305B has a high hardness and a surface smoothness, and also has an excellent chemical resistance and a high tensile strength, and can therefore be preferably used particularly as an ion exchanger to be in contact with a workpiece. The term “high hardness” herein means high rigidity and low compression elastic modulus. The ion exchanger 305B having a high hardness, when used in processing of the workpiece 301 having fine irregularities in the surface, hardly follows the irregularities and is therefore likely to selectively remove only the raised portions 301a, 301b, 301c in the surface of the workpiece 301. The expression “has a surface smooth” herein means that the surface has small irregularities. The ion exchanger 305B having a surface smoothness is less likely to contact the depressed portions 301d, 301e in the surface of the workpiece 301, and is more likely to selectively (preferentially) remove only the raised portions 301a, 301b, 301c.

In general, when carrying out flattening of a metal by electrolytic processing, a workpiece and an ion exchanger are allowed to make a relative movement while they are kept in contact with each other. Accordingly, fiber frayings, chips, scrapings, etc. of the ion exchanger are likely to be produced. Further, because of the electrical attraction between the workpiece and the ion exchanger, a large wearing stress is produced between them during electrolytic processing. In view of this, this embodiment employs the fluorine ion exchanger 305B having high hardness and good surface smoothness as an ion exchanger to be in contact with the workpiece 301, thereby preventing frayings, etc. of the ion exchangers 305A, 305B.

The kind of the fluorine ion exchanger 305B is not particularly limited. For example, a perfluorosulfonate resin, such as a commercially available product Nafion (trademark, DuPont Co.), may be used as the ion exchanger 305B. The use of an ion exchanger having a smooth surface, such as Nafion, can provide a processed surface with very high flatness. Further, by combining the fluorine ion exchanger 305B with the ion exchanger (non-woven fabric ion exchanger) 305A having a large ion exchange capacity, the ions from the workpiece, which have passed through the fluorine ion exchanger 305B, can be held in the non-woven fabric ion exchanger 305B.

The workpiece 301 may be one which, when given a positive potential, can bring about an electrolytic reaction according to the below-described reaction formula. Further, the workpiece 301 may be a single-component metal or a multi-component metal alloy.
Me→Meⁿ⁺+ne⁻

In the formula, Me represents the metal of the workpiece 301 and Meⁿ⁺ represents the metal ion as dissolved out of the workpiece. Specific examples of Me may include Cu, Al, Fe, Ni, Cr, Mo, Ti; and various metals and metal alloys generally employed in machining, such as a stainless alloy, brass, aluminum alloy, and inconel.

The processing product in the form of Meⁿ⁺, dissolved out of the workpiece 301 by the electrolytic reaction, passes through the ion exchanger 305B and is then held in the ion exchanger 305A, where the processing product, either as the metal ion or in the form of a metal oxide or metal hydroxide, adheres to the ion exchanger 305A. As shown in FIG. 19, the processing electrode 303 is disposed on the opposite side of the ion exchangers 305A, 305B from the surface of the workpiece 301. With respect to the processing electrode 303 and the feeding electrode 302, in general, oxidation or dissolution thereof by the electrolytic reaction is a problem. An electrochemically stable metal may therefore be used as a material for the processing electrode 303, and a noble metal such as platinum, iridium or ruthenium, or a conductive oxide thereof, may generally be used.

For the feeding electrode 302, a material may be used which is obtained by coating a metal, such as platinum, iridium or ruthenium by electroplating, CVD, calcination, etc. onto the surface of a base metal, such as a carbon steel, titanium or a stainless steel. In the case where only a positive or zero potential is applied to a workpiece, it is not necessary to take into consideration the problem of corrosion of the feeding electrode 302 due to the electrolytic reaction. Accordingly, an inexpensive metal such as a stainless steel, copper, brass, a carbon steel, etc., as it is, may be used for the feeding electrode 302.

As shown in FIG. 19, according to this embodiment, the processing electrode 303 is separated by the ion exchangers 305A, 305B from the workpiece 301 and the liquid 306. Accordingly, the processing product, dissolved out of the surface of the workpiece 301 through the electrolytic reaction, is removed in the form of metal ions, metal oxide or metal hydroxide and trapped in the ion exchanger 305A. Since the processing product removed is thus held in the ion exchanger 305A, there is no contamination with the processing product of the liquid, such as pure water, which is in use for processing. Accordingly, the processed metal product can be kept clean, and a cleaning step after electrolytic processing can be eliminated.

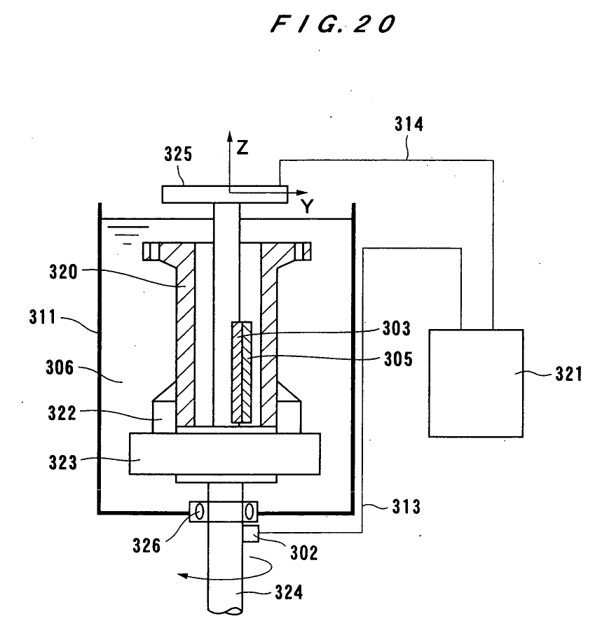

Next, an electrolytic processing apparatus according to a fifth embodiment of the present invention will now be described by referring to FIG. 20. FIG. 20 is a cross-sectional view schematically showing an electrolytic processing apparatus according to a fifth embodiment of the present invention. This embodiment relates to application of the present invention to an electrolytic processing apparatus for polishing the inner surface of a cylindrical metal. The following description is made of a particular case of polishing the inner surface of a hydraulic cylinder by using the electrolytic processing apparatus of this embodiment.

The electrolytic processing apparatus of this embodiment comprises a brash electrode 302 as a feeding electrode, a processing electrode 303, a power source 321 for applying a pulse voltage between the brush electrode 302 and the processing electrode 303, a liquid tank 311 for pooling a liquid 306 such as pure water therein, and a clamp 322 and a turntable 323 for fixing a hydraulic cylinder 320.

The hydraulic cylinder 320 as a workpiece is clamped by the clamp (chuck) 322 provided on the turntable 323. The turntable 323 is connected via a shaft 324 to a rotating mechanism (not shown), so that the hydraulic cylinder 320 clamped by the clamp 322 can rotate through the rotating mechanism. The hydraulic cylinder 320 is positioned by the clamp 322 such that its center coincides with the center of rotation of the turntable 323. The rotational speed of the hydraulic cylinder 320 is set at 10-1000 rpm.

The turntable 323 and the clamp 322 are disposed in the liquid tank 311. The liquid tank 311 is filled with a liquid 306, and the hydraulic cylinder 320 clamped by the clamp 322 and the turntable 323 are both immersed in the liquid 306. The shaft 324 connecting the turntable 323 and the rotating mechanism penetrates the bottom of the liquid tank 311. A shaft seal mechanism 326 is therefore provided to the shaft 324 so that the liquid 306 may not leak out of the liquid tank 311.

An electrode fixing shaft 325, extending along an axial extension of the shaft 324, is disposed above the turntable 323. The electrode fixing shaft 325 is connected to a drive mechanism (not shown), so that the electrode fixing shaft 325 moves in Y direction and Z direction through the drive mechanism. The processing electrode 303 is fixed to the lower portion of the electrode fixing shaft 325, and an ion exchanger 305 is mounted on the processing electrode 303. The electrode fixing shaft 325 is connected via a wire 314 to a cathode of the power source 321. Since the electrode fixing shaft 325 is electrically conductive, the processing electrode 303 is electrically connected via the electrode fixing shaft 325 and the wire 314 to the cathode of the power source 321.

The brush electrode 302 as a feeding electrode is disposed outside the liquid tank 311 such that it is in contact with the peripheral surface of the shaft 324. The brush electrode 302 is connected via a wire 313 to an anode of the power source 321. Since the shaft 324, the turntable 323 and the clamp 322 are all electrically conductive, the hydraulic cylinder 320 clamped by the clamp 322 is electrically connected to the anode of the power source 321. The shaft 324 and the rotating mechanism are electrically insulated from each other.

A process of electrolytically processing the hydraulic cylinder 320 by the above-described electrolytic processing apparatus of this embodiment will now be described.

First, the hydraulic cylinder 320 is sunk in the liquid 306 which fills the liquid tank 311, and the hydraulic cylinder 320 is clamped by the clamp 322. Thereafter, the hydraulic cylinder 320 is rotated by the rotating mechanism at a predetermined rotational speed. Next, the electrode fixing shaft 325 is lowered along the Z-axis, so that the processing electrode 303 and the ion exchanger 305 are positioned inside the hydraulic cylinder 320. Further, the electrode fixing shaft 325 is moved along the Y direction so as to bring the ion exchanger 305 into contact with the inner circumferential surface of the hydraulic cylinder 320. In order to grasp the time at which the ion exchanger 305 contacts the inner circumferential surface of the hydraulic cylinder 320, it is preferable to refer to a change in the electric current or in the resistance.

The power source 321 is preset to output a predetermined constant current (CC). After confirming that the ion exchanger 305 is in contact with the hydraulic cylinder 320, the power source 321 is switched on. Then a pulse voltage is applied from the power source 321 to between the brash electrode (feeding electrode) 302 and the processing electrode 303, whereupon electrolytic processing starts. During electrolytic processing, the electrode fixing shaft 325 is moved vertically so that the entire inner circumferential surface of the hydraulic cylinder 320 can be processed.

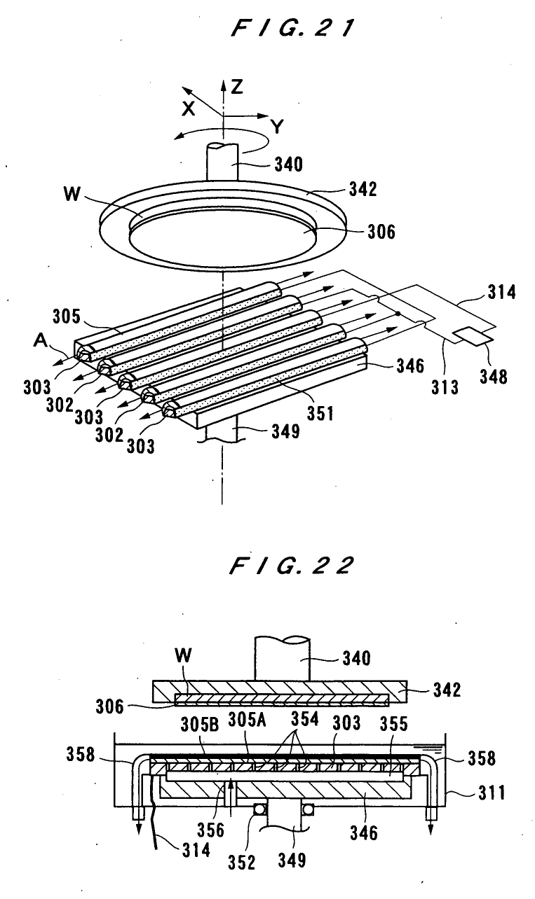

An electrolytic processing apparatus of a sixth embodiment of the present invention will now be described with reference to FIGS. 21 and 22. This embodiment concerns application of the present invention to the above-described electrolytic processing apparatus 114 shown in FIG. 6.

FIG. 21 is a perspective view schematically showing the electrolytic processing apparatus. FIG. 22 is a cross-sectional view of the electrolytic processing apparatus. As shown in FIGS. 21 and 22, the electrolytic processing apparatus comprises a rotating shaft 340, a substrate holder 342, mounted vertically to a free end of the rotating shaft 340, for attracting and holding a substrate W with its front surface facing downwardly (face down), a drive mechanism (not shown) for vertically moving the rotating shaft 340 and also for reciprocating the rotating shaft 340 along a horizontal plane, a plurality of feeding electrodes 302 and processing electrodes 303 placed on the upper surface of a rectangular electrode table 346, and a power source 348 for applying a pulse voltage between the feeding electrodes 302 and the processing electrodes 303.

The above-described drive mechanism includes a motor (not shown) for rotating the rotating shaft 340, and the substrate W held by the substrate holder 342 rotates via the rotating shaft 340 by the motor. According to this embodiment, the electrode table 346 is so designed that its size is slightly larger than the diameter of the substrate W held by the substrate holder 342. The above-described drive mechanism may be a conventional one that is employed in a CMP apparatus.

The substrate holder 342 of this embodiment employs the so-call vacuum chuck method and attracts the substrate W by vacuum suction. The substrate holder, however, is not limited to a vacuum chuck holder. For example, it is possible to use a mechanical chuck which holds the substrate by nails. With such a mechanical chuck, the nails in contact with the substrate impede processing. It is therefore preferred to shift the positions of the nails with respect to the substrate during processing so that the substrate can be processed uniformly over the entire surface of the substrate.

As shown in FIG. 21, a plurality of the feeding electrodes 302 and the processing electrodes 303 are disposed in parallel on the upper surface of the electrode table 346. The feeding electrodes 302 and the processing electrodes 303 are connected alternately to the anode and to the cathode of the power source 348. Specifically, the feeding electrodes 302 are connected via a wire 313 to the anode of the power source 348, while the processing electrodes 303 are connected via a wire 314 to the cathode of the power source 348. Thus, according to this embodiment, the feeding electrodes 302 and the processing electrodes 303 are disposed in parallel and alternately. The electrode table 346 is connected via a shaft to a not-shown horizontal movement mechanism, so that the electrode table 346 moves horizontally through the horizontal movement mechanism. The horizontal movement may comprise a reciprocating linear movement, the so-called scroll movement (non-rotational circular orbit movement), or a rotary movement.

An ion exchanger 305 is mounted on each feeding electrode 302 and each processing electrode 303. The ion exchanger 305 is comprised of a porous ion exchanger 305A and a diaphragmatic ion exchanger 305B. The porous ion exchanger 305A is mounted on the upper surface of the processing electrode 303, and the ion exchanger 305A and the processing electrode 303 is fully covered by the diaphragmatic ion exchanger 305B.

The ion exchanger 305B, because of its diaphragmatic nature, does not permit permeation of a liquid, but permits only ions to pass therethrough. On the other hand, because of its porous structure, the ion exchanger 305A has a large ion exchange capacity. Further, because of its high porosity, the ion exchanger 305A permits permeation of a liquid and a gas. Accordingly, the processing product (e.g. copper ions) produced by electrolytic reaction passes through the diaphragmatic ion exchanger 305B, and is trapped in the porous ion exchanger 305A. It is therefore better to use a material having a larger ion exchange capacity for the ion exchanger 305A.

Though in this embodiment the porous ion exchanger 305A and the diaphragmatic ion exchanger 305B are mounted also to each feeding electrode 302, the present invention is not limited thereto. It is possible to use a material other than an ion exchanger, such as a carbon felt or the like. Further, it is possible to use a carbon brush electrode as the feeding electrode 302. Any material and means may be employed for the feeding electrode 302 insofar as the electrode can feed electricity to a copper film 6 (see FIG. 1B) formed on the substrate W.

As shown in FIG. 22, the feeding electrodes 302, the processing electrodes 303, and the ion exchangers 305A, 305B, together with the electrode table 346, are disposed in a liquid tank 311. The liquid tank 311 is filled with pure water or ultrapure water; the feeding electrodes 302, the processing electrodes 303 and the ion exchangers 305A, 305B are disposed in pure water or ultrapure water. A shaft 349, which penetrates the bottom of the liquid tank 311, is provided with a shaft seal mechanism 352 for preventing a leak of the liquid.

In each processing electrode 303 are formed a plurality of vertically extending through-holes 354. The through-holes 354 communicate with a plurality of groove-like diffusion passages 355 formed between the processing electrodes 303 and the upper surface of the electrode table 346. Each diffusion passage 355 communicates with a not-shown liquid supply source via a pipe 356 that is disposed beneath the electrode table 346. Thus, a liquid is supplied from the liquid supply source through the pipe 356, the diffusion passage 355 and the through-holes 354 to each ion exchanger 305A. The liquid supplied from the liquid supply source may be different from or identical to a liquid (pure water or ultrapure water) pooled in the liquid tank 311.

Hydrogen gas, generated by the electrolytic reaction of water (pure water or ultrapure water), can be removed from the ion exchanger 305A by the liquid flowing in the ion exchanger 305A. If the hydrogen gas, conveyed by the liquid flowing in the ion exchanger 305A, contacts the copper film 6 of the substrate W, gas pits could be formed. In view of this, tubes 358 are provided at both ends of each ion exchanger so that the liquid, together with the hydrogen gas trapped therein, is discharged out. Accordingly, the liquid and hydrogen gas flowing in the ion exchanger 305A are discharged out without contact with the pure water or ultrapure water pooled in the liquid tank 311. The arrow A shown in FIG. 21 indicates the flow direction of the liquid flowing out of the ion exchanger 305A. The tubes 358 may be omitted. The liquid supplied to the ion exchanger 305A may be identical to a liquid (e.g. pure water) pooled in the liquid tank 311.

A regeneration liquid may be used as the liquid to be supplied to the ion exchanger 305A. This makes it possible to regenerate the ion exchanger 305A while removing the processing product (e.g. copper ion) trapped in the ion exchanger 305A. In this case, a strongly acidic electrolytic solution, such as sulfuric acid or hydrochloric acid, may be used as the regeneration liquid. The regeneration liquid supplied from the liquid supply source contacts the ion exchanger 305A and, through replacement of the processing product trapped in the ion exchanger 305A with a strongly acidic proton ion, the ion exchanger 305A is regenerated. Such a structure for regenerating the ion exchanger 305A may be provided also in the feeding electrodes 302.

Next, substrate processing (electrolytic processing) by the electrolytic processing apparatus of this embodiment will now be described. First, a substrate W having a copper film 6 as a conductive film (object to be processed) formed in the surface is attracted and held by the substrate holder 342 with the front surface of the substrate W facing downwardly after reversing the substrate W. Thereafter, the rotating shaft 340 is moved horizontally to move the substrate holder 342 holding the substrate W to a processing position right above the feeding electrodes 302 and the processing electrodes 303. Next, the substrate holder 342 is lowered to immerse the substrate W held by the substrate holder 342 in pure water or ultrapure water pooled in the liquid tank 311, and is further lowered so as to bring the substrate W into contact with the surfaces of the ion exchangers 305B. Thereafter, the substrate W is rotated by the motor (not shown) coupled to the rotating shaft 340, while the electrode table 346 is allowed to make a horizontal movement by the horizontal movement mechanism. At this time, the substrate W may not be rotated. The substrate W may be pivoted through a predetermined angle (e.g. 45) to the longitudinal direction of the electrodes 302, 303 periodically to prevent uneven processing.

A pulse voltage is applied from the power source 348 to between the feeding electrodes 302 and the processing electrodes 303 to carry out electrolytic processing of the copper film 6 of the surface of the substrate W at the processing electrodes 303 (cathode) through the reaction of hydrogen ions or hydroxide ions produced by the ion exchangers 305A, 305B. According to this embodiment, the drive mechanism is driven to move the rotating shaft 340 and the substrate holder 342 in the Y direction during electrolytic processing. Thus, according to this embodiment, processing of the substrate W is carried out while allowing the electrode table 346 to make a horizontal movement, thereby to move the substrate W in the direction perpendicular to the long direction of the feeding electrodes 302 and the processing electrodes 303.

During the electrolytic processing, the voltage applied between the feeding electrodes 302 and the processing electrodes 303 or the electric current flowing therebetween is monitored with a monitor section 118 (see FIG. 6) to detect the end point (terminal of processing). In this connection, when carrying out electrolytic processing with application of the same voltage (electric current), the electric current that flows (voltage applied) will differ depending on the material to be processed. Thus, monitoring of a change in the electric current or the voltage during processing can surely detect the end point.

Though in this embodiment the voltage applied or the electric current flowing between the feeding electrodes 302 and the processing electrodes 303 is monitored with the monitor section to detect the end point of processing, it is also possible to monitor with the monitor section a change in the state of the substrate during processing to detect the end point of processing, which is set arbitrarily, or change the processing conditions. In this case, the end point of processing refers to a point in time at which a desired processing amount is reached for a given portion of the processed surface, or a point in time at which a parameter, which is correlated with the processing amount, has reached a value corresponding to the desired processing amount. By thus arbitrarily setting and detecting the end point of processing in the course of processing, it becomes possible to carry out electrolytic processing in a multi-step process.

After completion of the electrolytic processing, the power source 348 is disconnected from the feeding electrodes 302 and the processing electrodes 303, and the rotation of the substrate holder 342 and the horizontal movement of the electrode table 346 are stopped. The substrate holder 342 is raised and the rotating shaft 340 is moved to transfer the substrate W to the transport robot 116 (see FIG. 6). After reversing the substrate W according to necessity, the substrate W is returned to the cassette in the loading/unloading section 110 (see FIG. 6).

According to the electrolytic processing apparatus of this embodiment, as described above, square waves and sine curves shown in FIG. 18A through 18D, for example, are also preferably employed as waveforms of the plus voltage, and waveforms having no negative potential current shown in FIGS. 18A and 18B are more preferably employed. In this case, a waveform having a so-called low-duty ratio, which comprises the longer positive potential time (ONtime) than the zero positive time (OFFtime), is preferably employed as a waveform having no negative potential current. This is considered that the gas babbles, which are generated during ON time (processing), are removed from the surface to be processed by the relative movement between the surface to be processed and the electrodes during OFF time, and the pits caused by gas babbles are decreased.

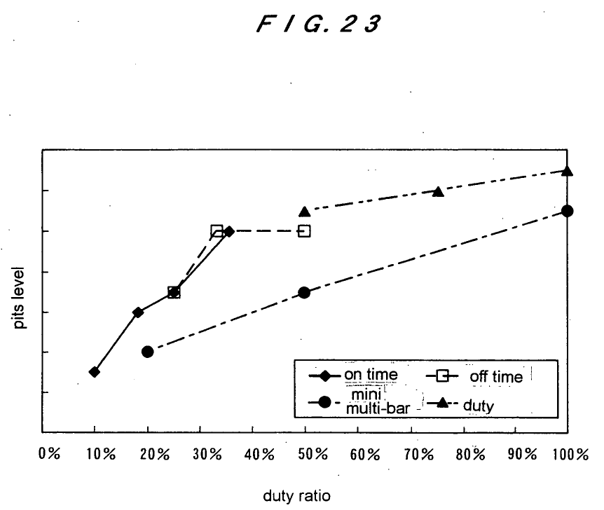

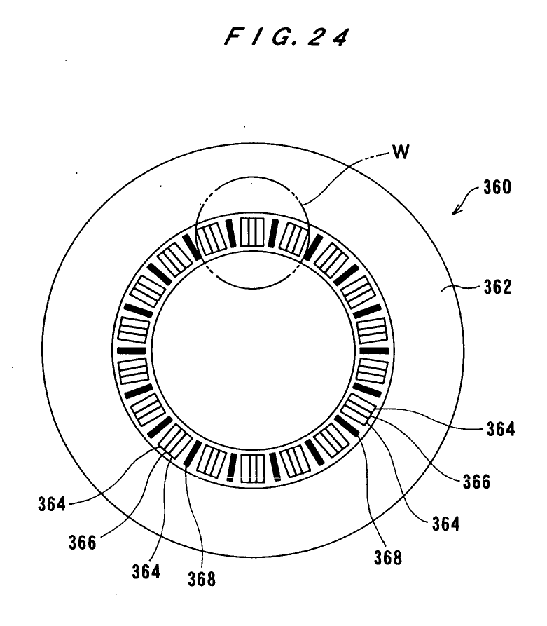

FIG. 23 shows the relationship between the pits level and the duty ratio; when processing was performed while applying a plus waveform, whose duty ratio is changed by changing ON (positive potential) time while fixing OFF (minimum potential=0V) time, to the electrolytic processing apparatus having the electrode table 346 on which a plurality of the feeding electrodes 302 and the processing electrodes 303 are disposed in parallel, while allowing the electrode table 346 to make a scroll movement with respect to the workpiece (substrate) (On Time); when processing was performed while applying a plus waveform, whose duty ratio is changed by changing OFF time while fixing ON time adversely, to the electrolytic processing (Off Time); when processing was performed while applying a plus waveform, whose duty ratio is changed by changing the ON/BFF time distribution in one constant cycle, to the electrolytic processing apparatus (Duty); and when processing was performed while applying a plus waveform, whose duty ratio is changed, to a electrolytic processing apparatus 360 shown in FIG. 24 (Duty). The electrolytic processing apparatus 360 has a mini multi-bar type electrode system.

The electrolytic processing apparatus 360 shown in FIG. 24 is provides with a rotatable circular electrode table 362. Processing electrodes 366, each having water nozzles 364 on its both sides, and feeding electrodes 368 are disposed alternatively at positions along the circumferential direction of the electrode table 362. In operation, the electrode table 362 is being rotated while supplying pure water or ultrapure water from the water supply nozzles 364 to process the substrate W which is disposed opposite the processing electrodes 366 and the feeding electrodes 368, which move with the rotation of the electrode table 362, and is rotated, if necessary.

FIG. 23 shows that the formation of pits is suppressed by using a pulse waveform having a so-called low-duty ratio not more than 50%, and the effect of suppressing the formation of pits is promoted by further decreasing the duty ratio.

Specifically, the duty ratio is preferably as low as possible so as to suppress the formation of pits, but when the duty ratio is lowered, as described above, the processing rate is decreased, leading to a prolonged processing time, especially the duty ratio is lowered to not more than 10%. Therefore, the duty rate is generally 10 to 97%, preferably 10 to 80%, more preferably 10 to 50%.

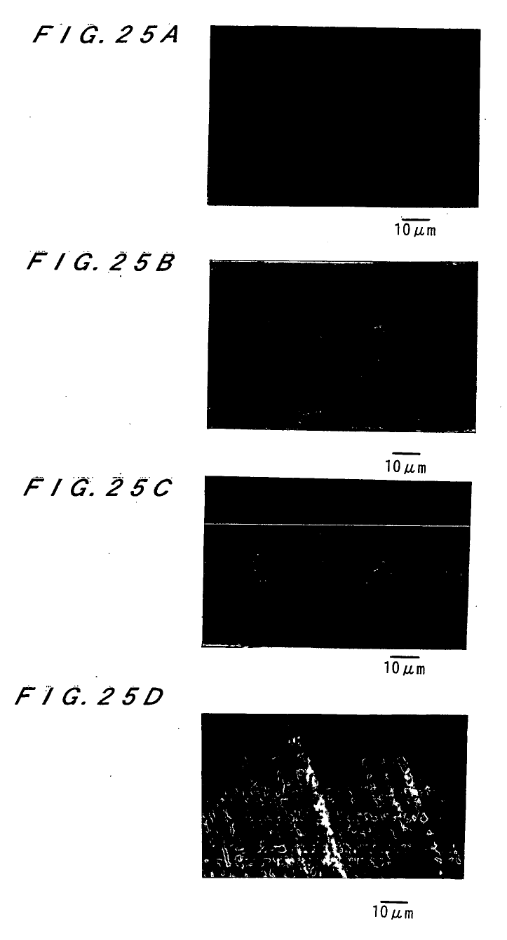

Experimental examples will now be described with referent to FIGS. 25 through 28. In the following Examples, a copper film formed on a surface of a wafer (substrate) was processed with an electrolytic processing apparatus according to the present invention.

### EXAMPLE 1

A sample (workpiece) for electrolytic processing was prepared by forming a 1.5 μm thick copper film by electroplating on a wafer having a diameter of 20 cm. A current-carrying portion of a platinum plate, on which a diaphragmatic ion exchanger and a porous ion exchanger are superimposed, was used as a processing electrode. Nafion 117 (trademark, DuPont Co.) was used as the diaphragmatic ion exchanger; a polyethylene non-woven fabric having a sulfonic ion-exchange group, introduced by graft polymerization, was used as the porous ion exchanger. The processing electrodes and the wafer were sunk in a water tank filled with ultrapure water, and the wafer was rotated at 500 rpm by a rotating machine. The processing electrodes were connected to a cathode of a bipolar power source, while a brash electrode (feeding electrode) was connected to an anode, and the brash electrode was brought into contact with the rotating wafer. The lowest potential of the bipolar power source was set at 0V; the highest potential was set at 10-40V; and the waveform of pulse voltage was set as a square wave. The duty ratio of pulse voltage was set at 33%; the positive potential time of pulse voltage was set at 10 ms; and the lowest potential (0V) time was set at 20 ms. FIGS. 25A through 25D are SEM photographs of the processed surfaces of the wafers as processed under the above conditions. FIGS. 25A through 25D show the SEM photographs of the processed surfaces after processing with application of the pulse voltage at 10V (FIG. 25A), 20V (FIG. 25B), 30V (FIG. 25C), and 40V (FIG. 25D). The results of Example 1 show a remarkable decrease in the number of pits formed in the processed surfaces of the samples as compared to the samples of the below-described Comp. Example 1 that employs a direct current in electrolytic processing. The SEM observation showed almost no formation of pits. The results of this Example 1 also show that a pulse voltage of a square waveform is effective for decreasing the number of pits.

### EXAMPLE 2

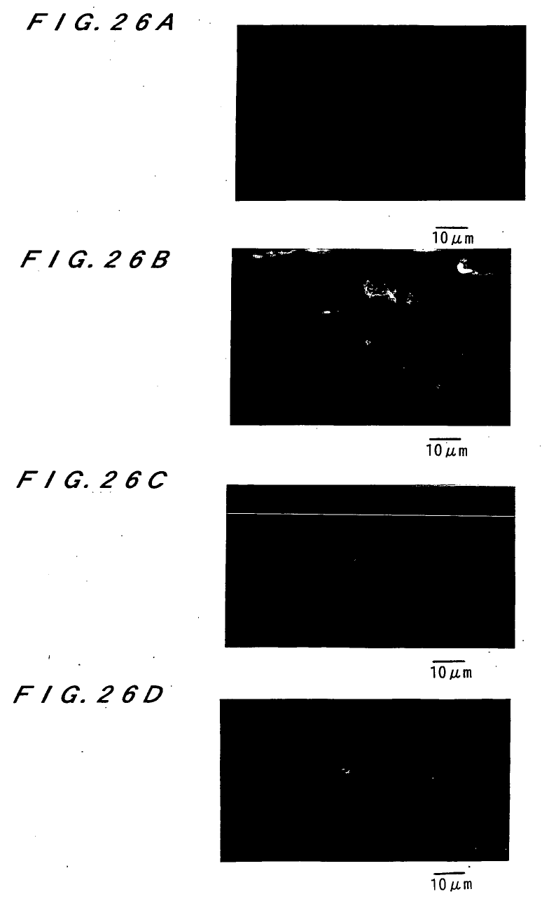

A sample (workpiece) for electrolytic processing was prepared by forming a 1.5 μm thick copper film by electroplating on a wafer having a diameter of 20 cm. A processing electrode was composed of a diaphragmatic ion exchanger, a porous ion exchanger and a current-carrying portion of a platinum plate. Nafion 117 was used as the diaphragmatic ion exchanger; a polyethylene non-woven fabric having a sulfonic ion-exchange group, introduced by graft polymerization, was used as the porous ion exchanger. The processing electrodes and the wafer were sunk in a water tank filled with ultrapure water, and the wafer was rotated at 500 rpm by a rotating machine. The processing electrodes were connected to a cathode of a bipolar power source, while a brash electrode (feeding electrode) was connected to an anode, and the brash electrode was brought into contact with the rotating wafer. The pulse wave of the bipolar power source was set in a constant current mode such that an electric current with a current density, per unit area of the processing electrode, of 80 mA/cm² to 1 A/cm² will flow during the period of positive potential. The duty ratio of pulse voltage was set at 50%; the frequency was set at 50 Hz; and the lowest potential was set at 0V. FIGS. 26A through 26D are SEM photographs of the processed surfaces of the wafers as processed under the above conditions. Pits or surface damage was observed on the wafers as processed at a current density of 80 mA/cm² (FIG. 26A), and at 240 mA/cm² (FIG. 26B), whereas no pits nor surface damage was observed on the wafers as processed at 700 mA/cm² (FIG. 26C) and at 1 A/cm² (FIG. 26D), indicating preferable conditions a current density of over 500 mA/cm². The results of this Example 2 thus show that there is a proper range of current density for electrolytic processing.

### EXAMPLE 3

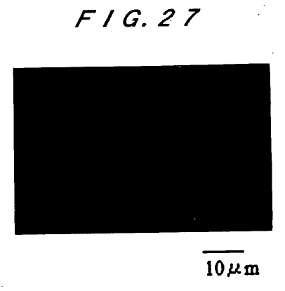

A sample (workpiece) for electrolytic processing was prepared by forming a 1.5 μm thick copper film by electroplating on a wafer having a diameter of 20 cm. A processing electrode was composed of a diaphragmatic ion exchanger, a porous ion exchanger and a current-carrying portion of a platinum plate. Nafion 117 was used as the diaphragmatic ion exchanger; a polyethylene non-woven fabric having a sulfonic ion-exchange group, introduced by graft polymerization, was used as the porous ion exchanger. The processing electrodes and the wafer were sunk in a water tank filled with pure water having an electric conductivity of 3 μS/cm, and the wafer was rotated at 500 rpm by a rotating machine. A slidax was provided as a power source. A diode was installed on the output side of the slidax power source in order to cut the negative potential half-waves. The diode output side was connected to a brush electrode, and the brush electrode was brought into contact with the rotating wafer. A facility power source (50 Hz, 100V) was used as the input power source of the slidax. The output voltage (effective voltage) of the slidax was set at 70V. A pulse voltage of 50 Hz sine curve with the negative potential cut off was applied to the wafer. FIG. 27 shows an SEM photograph of the processed surface of the wafer as processed under the above conditions. The copper film was removed by a thickness of about 700 nm, and no pits were observed in the processed surface. The results of this Example 3 show that use of pure water having an electric conductivity of 3 μS/cm is also effective for preventing the formation of pits. The results further show that the waveform utilizing part of a sine curve is also effective.

### EXAMPLE 4

A sample (workpiece) for electrolytic processing was prepared by forming a 1.5 μm thick copper film by electroplating on a wafer having a diameter of 20 cm. A processing electrode was composed of a diaphragmatic ion exchanger, a porous ion exchanger and a current-carrying portion of a platinum plate. Nafion 117 was used as the diaphragmatic ion exchanger; a polyethylene non-woven fabric having a sulfonic ion-exchange group, introduced by graft polymerization, was used as the porous ion exchanger. The processing electrodes and the wafer were sunk in a water tank filled with pure water having an electric conductivity of 3 μS/cm, and the wafer was rotated at 500 rpm by a rotating machine. A bipolar power source was used as a power source. The bipolar power source was set such that an electric current with a current density, per unit area of the processing electrode, of 2.4 A/cm² will flow. The pulse voltage of the bipolar power source was set as follows: the lowest potential 0V; the duty ratio 50%; and a square wave with the positive potential time of 10 ms. With respect to the wafer sample processed under the above conditions, the formation of pits in the processed metal surface of the wafer was observed under a laser microscope. The number of pits was found to be less than 50,000 per square centimeters of metal surface, with the diameter of each pit being less than 0.5 μm and the depth less than 0.2 μm. As apparent from comparison with the below-described Comp. Example 2 which employs a DC voltage with the same current density, use of a pulse voltage can remarkably decrease the number of pits.

### EXAMPLE 5

A flange, for one-inch high-pressure pipe, of SUS 316 was mounted to a rotating machine, and a processing electrode and the flange were immersed in water having an electric conductivity of 180 μS/cm. The flange had been produced on lathe processing. The processing electrode having a 5 mm×4 mm effective area was brought into contact with a gasket portion of the flange which is an annular groove with a width of 5 mm and in which a metal O-ring is to be mounted. The rotating machine was rotated at 300 rpm. An anode of a bipolar power source was connected via a brush electrode to a shaft of the rotating machine so that a pulse voltage can be applied to the whole flange. The pulse waveform of the bipolar power source was set in a constant current made such that an electric current with a current density, per unit area of the processing electrode, of 1 A/cm² will flow during the period of positive potential. A square wave was used as the pulse waveform, and the duty ratio was set at 50% and the frequency was set at 50 Hz. The gasket portion of the flange was processed for three minutes under the above conditions. After the processing, a mirror-like surface was obtained in the gasket portion. A metal O-ring was mounted in the processed flange, and a leak test was carried out using water at a pressure of 100 MPa. As a result, no leak of water was observed. This shows that a processed surface having a very flatness can be obtained by electrolytic processing even with use of water having an electric conductivity of 180 μS/cm.

The following are comparative examples to the above examples according to the present inventions; a copper film formed on a wafer was processed with a conventional electrolytic processing apparatus.

### COMP. EXAMPLE 1

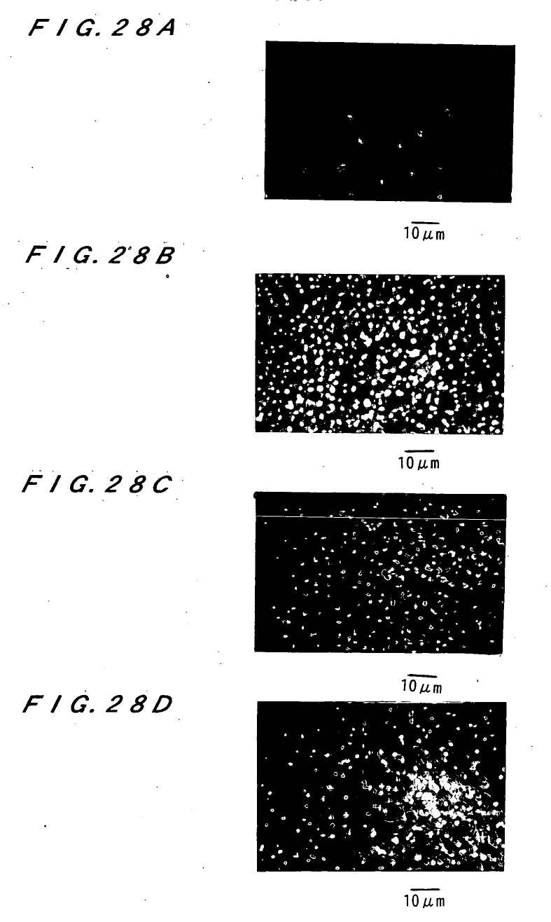

A sample (workpiece) for electrolytic processing was prepared by forming a 1.5 μm thick copper film by electroplating on a wafer having a diameter of 20 cm. A processing electrode was composed of a diaphragmatic ion exchanger, a porous ion exchanger and a current-carrying portion of a platinum plate. Nafion 117 was used as the diaphragmatic ion exchanger; a polyethylene non-woven fabric having a sulfonic ion-exchange group, introduced by graft polymerization, was used as the porous ion exchanger. The processing electrodes and the wafer were sunk in a water tank filled with ultrapure water, and the wafer was rotated at 500 rpm by a rotating machine. The processing electrodes were connected to a cathode of a DC power source, while a brash electrode as a feeding electrode was connected to an anode, and the brash electrode was brought into contact with the rotating wafer. The DC power source was set in a constant voltage (CV) made, and a voltage at 10-40V was applied. FIGS. 28A through 28D are SEM photographs of the processed surfaces of the wafers as processed under each DC voltage. FIGS. 28A through 28D show the SEM photographs of the processed surfaces after processing with the application of a DC voltage at 10V (FIG. 28A), 20V (FIG. 28B), 30V (FIG. 28C), and 40V (FIG. 28D). It was observed that in the electrolytic processing using a direct current, the processing rate of the copper film of the wafer increased in proportion to the voltage applied. On the other hand, the SEM observation showed the formation of pits in all of the processed wafer samples, with the number of pits being large.

### COMP. EXAMPLE 2

A sample (workpiece) for electrolytic processing was prepared by forming a 1.5 μm thick copper film by electroplating on a wafer having a diameter of 20 cm. A processing electrode was composed of a diaphragmatic ion exchanger, a porous ion exchanger and a current-carrying portion of a platinum plate. Nafion 117 was used as the diaphragmatic ion exchanger; a polyethylene non-woven fabric having a sulfonic ion-exchange group, introduced by graft polymerization, was used as the porous ion exchanger. The processing electrodes and the wafer were immersed in pure water, having an electric conductivity of 3 μS/cm, pooled in a water tank, and the wafer was rotated at 500 rpm by a rotating machine. A DC power source was used as a power source. The DC power source was set such that an electric current with a current density, per unit area of the processing electrode, of 2.4 A/cm² will flow. With respect to the wafer sample processed under the above conditions, the formation of pits in the processed metal surface of the wafer was observed under a laser microscope. The number of pits was found to over 1,000,000 per square centimeters of metal surface. The pits had a wide size distribution ranging from 0.5-2 μm, and the deepest pits had a depth of 3 μm.

As described hereinabove, according to the present invention, instead of a CMP processing, for example, electrolytic processing of a workpiece, such as a substrate, can be effected through an electrochemical action without causing any physical defects in the workpiece that would impair the properties of the workpiece. Accordingly, the present invention can omit a CMP processing entirely or at least reduce a load upon CMP processing. Further, the present invention can effectively remove (clean) matter adhering to the surface of the workpiece, such as a substrate. The present invention is particularly suited for flattening a semiconductor substrate that employs a low dielectric constant material, such as an organic insulating film, to which a high mechanical pressure cannot be applied. Further, the processing of a substrate can be effected even by solely using pure water or ultrapure water. This obviates the possibility that extra impurities such as an electrolyte will adhere to or remain on the surface of the substrate, can simplify a cleaning process after the removal processing, and can remarkably reduce a load upon waste liquid disposal. Furthermore, the present invention can prevent the formation of pits in a workpiece which would impair the product quality.

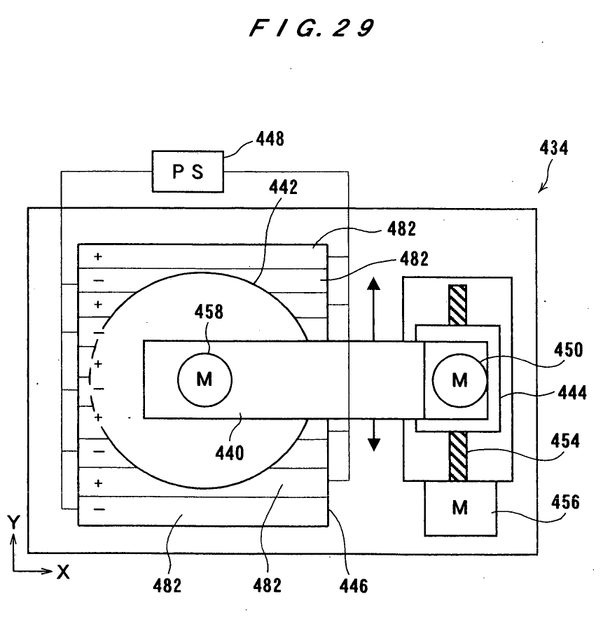

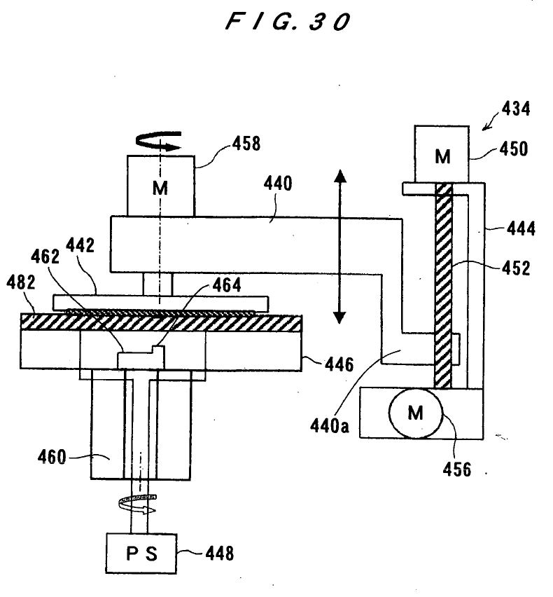

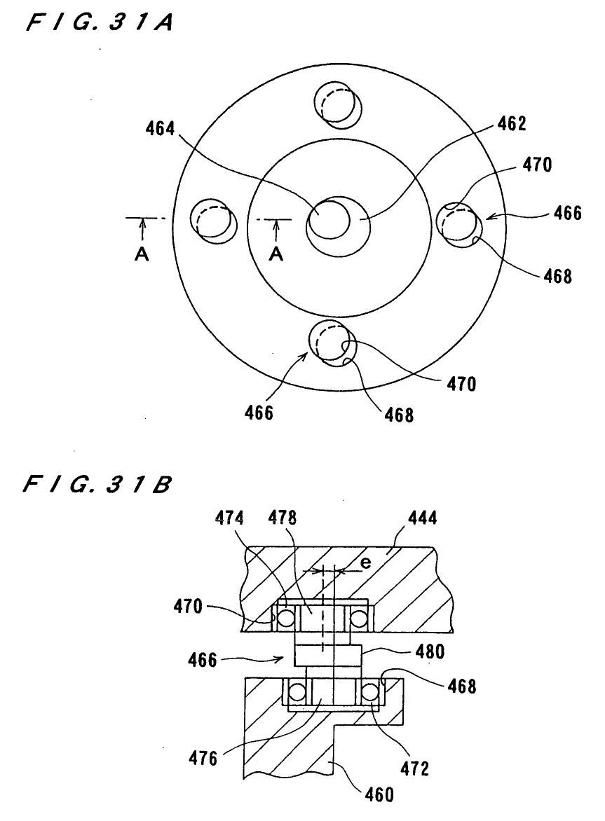

FIG. 29 is a plan view schematically showing an electrolytic processing apparatus of a seventh embodiment of the present invention that is used as the above-described electrolytic processing apparatus 114 shown in FIG. 6, and FIG. 30 is a vertical sectional view of FIG. 29. As shown in FIGS. 29 and 30, the electrolytic processing apparatus 434 of this embodiment includes a arm 440 that can move vertically and make a reciprocating movement in a horizontal plane, a substrate holder 442, supported vertically at the free end of the arm 440, for attracting and holding the substrate W with its front surface facing downwardly (face-down), moveable flame 444 to which the arm 440 is attached, a rectangular electrode section 446, and a power source 448 to be connected to the electrode section 446. In this embodiment, the size of the electrode section 446 is designed to have a slightly larger size than the diameter of the substrate W to be held by the substrate holder 442. A substrate holding device, which is adapted to hold a substrate with vacuum suction, may be used as the substrate holder 442.

A vertical-movement motor 450 is mounted on the upper end of the moveable flame 444. A ball screw 452, which extends vertically, is connected to the vertical-movement motor 450. A base 440a of the arm 440 is connected to a ball screw 452, so that the arm 440 moves vertically via the ball screw 452 by the actuation of the vertical-movement motor 450. The moveable flame 444 per se is connected to a ball screw 454 that extends horizontally, so that the moveable flame 444 and the arm 440 make a reciprocating movement in a horizontal plane by the actuation of a reciprocating motor 456.

The substrate holder 442 is connected to a substrate-rotating motor 458 supported at the free end of the arm 440, and is rotated (about its axis) by the actuation of the substrate-rotating motor 458. The arm 440 can move vertically and make a reciprocating movement in the horizontal direction, as described above, the substrate holder 442 can move vertically and make a reciprocating movement in the horizontal direction together with the arm 440.

A hollow motor 460 is disposed below the electrode section 446. A drive end 464 is formed at an upper end portion of a main shaft 462 of the hollow motor 460 and arranged eccentrically position to the center of the main shaft 462. The electrode section 446 is rotatably coupled to the drive end 464 via a bearing (not shown) at the center portion thereof. Three or more of rotation-prevention mechanisms are provided in the circumferential direction between the electrode section 446 and the hollow motor 460.

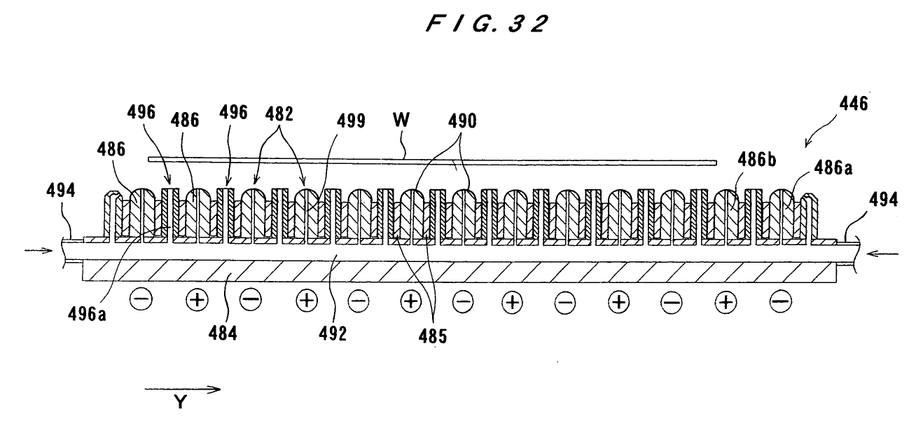

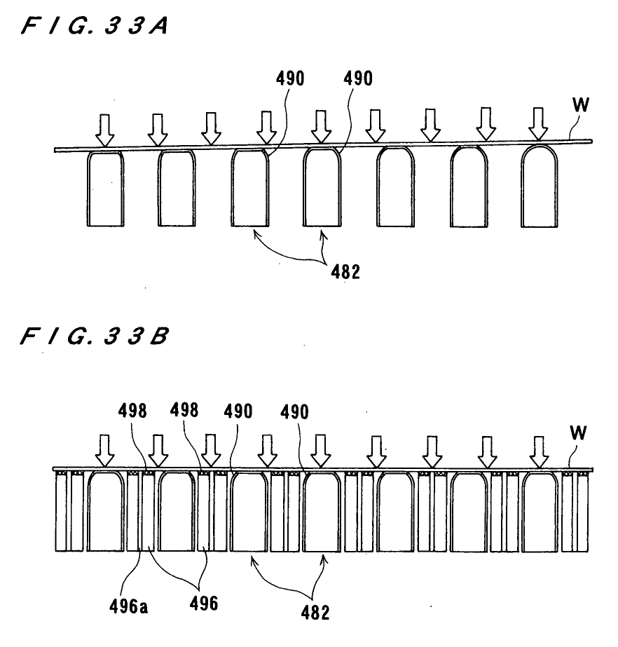

FIG. 31A is a plan view showing the rotation-prevention mechanisms of this embodiment, and FIG. 31B is a cross-sectional view taken along line A-A of FIG. 31A. As shown in FIGS. 31A and 32B, three or more (four in FIG. 31A) of rotation-prevention mechanisms 466 are provided in the circumferential direction between the electrode section 446 and the hollow motor 460. As shown in FIG. 31B, a plurality of depressions 468, 470 are formed at equal intervals in the circumferential direction at the corresponding positions in the upper surface of the hollow motor 460 and in the lower surface of the electrode section 446. Bearings 472, 474 are fixed in each depression 468, 470, respectively. A connecting member 480, which has two shafts 476, 478 that are eccentric to each other by eccentricity “e”, is coupled to each pair of the bearings 472, 474 by inserting the respective ends of the shafts 476, 478 into the bearings 472, 474. The eccentricity of the drive end 464 against to the center of the main shaft 462 of the hollow motor 460 is also “e”, as described above. Accordingly, the electrode section 446 is allowed to make a revolutionary movement with the distance between the center of the main shaft 462 and the drive end 464 as radius “e”, without rotation about its own axis, i.e. the so-called scroll movement (translational rotation movement) by the actuation of the hollow motor 460, to make a relative movement against the substrate W.

Next, the electrode section 446 according to this embodiment will now be described. FIG. 32 is a vertical sectional view of the electrode section 446. As shown in FIGS. 29 and 32, the electrode section 446 includes a plurality of electrode members 482 which extend in the X direction (see FIG. 29) and are disposed in parallel at an even pitch on a tabular base 484.

As shown in FIG. 32, each electrode member 482 comprises an electrode 486 to be connected to a power source, and an ion exchanger (ion-exchange membrane) 490 covering a surface of the electrode 486 integrally. The ion exchanger 490 is mounted to the electrode 486 via holding plates 485 disposed on both sides of the electrode 486.

According to this embodiment, the electrodes 486 of adjacent electrode members 482 are connected alternately to a cathode and to an anode of the power source. For example, an electrode 486a (see FIG. 32) is connected to the cathode of the power source 448 and an electrode 486b (see FIG. 32) is connected to the anode. When processing copper, for example, the electrolytic processing action occurs on the cathode side, and therefore the electrode 486a connected to the cathode becomes a processing electrode, and the electrode 486b connected to the anode becomes a feeding electrode. Thus, according to this embodiment, the processing electrodes 486a and the feeding electrodes 486b are disposed in parallel and alternately.

As previously stated, depending upon the material to be processed, the electrode connected to the cathode of the power source may serve as a feeding electrode, and the electrode connected to the anode may serve as a processing electrode.

By thus providing the processing electrodes 486a and the feeding electrodes 486b, which face the substrate W, alternately in the Y direction of the electrode section 446 (direction perpendicular to the long direction of the electrode members 482), provision of a feeding section for feeding electricity to the conductive film (object to be processed) of the substrate W is no longer necessary, and processing of the entire surface of the substrate becomes possible. Further, by changing the positive and negative of the voltage applied between the electrodes 486 in a pulse form (e.g. square wave or sine curve or part of them), it becomes possible to dissolve the electrolysis products, and improve the flatness of the processed surface through the multiplicity of repetition of processing.

As shown in FIG. 32, a flow passage 492 for supplying pure water, more preferably ultrapure water, to the surface to be processed is formed in the interior of the base 484 of the electrode section 446, and the flow passage 492 is connected to a pure water supply source (not shown) via a pure water supply pipe 494. On both sides of each electrode member 482, there are provided partition members 496 that contact the surface of the substrate W. Through-holes 496a (fluid supply section), communicating with the flow passage 492, are formed in the interior of each partition member 496, and a liquid, such as pure water or ultrapure water, is supplied through the through-holes 496a to between the substrate W and the ion exchangers 490 of the electrode members 482.

Through-holes 499, which extend to the ion exchangers 490 from the flow passage 492, are formed in the interior of the electrode 486 of each electrode member 482. With such a construction, pure water or ultrapure water in the flow passage 492 is supplied to the ion exchangers 490 through the through-holes 499. Pure water herein refers to a water having an electric conductivity of not more than 10 μS/cm, and ultrapure water refers to a water having an electric conductivity of not more than 0.1 μS/cm.

A voltage is applied between adjacent electrodes 486 via the power source 448 so that the electrodes 486 function as processing electrodes and feeding electrodes, while supplying pure water or ultrapure water, which does not contain an electrolyte, to between the copper film (see FIG. 1B) of the substrate W and the electrodes 486, whereby electrolytic processing of the surface of the substrate W is carried out.

As described above, instead of pure water or ultrapure water, a liquid having an electric conductivity of not more than 500 μS/cm, preferably not more than 50 μS/cm, more preferably not more than 0.1 μS/cm (resistivity of not less than 10 MΩ·cm) may be used.

This invention is not limited to electrolytic processing using an ion exchanger. When using, for example, an electrolytic solution as a processing liquid, a processing member to be mounted on the surfaces of the electrodes is not limited to an ion exchanger which is the most suitable for pure water or ultrapure water, but a soft polishing pad or non-woven fabric, or the like may also be used. Also in that case, the above-described contact member and substrate holder are useful in obtaining a good processing performance.

It is preferred to use an ion exchanger having an excellent water permeability as the ion exchanger 490 covering the surface of the electrode 486. By permitting pure water or ultrapure water to flow through the ion exchanger 490, a sufficient amount of water can be supplied to a functional group (sulfonic acid group in the case of a strongly acidic cation-exchange material) for promoting dissociative reaction of water, to thereby increase the amount of dissociated water molecules, and the processing products (including gasses) formed by the reaction through hydroxide ions (or OH radicals) can be removed by the flow of water, whereby the processing efficiency can be enhanced. A water-permeable sponge-like member or a member in the form of a membrane, such as Nafion (trademark, DuPont Co.), having through-holes for permitting water to flow therethrough, for example, is used as such a water-permeable member.

It is ideal that the substrate W contacts the ion exchangers 490 uniformly over all of the electrode members 482. In cases where ion exchangers 490, having an elasticity, are disposed in parallel as in this embodiment, since the ion exchangers 490 do not have such an elasticity as a polishing surface as employed in CMP, the substrate W could tilt due to a relative movement between the electrode members 482 and the substrate W, the supply of pure water, etc., leading to a failure in making a uniform contact with the ion exchangers 490, as shown in FIG. 33A. Especially, according to the substrate holder 442 that holds a substrate with vacuum suction, contact between the whole substrate surface and the electrodes 486 is controlled. Accordingly, in the case where a plurality of electrodes 486 (ion exchangers 490) are disposed, it is difficult with the substrate holder to effect such a control that the substrate W contacts all the electrodes 486 (ion exchangers 490) uniformly.

In view of the above, according to this embodiment, the partition members 496 are provided on both sides of each electrode member 482. The height of each partition member 496 is set so that it is slightly lower than the height of the ion exchanger 490 of each electrode member 482. Accordingly, when the substrate W is brought into contact with the ion exchangers 490 of the electrode members 482, the surface of the substrate W comes to be supported by the partition members 496. Thus, as shown in FIG. 33B, after pressing the substrate W against the ion exchangers 490 to a certain extent, the substrate W comes into contact with the upper surfaces of the partition members 496. Accordingly, if it is attempted to further press the substrate W against the ion exchangers 490, the pressing force is received with the partition members 496, and therefore the contact area between the substrate W and the ion exchangers 490 does not change. Thus, according to this embodiment, the substrate W can be prevented from tilting, and the contact area can be kept constant, whereby a uniform processing can be effected.

As shown in FIG. 33B, it is preferred to mount on the upper surface of each partition member 496 a buffer member 498 formed of a material having such an elasticity as not to damage the surface of the substrate W. Specific examples of the buffer member 498 include porous polymers, such as foamed urethane; fibrous materials, such as non-woven or woven fabric; various polishing pads. It is also possible to a use POLYTEX pad (trademark, Rodel, Inc.) as such a buffer member 498. In the case of electrolytic processing using an electrolytic solution, water-permeable contact members such as polishing pads may be provided between the electrodes and the substrate W, instead of ion exchangers 490 which cover the electrodes.

Next, substrate processing (electrolytic processing) by using the electrolytic processing apparatus of this embodiment will be described. First, a substrate W, e.g. a substrate W, as shown in FIG. 1B, which has in its surface a copper film 6 as a conductive film (object to be processed), is reversed so that the front surface of the substrate W faces downwardly, and transferred to the electrolytic processing apparatus 434. The substrate W is then attracted and held by the substrate holder 442. The arm 440 is moved to move the substrate holder 442 holding the substrate W to a processing position right above the electrode section 446. Next, the vertical-movement motor 450 is driven to lower the substrate holder 442 so as to bring the copper film 6 of the substrate W held by the substrate holder 442 into contact with the surfaces of the ion exchangers 490 (elastic members) of the electrode section 446, and to position the substrate W where its surface comes into contact with the buffer members 498 (elastic members) on the upper surfaces of the partition members 496. The substrate W may be positioned just before being contact with the buffer members 498. Thereafter, the substrate-rotating motor 458 (first drive section) is driven to rotate the substrate W and, at the same time, the hollow motor 460 (second drive section) is driven to allow the electrode section 446 to make a scroll movement, while pure water or ultrapure water is supplied from the through-holes 496a of the partition members 496 to between the substrate W and the electrode members 482 and, at the same time, pure water or ultrapure water is passed through the through-holes 499 of the electrode section 446 to the ion exchangers 490, thereby impregnating the ion exchangers 490 with pure water or ultrapure water. According to this embodiment, the pure water or ultrapure water supplied to the ion exchangers 490 is discharged from the ends in the long direction of each electrode member 482.

A given voltage is applied from the power source 448 to between the adjacent electrodes 486, thereby electrolytic processing of the copper film 6 in the surface of the substrate W for dissolving and removing the copper film 6 is carried out at the electrodes 486a on the cathode side, which may be referred as processing electrode 486a, through the action of hydrogen ions and hydroxide ions produced by the ion exchanger 490. Processing proceeds in the region facing the processing electrodes 486a, the entire surface of the substrate W may be carried out by allowing the substrate W and the processing electrodes 486a to make a relative movement. The voltage applied during electrolytic processing may be a pulse wave of a square wave, a sine curve or a positive potential thereof.

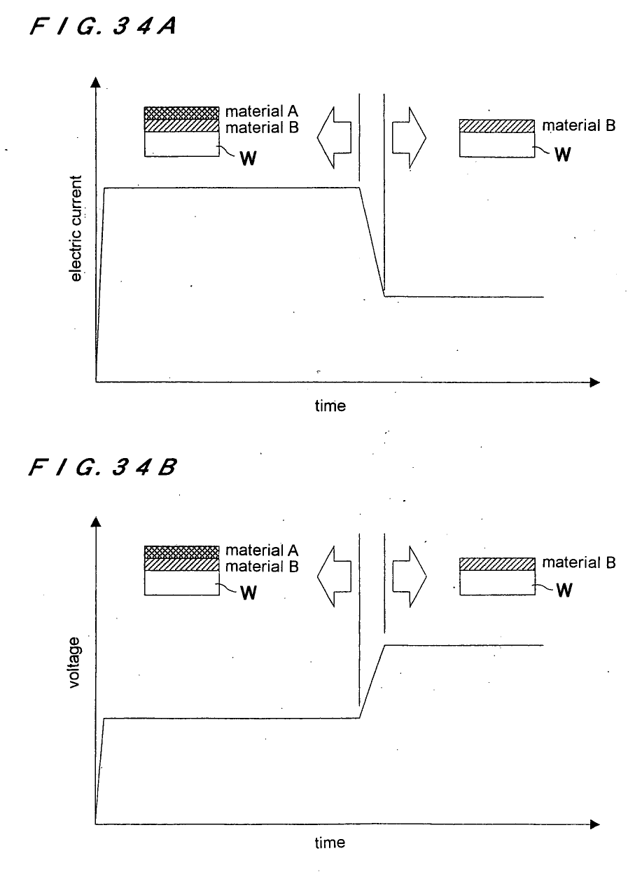

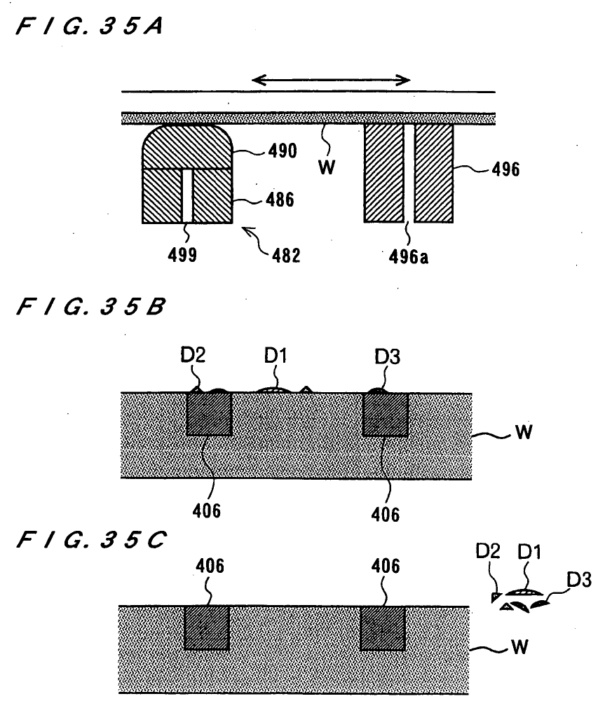

During the electrolytic processing, the voltage applied between the electrodes 486 or the electric current flowing therebetween is monitored with the monitor section 118 (see FIG. 6) to detect the end point (terminal of processing). It is noted in this connection that in electrolytic processing, the electric current (applied voltage) may vary depending upon the material to be processed even with the same voltage (electric current). For example, as shown in FIG. 34A, when an electric current is monitored during electrolytic processing of the surface of a substrate W on which a film of material B and a film of material A are laminated in this order, a constant electric current is observed during the processing of material A, but it changes upon the shift to the processing of the different material B. Likewise, as shown in FIG. 34B, though a constant voltage is applied between the electrodes 486 during the processing of material A, the voltage applied changes upon the shift to the processing of the different material B. FIG. 34A illustrates a case in which the electric current is harder to flow in electrolytic processing of material B compared to electrolytic processing of material A, and FIG. 34B illustrates a case in which the voltage becomes higher in electrolytic processing of material B compared to electrolytic processing of material A. As will be appreciated from the above-described example, the monitoring of a change in electric current or voltage can surely detect the end point.

Though in this embodiment the voltage applied between the electrodes 486, or the electric current flowing therebetween is monitored with the monitor section 118 to detect the end point of processing, it is also possible to monitor with the monitor section 118 a change in the state of a substrate being processed to detect an arbitrarily set end point of processing. In this case, the end point of processing refers to a point at which a desired processing amount is reached for a specified region in the processing surface of the substrate, or a point at which a parameter correlated with processing amount has reached a value corresponding to a desired processing amount for a specified region in the processing surface. By thus arbitrarily setting and detecting the end point of processing even in the course of processing, it becomes possible to carry out a multi-step electrolytic processing.

For example, the processing amount may be determined by detecting a change in frictional force due to a difference in friction coefficient produced when a different material is reached in a substrate, or a change in frictional force produced by removal of irregularities in the surface of the substrate. The endpoint of processing may be detected based on the processing amount thus determined. During electrolytic processing, heat is generated by the electric resistance of the surface to be processed, or by collision between water molecules and ions moving in the liquid (pure water) between the surface to be processed and the processing electrodes. In processing e.g. a copper film deposited on the surface of a substrate under a controlled constant voltage, when a barrier layer or an insulating film becomes exposed with the progress of electrolytic processing, the electric resistance increases and the current value decreases, and the heat value decreases in order. Accordingly, the processing amount may be determined by detecting the change in the heat value. The end point of processing may therefore be detected. Alternatively, the film thickness of a to-be-processed film on a substrate may be determined by detecting a change in the intensity of reflected light due to a difference in reflectance produced when a different material is reached in the substrate. The end point of processing may be detected based on the film thickness thus determined. The film thickness of a to-be-processed film on a substrate may also be determined by generating an eddy current within a to-be-processed conductive film, for example, a copper film, and monitoring the eddy current flowing within the substrate to detect a change in e.g. the frequency, thereby detecting the end point of processing. Further, in electrolytic processing, the processing rate depends on the value of the electric current flowing between the electrodes 486, and the processing amount is proportional to the quantity of electricity, determined by the product of the current value and the processing time. Accordingly, the processing amount may be determined by integrating the quantity of electricity, and detecting the integrated value reaching a predetermined value. The end point of processing may thus be detected.

The monitor section 118, when it determines the completion of electrolytic processing, effects a control to disconnect the electrodes 486 from the power source 448, thereby stopping the application of voltage between the electrodes 486. Thereafter, as shown in FIG. 35A, while the substrate W is kept in contact with the top of each ion exchanger 490 and the top of each partition member 496, the substrate-rotating motor 458 (first drive section) is driven to rotate the substrate W and the hollow motor 460 (second drive section) is driven to allow the electrode section 446 to make a scroll movement, thereby allowing the substrate W and the electrode section 446 to make a relative movement for a given length of time, for example 1 to 60 seconds, preferably 5 to 30 seconds, more preferably 5 to 15 seconds. At the same time, a liquid, such as pure water or ultrapure water, is supplied from the through-holes 496a of each partition member 496 and from the through-holes 499 of each electrode 486 to between the ion exchanger 490, the partition member 496 and the substrate W, and the liquid is discharged from the ends in the long direction of each electrode member 482. The pressing force of the substrate W to the processing electrode section during the relative movement may be the same as in the electrolytic processing, or may be lowered within the range that allows contact between the workpiece and the ion exchangers 490 (contact members). It is possible not to precisely measure the processing amount. Thus, it is possible to carryout electrolytic processing for a predetermined time-by-time management, and then carry out the scrubbing of the substrate without applying a voltage.

As shown in FIG. 35B, various extraneous matters and residues are present on the processed surface of the substrate W immediately after electrolytic processing with current supplying. Among them is, for example, a processing product D1 which has dissolved out of the conductive film (copper film 6) of the substrate W during electrolytic processing and adhered to the substrate surface. The extraneous matter D1 is a substance which is produced upon the processing reaction between copper and OH ions. There are also scrapings D2 of the ion exchanger 490 which have been scraped off from the ion exchanger 490 by the relative movement between the substrate W and the electrode section 446, and attracted to the substrate surface due to the electric field effect by the voltage application. Further, an extremely thin oxide film layer which has been oxidized through electrolytic processing to become an insulator, a small amount of unreacted metal D3 remaining in a non-conductive state, etc. are present as residues.

By allowing the substrate W and the electrode section 446 to make a relative movement for a given length of time also after completion of electrolytic processing while supplying a liquid, such as pure water or ultrapure water, between the ion exchangers 490, the partition members 496 and the substrate W, the extraneous matters and residues D1 through D3 are removed by the top contact portions of the ion exchangers 490 and the partition members 496, and are partly discharged out together with the liquid, such as pure water or ultrapure water. Part of the extraneous matters and residues D1 through D3 are trapped in the ion exchangers 490 or the partition members 496.

Thereafter, the monitor section 118 stops the rotation of the substrate holder 442 and the scroll movement of the electrode section 446, and then raises the substrate holder 442 to thereby separate the substrate W from the electrode section 446 and moves the arm 440 to transfer the substrate W to the transport robot 116 (see FIG. 6). The transport robot 116, which has received the substrate W, after reversing the substrate according to necessity, returns the substrate W to the cassette in the loading/unloading section 110 (see FIG. 6).

According to this embodiment, after stopping the voltage application upon the completion of electrolytic processing, the substrate W and the electrode section 446 are allowed to make a relative movement for a given length of time while supplying the liquid therebetween. As a result, the above-described extraneous matters and residues D1 through D3 are no more present on the surface of the substrate W, as shown in FIG. 35C. Visual comparison of the substrate W immediately after electrolytic processing with the substrate W after the post-processing relative movement without voltage application would readily confirm that the extraneous matters and residues on the former substrate have been cleaned off and are no more present on the latter substrate. The substrate W can thus be prevented from remaining contaminated with the extraneous matters and residues, such as a precipitate from dissolved copper ions, fine particles, etc. This makes it possible to remarkably reduce contamination of the surface of a workpiece associated with its electrolytic processing. In addition, use as a processing liquid a liquid having an electric conductivity of not more than 500 μS/cm, preferably pure water, more preferably ultrapure water, can facilitate disposal of the waste liquid after processing.

Thus, this makes it possible to clean the processed surface of the substrate W, removing factors that would cause a short circuit between the interconnects 6 (see FIG. 1C) of copper film of the substrate W, and thereby improve the reliability of the processed substrate W while reducing a load upon cleaning after electrolytic processing.

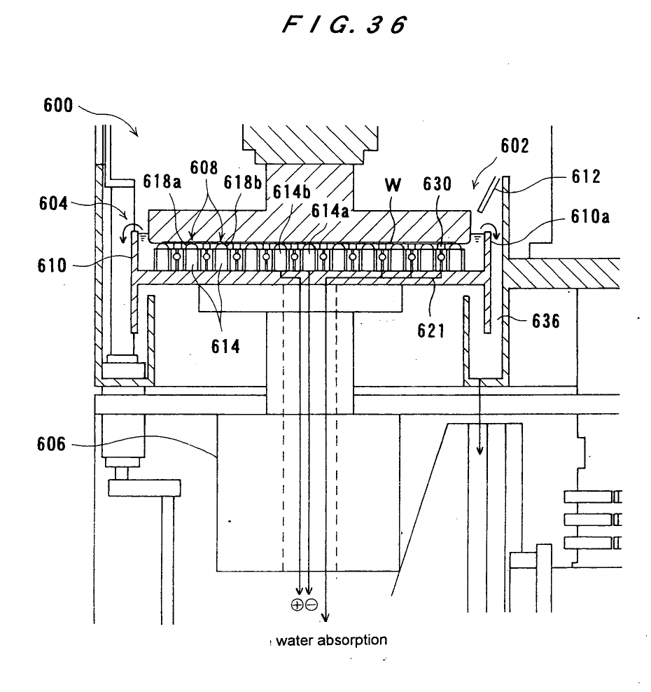

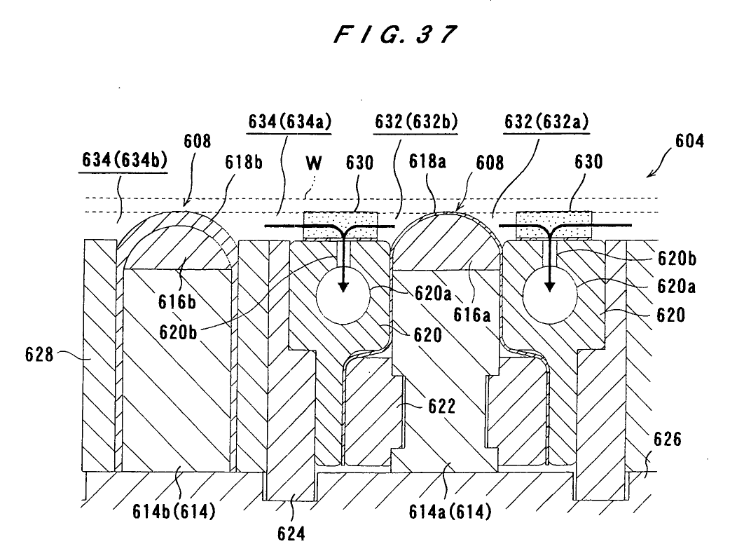

FIG. 36 is a vertical sectional view showing a main portion of an electrolytic processing apparatus according to a eighth embodiment of the present invention, and FIG. 37 is an enlarged view of a main portion of FIG. 36. As shown in FIG. 36, the electrolytic processing apparatus 600 includes a substrate holder 602 for holding a substrate W with its front surface facing downwardly, and a rectangular electrode section 604 disposed below the substrate holder 602. The substrate holder 602, as with the substrate holder 442 shown in FIGS. 29 through 33, is rotatable and is movable vertically and horizontally. The electrode section 604 is provided with a hollow scroll motor 606 (drive section) and, by the actuation of the scroll motor 606, makes a circular movement without rotation, a so-called scroll movement (translational rotary movement).

The electrode section 604 includes a plurality of linearly-extending electrode members 608 and a vessel 610 which opens upwardly. The plurality of electrode members 608 are disposed in parallel at an even pitch in the vessel 610. Further, positioned above the vessel 610, a liquid supply nozzle 612 is disposed for supplying a liquid, such as ultrapure water or pure water, into the vessel 610. Each electrode member 608 includes an electrode 614 to be connected to a power source in the apparatus. The electrodes 614 are connected alternately to a cathode and to an anode of the power source, that is, processing electrodes 614a are connected to the cathode of the power source and feeding electrodes 614b are connected to the anode alternately. Thus, as described above, when processing copper, for example, the electrolytic processing action occurs on the anode side, and therefore the electrode 614a connected to the cathode becomes a processing electrode and the electrode 614b connected to the anode becomes a feeding electrode.

With respect to each processing electrode 614a connected to the cathode, as shown in detail in FIG. 37, an ion exchanger 616a composed of e.g. a non-woven fabric is mounted on the upper portion of the processing electrode 614a. The processing electrode 614a and the ion exchanger 616a are covered integrally with a second ion exchanger 618a composed of an ion-exchange membrane which shuts off permeation therethrough of a liquid and permits only ions to pass therethrough. Similarly, an ion exchanger 616b composed of e.g. a non-woven fabric is mounted on the upper portion of each feeding electrode 614b to be connected to the anode, and the feeding electrode 614b and the ion exchanger 616b are covered integrally with a second ion exchanger 618b composed of ion-exchange membrane which shuts off permeation therethrough of a liquid and permits only ions to pass therethrough. Accordingly, ultrapure water or a liquid passes through through-holes (not shown) provided at certain locations along the long direction of the electrode 614 and can move freely within the ion exchanger 616a, 616b composed of a non-woven fabric and easily reach the active points, having water dissociation catalytic activity, within the non-woven fabric, while the flow of the liquid is shut off by the ion exchanger 618a, 618b, which constitutes the below-described second partition.

A pair of liquid suction nozzles 620 is disposed on both sides of each processing electrode 614a connected to the cathode of the power source. In the interior of each liquid suction nozzle 620, a liquid flow passage 620a, extending in the long direction, is provided, and liquid suction holes 620b, which opens upward and communicates with the liquid flow passage 620a, are provided at certain locations along the long direction. The liquid flow passage 620a communicates with a liquid discharge passage 621, as shown in FIG. 36, and the liquid in the liquid flow passage 620a is discharged out from the liquid discharge passage 621.

The processing electrode 614a and the pair of liquid suction nozzles 620 are integrated by a pair of tap bars 622, and held between a pair of insert plates 624 and fixed on a base 626. On the other hand, each feeding electrode 614b, with its surface covered with the ion exchanger 618b, is held between a pair of holding plates 628 and fixed on the base 626.

The ion exchangers 616a, 616b are, for example, composed of a non-woven fabric having an anion exchange group or a cation exchange group. As described above, it is possible to use a laminate of an anion exchanger having an anion exchange group and a cation exchanger having a cation exchange group, or impart both of anion exchange group and cation exchange group to the ion exchangers 616a, 616b themselves. A polyolefin polymer, such as polyethylene or polypropylene, or other organic polymers may be used as the base material of the ion exchangers. With respect to the base material of the electrodes 614 of the electrode members 608, rather than metals or metal compounds widely used for electrodes, it is preferred to use carbon, a relatively inactive noble metal, a conductive oxide or a conductive ceramic, as also described above.

A contact member (partition) 630, composed of e.g. a continuous-pore porous material having elasticity, is mounted on the upper surface of each liquid suction nozzle 620 over the full length in the long direction. The thickness of the contact member 630 is set at such a thickness that when the substrate W, held by the substrate holder 602, is brought close to or into contact with the ion exchangers 618a, 618b of the electrode members 608 to carry out electrolytic processing of the substrate W, the upper surface of the partition 630 comes into pressure contact with the substrate W held by the substrate holder 602.

Accordingly, upon electrolytic processing, flow paths 632 (fluid supply sections) formed between the processing electrodes 614a and the substrate W, and flow paths 634 (fluid supply sections) formed between the feeding electrodes 614b and the substrate W, which are separated by the contact members (partitions) 630, are formed in parallel between the electrode section 604 and the substrate holder 602. Further, each flow path 632 formed between the processing electrode 614a and the substrate W is separated into two flow paths 632a, 632b by the ion exchanger 618a as a second partition composed of an ion-exchange membrane, while each flow path 634 formed between the feeding electrode 614b and the substrate W is separated into two flow paths 634a, 634b by the ion exchanger 618b as a second partition composed of an ion-exchange membrane.

By the actuation of a suction pump connected to the liquid discharge passage 621, the liquid flowing along the flow paths 632, 634 flows into the contact members (partitions) 630, then passes through the liquid suction holes 620b, the liquid flow passages 620a and the liquid discharge passage 621 and is discharged out. Use as the contact member (partition) 630 a continuous-pore porous material thus cannot completely separate (shut off) the flow of the liquid, but can shut off the flow only partly. In this regard, however, a complete separation (shut-off) of the liquid is not necessary, and it is sufficient if the flow of the liquid can be blocked to a certain degree.

A polyurethane sponge may be used as the continuous-pore porous material having elasticity that constitutes the contact member 630. The contact member 630 may also be composed of a non-woven fabric, a foamed polyurethane, a PVA sponge or an ion exchanger.

According to this embodiment, during electrolytic processing, the inside of the vessel 610 is filled with a liquid, such as ultrapure water or pure water, supplied from the liquid supply nozzle 612, while a liquid, such as ultrapure water or pure water, is kept supplied from the through-holes (not shown) provided in the electrodes 614 to the ion exchangers 616a, 616b composed of a non-woven fabric disposed on the upper portions of the processing electrodes 614a and the feeding electrodes 614b. An overflow channel 636 for discharging the liquid that has overflowed a circumferential wall 610a of the vessel 610 is provided outside the vessel 610. The liquid that has overflowed the circumferential wall 610a flows through the overflow channel 636 into a waste liquid tank (not shown).

During electrolytic processing, the suction pump connected to the liquid discharge passage 621 is driven, so that the liquid flowing along the flow paths 632 formed between the processing electrodes 614a and the substrate W, and the flow paths 634 formed between the feeding electrodes 614b and the substrate W is discharged out. Thus, upon electrolytic processing which is an electrochemical processing, the flows of the liquid flowing between the substrate W and the feeding electrodes 614b, at which a gas generation reaction mainly occurs, can at least partly be separated from the flows of the liquid flowing between the processing electrodes 614a and the substrate W, and the respective flows can be controlled independently, whereby the gas bubbles generated can be removed effectively.

It has been confirmed that when the flow paths 632 formed between the processing electrodes 614a and the substrate W are separated from the flow paths 634 formed between the feeding electrodes 614b and the substrate by using e.g. polyurethane sponges as the contact members (partitions) 630 in a so-called multi-bar electrode system, the formation of pits decreases about on a single-digit order. This is considered to be due to the facts that (1) movement of the gas bubbles on the feeding electrode side to the surface of the workpiece is shut off by the partitions and (2) the flow path on the processing electrode side is restricted (i.e. the cross-sectional area of the flow path is decreased) by the partitions, whereby the flow velocity of ultrapure water on the processing electrode side is increased.

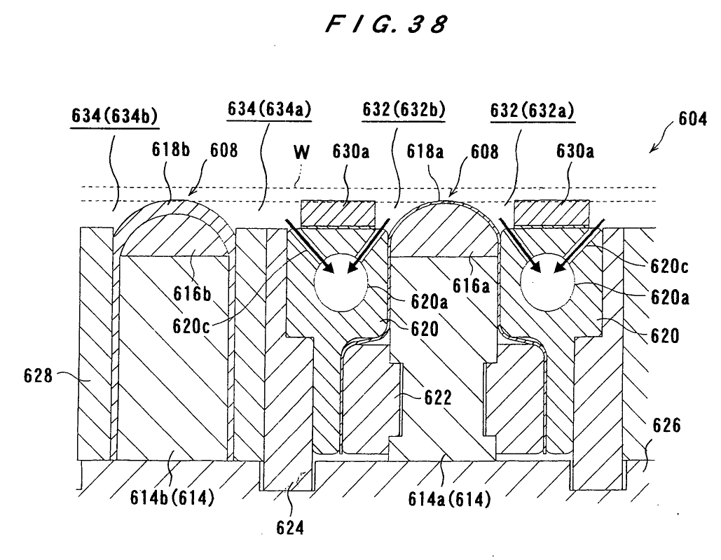

FIG. 38 shows a variation of the electrode section 604. This embodiment employs as a contact member (partition) 630a an elastic material, such as a rubber, which is not permeable to a liquid, and employs as the liquid suction nozzle 620 one having two liquid suction holes 620c that open to both sides of the partition 630a. The other construction is the same as the above-described embodiment. According to this embodiment, separation of the flow paths 632 formed between the processing electrodes 614a and the substrate W from the flow paths 634 formed between the feeding electrodes 614b and the substrate can be made complete.

Though not shown diagrammatically, it is possible to replace one of the pair of liquid suction nozzles, disposed on both sides of each processing electrode, with a liquid supply nozzle having liquid supply holes provided at certain locations along the long direction. By carrying out supply of the liquid by the liquid supply nozzle and suction of the liquid by the liquid suction nozzle simultaneously, it becomes possible to more securely control the flow of the liquid flowing along the flow paths 632 formed between the processing electrodes 614a and the substrate W and the flow of the liquid flowing along the flow paths 634 formed between the feeding electrodes 614b and the substrate, and decrease the amount of the liquid that flows across the partitions into the adjacent spaces. It is also possible to replace both of the nozzles, disposed on both sides of each processing electrode, with liquid supply nozzles so as to push out the liquid flowing along the electrodes. Also in this case, the processing is carried out while the inside of the vessel 610 is kept filled with the liquid and the substrate is kept immersed in the liquid. It is therefore desirable to supply the processing liquid from the liquid supply nozzle 612.

In the above-described embodiments that show the case of mounting an ion exchanger on the electrode, the shape of the electrode and the liquid for use in processing are not particularly limited provided that the partition member 496 or the contact member (partition) 630 can be provided between adjacent electrodes. Thus, the shape of electrode is not limited to a bar-like shape, but any shape of electrode can be selected, and a plurality of such electrodes may be disposed so that they will be opposed to a workpiece. It is possible to mount a water-permeable scrub member other than an ion exchanger on the electrode. Further, it is possible to make the partition member or the partition higher than the electrode surface, thereby preventing direct contact between a workpiece and the electrode and making the surface of the electrode exposed. Even in the case of not mounting an ion exchanger on the surface of the electrode, the second partition for partitioning the flow of the liquid between a workpiece and the electrode is preferably provided.

Also in this embodiment, as with the above-described seventh embodiment, after carrying out the substrate processing (electrolytic processing) until a predetermined processing amount is reached and determining the completion of electrolytic processing, feeding of the voltage is stopped, and the substrate W and the electrode section 604 are allowed to make a relative movement for a given length of time (e.g. 10 seconds) while supplying a liquid, such as pure water or ultrapure water, between them. Thereafter, the substrate W is separated from the electrode section 664 to thereby completely finish the electrolytic processing process. As with the above-described seventh embodiment, by the relative movement carried out without feed of a voltage, extraneous matters and residues remaining on the processed surface of the substrate W are removed and trapped in the contact members (partitions) 630, 630a and the ion exchangers 616a, 616b, 618a, 618b, and are partly discharged together with the liquid such as pure water or ultrapure water. Thus, also in this embodiment, the extraneous matters and residues on the surface of the substrate W coming from electrolytic processing can be removed by the treatment after the completion of electrolytic processing. Copper ions or the like, which have dissolved during electrolytic processing, are instantly trapped through ion-exchange reaction in the ion exchangers 616a, 616b, 618a, 618b. A small amount of unreacted metal, etc. is also trapped in the ion exchangers 616a, 616b, 618a, 618b. Accordingly, the substrate W is prevented from being contaminated with a precipitate of dissolved copper ions, a small amount of metal, etc.

This embodiment thus makes it possible to clean the surface of the substrate W, removing factors that would cause a short circuit between the interconnects 6 (see FIG. 1C) of copper film, and improve the reliability of the processed substrate W while reducing a load upon cleaning after electrolytic processing.

As described hereinabove, according to the present invention, extraneous matter and residues can be removed from the processed surface of a workpiece in the electrolytic processing process whereby, for example, extra impurities can be prevented from adhering to or remaining on the surface between the interconnects of a semiconductor substrate. Accordingly, the present invention makes it possible to improve the reliability of a workpiece, as by reducing the possibility of short circuit between interconnects of a semiconductor substrate or the like, while simplifying a cleaning step after electrolytic processing.

1. An electrolytic processing apparatus comprising:
a processing electrode that can come close to a workpiece;
a feeding electrode for feeding electricity to the workpiece;
a holder for holding the workpiece;
a power source for applying a voltage between the processing electrode and the feeding electrode;
a fluid supply section for supplying a fluid between the workpiece and at least one of the processing electrode and the feeding electrode;
a sensor for measuring the electric conductivity of the fluid; and
a control section for changing the processing conditions based on the electric conductivity measured by the sensor.

2. The electrolytic processing apparatus according to claim 1, wherein an ion exchanger is disposed between the workpiece and at least one of the processing electrode and the feeding electrode.

3. The electrolytic processing apparatus according to claim 1, wherein the control section changes the processing conditions during or after electrolytic processing of the workpiece.

4. The electrolytic processing apparatus according to claim 1, wherein the control section changes the processing conditions by changing the flow rate of the fluid supplied from the fluid supply section.

5. The electrolytic processing apparatus according to claim 1, wherein the sensor is disposed in the vicinity of the processing electrode or the feeding electrode.

6. The electrolytic processing apparatus according to claim 1, wherein the sensor is disposed at the fluid supply section.

7. The electrolytic processing apparatus according to claim 1, wherein the sensor is disposed at a fluid discharge section for discharging the fluid supplied from the fluid supply section.

8. The electrolytic processing apparatus according to claim 1, wherein the fluid supplied from the fluid supply section is pure water, ultrapure water or a fluid having an electric conductivity of not more than 500 μS/cm.

9. An electrolytic processing apparatus comprising:
a processing electrode;
a feeding electrode for feeding electricity to a workpiece;
an ion exchanger disposed between the workpiece and at least one of the processing electrode and the feeding electrode;
a holder for holding the workpiece and bringing the workpiece close to or into contact with the ion exchanger;
a power source for applying a voltage between the processing electrode and the feeding electrode;
a fluid supply section for supplying a fluid between the workpiece and the electrode in which the ion exchanger is disposed;
a sensor for measuring the electric conductivity of the fluid; and
a contaminant removing section for removing contaminants on the surface or in the interior of the ion exchanger based on the electric conductivity measured by the sensor.

10. The electrolytic processing apparatus according to claim 9, wherein the contaminant removing section comprises a regeneration section for regenerating the ion exchanger.

11. The electrolytic processing apparatus according to claim 9, wherein the contaminant removing section removes the contaminants during or after electrolytic processing of the workpiece.

12. The electrolytic processing apparatus according to claim 9, wherein the sensor is disposed at the contaminant removing section.

13. The electrolytic processing apparatus according to claim 9, wherein the sensor is disposed in the vicinity of the processing electrode or the feeding electrode.

14. The electrolytic processing apparatus according to claim 9, wherein the sensor is disposed at the fluid supply section.

15. The electrolytic processing apparatus according to claim 9, wherein the sensor is disposed at a fluid discharge section for discharging the fluid supplied from the fluid supply section.

16. The electrolytic processing apparatus according to claim 9, wherein the fluid supplied from the fluid supply section is pure water, ultrapure water or a fluid having an electric conductivity of not more than 500 μS/cm.

17. An electrolytic processing apparatus comprising:
a processing electrode that can come close to a workpiece;
a feeding electrode for feeding electricity to the workpiece;
a holder for holding the workpiece;
a power source for applying a voltage between the processing electrode and the feeding electrode;
a fluid supply section for supplying a fluid between the workpiece and at least one of the processing electrode and the feeding electrode;
a sensor for measuring the resistance between the processing electrode and the feeding electrode; and
a control section for controlling the operation of the apparatus based on the resistance measured by the sensor.

18. The electrolytic processing apparatus according to claim 17, wherein an ion exchanger is disposed between the workpiece and at least one of the processing electrode and the feeding electrode.

19. The electrolytic processing apparatus according to claim 17, wherein the sensor is disposed in the vicinity of the processing electrode or the feeding electrode.

20. The electrolytic processing apparatus according to claim 17, wherein the sensor is disposed at the fluid supply section.

21. The electrolytic processing apparatus according to claim 17, wherein the sensor is disposed at a fluid discharge section for discharging the fluid supplied from the fluid supply section.

22. The electrolytic processing apparatus according to claim 17, wherein the fluid supplied from the fluid supply section is pure water, ultrapure water or a fluid having an electric conductivity of not more than 500 μS/cm.

23. An electrolytic processing method comprising:
allowing a workpiece to be close to a processing electrode;
applying a voltage between the processing electrode and a feeding electrode for feeding electricity to the workpiece;
supplying a fluid between the workpiece and at least one of the processing electrode and the feeding electrode;
measuring the electric conductivity of the fluid; and
changing the processing conditions based on the measured electric conductivity.

24. The electrolytic processing method according to claim 23, wherein an ion exchanger is disposed between the workpiece and at least one of the processing electrode and the feeding electrode.

25. The electrolytic processing method according to claim 23, wherein the processing conditions are changed during or after electrolytic processing of the workpiece.

26. The electrolytic processing method according to claim 23, wherein the processing conditions are changed by changing the flow rate of the fluid supplied between the workpiece and said at least one of the processing electrode and the feeding electrode.

27. The electrolytic processing method according to claim 23, wherein the fluid supplied between the workpiece and said at least one of the processing electrode and the feeding electrode is pure water, ultrapure water or a fluid having an electric conductivity of not more than 500 μS/cm.

28. An electrolytic processing method comprising:
disposing an ion exchanger between a workpiece and at least one of a processing electrode and a feeding electrode for feeding electricity to the workpiece;
allowing the workpiece to be close to or in contact with the ion exchanger;
applying a voltage between the processing electrode and the feeding electrode;
supplying a fluid between the workpiece and the electrode in which the ion exchanger is disposed;
measuring the electric conductivity of the fluid; and
removing contaminants on the surface or in the interior of the ion exchanger based on the measured electric conductivity.

29. The electrolytic processing method according to claim 28, wherein the contaminants are removed during or after electrolytic processing of the workpiece.

30. The electrolytic processing method according to claim 28, wherein the fluid supplied between the workpiece and said at least one of the processing electrode and the feeding electrode is pure water, ultrapure water or a fluid having an electric conductivity of not more than 500 μS/cm.

31. An electrolytic processing apparatus comprising:
a processing electrode;
a feeding electrode for feeding electricity to a workpiece;
an ion exchanger disposed at least one of between the workpiece and the processing electrode, and between the workpiece and the feeding electrode;
a power source for applying a pulse voltage between the processing electrode and the feeding electrode; and
a liquid supply section for supplying a liquid between the workpiece and at least one of the processing electrode and the feeding electrode.

32. The electrolytic processing apparatus according to claim 31, wherein the liquid is pure water, ultrapure water or a liquid having an electric conductivity of not more than 500 μS/cm.

33. The electrolytic processing apparatus according to claim 31, wherein the lowest potential of the pulse voltage periodically becomes zero or a negative potential.

34. The electrolytic processing apparatus according to claim 31, wherein the waveform of the pulse voltage is part of a square wave or a sine curve.

35. The electrolytic processing apparatus according to claim 31, wherein the duty ratio of positive potential of the pulse voltage is within the range of 10-97%.

36. The electrolytic processing apparatus according to claim 31, wherein the current density of an electric current flowing in the surface of a workpiece in contact with the ion exchanger is 0.1 to 100 A/cm².

37. The electrolytic processing apparatus according to claim 31, wherein the positive potential time in one cycle of the pulse voltage is 50 μs to 7 sec.

38. The electrolytic processing apparatus according to claim 31, wherein the liquid has been degassed to a dissolved oxygen concentration of 1 ppm or less.

39. An electrolytic processing method comprising:
disposing an ion exchanger between at least one of between a workpiece and a processing electrode, and between the workpiece and a feeding electrode;
allowing the workpiece to be close to the processing electrode;
applying a pulse voltage between the processing electrode and the feeding electrode; and
processing the workpiece while supplying a liquid between the workpiece and at least one of the processing electrode and the feeding electrode.

40. The electrolytic processing method according to claim 39, wherein the liquid is pure water, ultrapure water or a liquid having an electric conductivity of not more than 500 μS/cm.

41. The electrolytic processing method according to claim 39, wherein the lowest potential of the pulse voltage periodically becomes zero or a negative potential.

42. The electrolytic processing method according to claim 39, wherein the waveform of the pulse voltage is part of a square wave or a sine curve.

43. The electrolytic processing method according to claim 39, wherein the duty ratio of positive potential of the pulse voltage is within the range of 10-97%.

44. The electrolytic processing method according to claim 39, wherein the current density of an electric current flowing in the surface of a workpiece in contact with the ion exchanger is 0.1 to 100 A/cm².

45. The electrolytic processing method according to claim 39, wherein the positive potential time in one cycle of the pulse voltage is 50 μs to 7 sec.

46. The electrolytic processing method according to claim 39, wherein the liquid has been degassed to a dissolved oxygen concentration of 1 ppm or less.

47. An electrolytic processing method comprising:
electrolytically processing a surface of a workpiece by providing a processing electrode and a feeding electrode for feeding electricity to the workpiece, applying a voltage between the processing electrode and the feeding electrode, allowing a liquid and a partition member to be present between the processing electrode and the workpiece, allowing the workpiece to be close to the processing electrode, and allowing the workpiece and the processing electrode to make a relative movement;
stopping the application of the voltage between the processing electrode and the feeding electrode after electrolytically processing the surface of the workpiece until a predetermined processing amount is reached;
allowing the processing electrode and the workpiece to make a relative movement for a given length of time; and
separating the workpiece from the processing electrode.

48. The electrolytic processing method according to claim 47, wherein an ion exchanger is disposed between the workpiece and at least one of the processing electrode and the feeding electrode.

49. The electrolytic processing method according to claim 47, wherein the partition member to be present between the processing electrode and the workpiece is an ion exchanger disposed such that it covers the processing electrode or the feeding electrode, a buffer member, or a partition disposed in the vicinity of the processing electrode.

50. The electrolytic processing method according to claim 47, wherein the processing electrode and the feeding electrode are disposed such that they face the surface of the workpiece.

51. The electrolytic processing method according to claim 47, wherein the apparatus determines whether the predetermined processing amount is reached by a processing amount measurement section or by time management.

52. The electrolytic processing method according to claim 47, wherein the relative movement between the processing electrode and the workpiece after the stoppage of voltage application is carried out for 1-60 seconds.

53. An electrolytic processing apparatus comprising:
an electrode section including a plurality of electrodes;
a holder for holding a workpiece, capable of bringing the workpiece close to or into contact with the electrodes;
a power source to be connected to the electrodes of the electrode section;
a partition member disposed such that it can make contact with the surface of the workpiece;
a liquid supply section for supplying a liquid between at least one of the electrodes, the partition member and the workpiece; and
a drive section for allowing the electrode section and the workpiece to make a relative movement;
wherein application of a voltage is stopped after processing the workpiece until a predetermined processing amount is reached, and the electrode section and the workpiece is allowed to make a relative movement for a given length of time while supplying the liquid between at least one of the electrodes, the partition member and the workpiece.

54. The electrolytic processing apparatus according to claim 53, wherein an ion exchanger is mounted on at least one of the electrodes such that it covers the electrode.

55. The electrolytic processing apparatus according to claim 53, wherein the electrodes are comprised of processing electrodes and feeding electrodes, and the processing electrodes and the feeding electrodes are disposed such that they face the surface of the workpiece.

56. The electrolytic processing apparatus according to claim 55, wherein the partition member is disposed between the processing electrode and the feeding electrode.

57. The electrolytic processing apparatus according to claim 53, wherein the partition member is comprised of an ion exchanger, a porous polymer material, a fibrous material or a polishing pad.

58. The electrolytic processing apparatus according to claim 53, wherein the apparatus determines whether the predetermined processing amount is reached by a processing amount measurement section or by time management.

59. An electrolytic processing apparatus comprising:
a processing electrode;
a feeding electrode;
a holder for holding a workpiece, capable of bringing the workpiece close to or into contact with the processing electrode;
a power source to be connected to the processing electrode and the feeding electrode;
a contact member disposed between the workpiece and at least one of the processing electrode and the feeding electrode, and capable of making contact with the workpiece;
a liquid supply section for supplying a liquid between the workpiece and at least one of the processing electrode and the feeding electrode; and
a drive section for allowing the workpiece and at least one of the processing electrode and the feeding electrode to make a relative movement;
wherein application of a voltage is stopped after processing the workpiece until a predetermined processing amount is reached, and the workpiece and at least one of the processing electrode and the feeding electrode are allowed to make a relative movement for a given length of time.

60. The electrolytic processing apparatus according to claim 59, wherein the contact member is an ion exchanger or a buffer member having elasticity.

61. The electrolytic processing apparatus according to claim 59, wherein the processing electrode and the feeding electrode are disposed in the same direction.

62. The electrolytic processing apparatus according to claim 59, wherein the apparatus determines whether the predetermined processing amount is reached by a processing amount measurement section or by time management.
